(19) United States
(12) Patent Application Publication
(10) Pub. No.: US 2006/0188790 A1
(43) Pub. Date: Aug. 24, 2006

(54) Hologram recording material, hologram recording method, and optical recording medium

(75) Inventor: Hiroo Takizawa, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/359,566

(22) Filed: Feb. 23, 2006

(30) Foreign Application Priority Data
Feb. 23, 2005 (JP) P.2005-047609

(51) Int. Cl. G03H 1/04

(52) U.S. Cl. 430/1; 430/2; 359/3

(57) ABSTRACT

A hologram recording material is provided and has: a sensitizing dye absorbing light upon hologram exposure to generate an excited state thereof, and an interference fringes-recording component capable of causing color development reaction or discoloration by an electron or energy transfer (movement) form the excited state to record interference fringes providing a refractive index modulation. At least one of the sensitizing dye one the interference fringes-recording component is one a polymer and an oligomer.

### FIELD OF THE INVENTION

The present invention relates to a hologram recording material and hologram recording method which can be applied to high density optical recording medium, three-dimensional display, holographic optical element etc.

### BACKGROUND OF THE INVENTION

The general principle of preparation of hologram is described in some literatures and technical books, e.g., Junpei Tsujiuchi, “Holographic Display”, Sangyo Tosho, Chapter 2. In accordance with these literatures and technical books, a recording object is irradiated with one of two fluxes of coherent laser beams and a photosensitive hologram recording material is disposed in a position such that all the lights reflected by the recording object can be received. Besides the light reflected by the recording object, the other coherent light is incident on the hologram recording material without hitting the object. The light reflected by the object is called object light. The light with which the recording material is directly irradiated is called reference light. The band of interference of reference light with object light is then recorded as image data. Subsequently, when the hologram recording material thus processed is irradiated with the same light (reproducing light) as the reference light, the hologram performs diffraction in such a manner that the wave front of the first reflected light which has reached the recording material from the object during recording is reproduced. As a result, substantially the same object image as the real image of the object can be three-dimensionally observed.

The hologram formed by allowing reference light and object light to be incident on the hologram recording material in the same direction is called transmission hologram. The interference fringes are formed in the direction perpendicular or substantially perpendicular to the surface of the recording material at an interval of from about 1,000 to 3,000 lines per mm.

On the other hand, the hologram formed by allowing reference light and object light to be incident on the hologram recording material in opposite directions is normally called reflection hologram. The interference fringes are formed in the direction parallel to or substantially parallel to the surface of the recording material at an interval of from about 3,000 to 7,000 lines per mm.

The transmission hologram can be prepared by any known method as disclosed in JP-A-6-43634. The reflection hologram can be prepared by any known method as disclosed in JP-A-2-3082, JP-A-3-50588, etc.

On the other hand, the hologram having a sufficiently thick layer relative to the interval of interference fringes (normally five times the oval of interference fringes or about 1 μm or more) is called volume hologram.

On the contrary, the hologram having a layer thickness which is five times or less the interval of interference fringes or about 1 μm or less is called plane or surface hologram.

Further, the hologram involving the absorption by dye or silver causing the recording of an interference fringes is called amplified hologram. The hologram involving recording by surface relief or refractive index modulation is called phase hologram. The amplified hologram is subject to drastic drop of light diffraction efficiency or reflectance due to absorption of light and thus is disadvantageous in percent utilization of light. In general, the phase hologram is preferably used

In accordance with the volume phase type hologram many interference fringes having different refractive indexes are formed in the hologram recording material without by making optical absorption, making it possible to modulate the phase of light without absorbing light.

In particular, the reflection volume phase type hologram is also called Lipman type hologram. In accordance with the reflection volume phase type hologram, wavelength-selective reflection involving Bragg diffraction allows the formation of full-color image, reproduction of white color and enhancement of resolution at a high diffraction efficiency, making it possible to provide a high resolution full-color three-dimensional display.

In recent years, hologram has been put into practical use in the art of holographic optical element (HOE) such as headup display (HUD) to be mounted on automobile, pickup lens for optical disc, head mount display, color filter for liquid crystal and reflection type liquid crystal reflector by making the use of its wavelength-selective reflectivity.

Studies have been made also on the practical use or application of hologram to lens, diffraction grating interference filter, connector for optical fiber, light polarizer for facsimile, window glass for building, etc.

In the recent tend for highly informative society, networks such as internet and highvision TV have been rapidly spread. Further, with the operation of HDTV (High Definition Television) close at hand, there has been a growing demand for high density recording medium for simply recording image data having a capacity of 100 GB or more at reduced cost also in consumers' use.

In the trend for enhancement of computer capacity, an ultrahigh density recording medium capable of recording data having a capacity of about 1 TB or more at a high rate and reduced cost has been desired also in business uses such as computer backup and broadcast backup.

Under these circumstances, replaceable and random-accessible small-sized inexpensive optical recording media have been noted more than ever relative to magnetic tapes, which are not random-accessible, and hard discs, which are not replaceable and are subject to failure. Speaking from the standpoint of physical principle, however, existing two-dimensional optical recording media such as DVD-RR allow recording of 25 GB data at greatest per one side even if the wavelength of the recording light is reduced. Thus, these two-dimensional recording media cannot be expected to have a recording capacity great enough to meet the future demand.

Then, three-dimensional optical recording media which perform recording in the thickness direction have been recently noted as ultimate ultrahigh density recording media. Effective methods for this system include method involving the use of two-photon absorbing material and method involving the use of holography (interference). Therefore, volume phase type hologram recording materials have recently been suddenly noted as three-dimensional optical media (holographic memory).

In operation, the holographic memory comprising a volume phase type hologram recording material records many two-dimensional digital data (called signal light) using a spatial light modulation element (SLM) such as DMD and LCD instead of object light reflected by the three-dimensional object. Since the recording involves multiplexed recording such as angle-multiplexed recording, phase-multiplexed recording, wavelength-multiplexed recording and shift-multiplexed recording, a capacity as high as up to 1 TB can be attained. Further, reading is normally accomplished by the use of CCD, CMOS or the like. These elements allow parallel writing/reading, making it possible to raise the transfer rate up to 1 Gbps.

However, the hologram recording materials to be used in holographic memory have severer requirements than for the three-dimensional display and HOE as follows.
(1) To have a high sensitivity.
(2) To have a high resolution.
(3) To have a high hologram diffraction efficiency,
(4) To use a fast dry processing during recording,
(5) To allow multiplexed recording (broad dynamic range),
(6) To have a small shrinkage after recording,
(7) To have good hologram storage properties.

In particular, the requirements (1) To have a high sensitivity, (3) To have a high hologram diffraction efficiency, (4) To use a fast dry processing during recording, (6) To have a small shrinkage after recording and (7) To have good hologram storage properties are chemically opposing properties. It is very difficult to meet these requirements at the same time.

Examples of known volume phase type hologram recording materials include write-once-read-many type hologram recording materials such as gelatin bichromate process hologram recording material, bleached silver halide process hologram recording material and photopolymer process hologram recording material and rewritable type hologram recording materials such as photorefractive process hologram recording material and photochromic polymer process hologram recording material.

However, none of these known volume phase type hologram recording materials cannot meet all these requirements particularly when used as high sensitivity optical recording medium. Thus, these known volume phase type hologram recording materials leave something to be desired.

In some detail, the gelatin bichromate process hologram recording material is advantageous in that it has a high diffraction efficiency and a low noise but is disadvantageous in that it has extremely poor storage properties, requires wet processing and exhibits a low sensitivity. Thus, the gelatin bichromate process hologram recording material is not suitable for holographic memory.

The bleached silver halide process hologram recording material is advantageous in that it has a high sensitivity but is disadvantageous in that it requires wet processing and troublesome bleaching process, causes great scattering and has a poor light-resistance. Thus, the bleached silver halide process hologram recording material, too, is not suitable for holographic memory.

The photorefractive hologram recording material is advantageous in that it is rewritable but is disadvantageous in that it requires the application of a high electric field during recording and has poor record storage properties.

The photochromic polymer process hologram recording material such as azobenzene polymer process hologram recording material is advantageous in that it is rewritable but is disadvantageous in that it has an extremely low sensitivity and poor record storage properties. For example, WO9744365A1 proposes a rewritable hologram recording material utilizing the refractive anisotropy and orientation control of azobenzene polymer (photochromic polymer). However, this type of a rewritable hologram recording material is disadvantageous in that since the quantum yield of isomerization of azobenzene is low and this process involves orientation change, the sensitivity is extremely low. This type of a rewritable hologram recording material is also disadvantageous in that it has poor record storage properties, which are contrary to rewritability. Thus, this type of a rewritable hologram recording material cannot be put into practical use.

Under these circumstances, the dry-processed photopolymer process hologram recording material disclosed in the above cited JF-A-3634, JF-A-2-3082 and JP-A-3-50588 has the following arrangement. In other words, the dry-processed photopolymer process hologram recording material is essentially composed of a binder, a radical-polymerizable monomer and a photopolymerization initiator. In order to enhance refractive index modulation, one of the binder and the radical-polymerizable monomer comprises a compound having an aromatic ring, chlorine or bromine incorporated therein to make a difference in refractive index therebetween. In this arrangement, the hologram exposure causes the progress of polymerization with the monomer and the binder gathering at the bright area and the dark area of the interference fringes thus formed, making it possible to form a refractive index difference. Thus, it can be said that the dry-processed photopolymer process hologram recording material is a relatively practical hologram recording material which can attain a high diffraction efficiency and dry processing properties at the same time.

However, the dry-processed photopolymer process hologram recording material is disadvantageous in that it has a sensitivity of about one thousandth of that of the bleached silver halide process hologram recording material, requires a heat-fixing step for about 2 hours to enhance diffraction efficiency, requires radical polymerization causing the effect of polymerization inhibition by oxygen and is subject to shrinkage after exposure and fixing and hence change of diffraction wavelength and angle during reproduction. Further, the dry-processed photopolymer process hologram recording material is in the form of soft membrane and lacks storage properties. Accordingly, the dry-processed photopolymer process hologram recording material can be by no means used for holographic memory.

In general, as opposed to radical polymerization, cationic polymerization, particularly cationic polymerization involving the ring opening of an epoxy compound, etc., causes little shrinkage after polymerization and no polymerization inhibition by oxygen. As a result, a rigid membrane can be given. It is also pointed out that cationic polymerization is more suitable for holographic memory than radical polymerization.

For example, JP-A-5-107999 and JP-A4-16078 disclose a hologram recording material comprising in combination a cationically-polymerizable compound (monomer or oligomer) instead of binder and a sensitizing dye, a radical polymerization initiator, a cationic polymerization initiator and a radical-polymerizable compound.

Further, JP-T-2001-523842 and JP-T-11-512847 disclose a hologram recording material comprising only a sensitizing dye, a cationic polymerization initiator, a cationically-polymerizable compound and a binder but free from radical polymerization.

The aforementioned cationic polymerization process hologram recording material shows some improvement in shrinkage resistance as compared with the radical polymerization process hologram recording material but has a lowered sensitivity as opposed to the improvement. It is thought that this disadvantage gives a great problem in transfer rate during practical use. Further, the cationic polymerization process hologram recording material exhibits a reduced diffraction efficiency that probably gives a great problem in S/N ratio and multiplexed recording properties.

As previously mentioned, the photopolymer process hologram recording method involves the movement of materials. This causes a dilemma. In some detail, when the hologram recording material to be applied to holographic memory is arranged to have better storage properties and shrinkage resistance, the resulting sensitivity is lowered (cationic polymerization process hologram recording material). On the contrary, when the hologram recording material is arranged to have an enhanced sensitivity, the resulting storage properties and shrinkage resistance are deteriorated (radical polymerization process hologram recording material). In order to enhance the recording density of holographic memory, it is essential that multiplexed recording involving more than 50 times, preferably 100 times or more recording jobs be effected. However, since the photopolymer process hologram recording material employs polymerization process involving the movement of materials to perform recording, the recording speed in the latter half of multiplied recording process, in which most of the compound has been polymerized, is reduced as compared with that in the initial stage of multiplexed recording process. Accordingly, exposure must be adjusted and a broad dynamic range must be used to control the recording speed. This gives a practically great problem.

The dilemma caused by the requirements for higher sensitivity, better storage properties and dry processing properties and the problem of multiplexed recording properties (high recording density) cannot be avoided from the physical standpoint of view so far as the related art photopolymer process hologram recording material is used. It is also difficult for the silver halide process recording material in principle from the standpoint of dry processing properties to meet the requirements for holographic memory.

In order to apply a hologram recording material to holographic memory, it has been keenly desired to develop quite a new recording system which can give essential solution to these problems, particularly one which can attain higher sensitivity, lower shrinkage, better storage properties, dry processing properties and multiplexed recording properties (high recording density) at the same time.

It has been particularly desired to develop a hologram recording material which can storage recorded information for long time.

### SUMMARY OF THE INVENTION

An object of an illustrative, non-limiting embodiment of the invention is to provide a hologram recording material and hologram recording method which can be applied to high density optical recording medium, three-dimensional display, holographic optical element, etc. and can attain a high sensitivity, high diffraction efficiency, good storage properties, low shrinkage factor, dry processing properties and multiplexed recording properties (high recording density) at the same time.

As a result of the inventors' extensive studies, the aforementioned aims of the invention were accomplished by the following means.
(1) A hologram recording material comprising at least: a sensitizing dye absorbing light upon hologram exposure to generate an excited state thereof, and an interference fringes-recording component capable of causing color development reaction or discoloration reaction by an electron or energy transfer (movement) form the excited state to record interference fringes providing a refractive index modulation, wherein at least one of the sensitizing dye or the interferences fringes-recording component is a polymer or oligomer.
(2) The hologram recording material as defined in Clause (1), wherein the interference fringes-recording component comprises at least an acid generator and an acid-colorable dye precursor or acid-discolorable dye at least one of which is a polymer or oligomer,
(3) The hologram recording material as defined in Clause (2), wherein the acid-colorable dye precursor or acid-discolorable dye is a polymer or oligomer.
(4) The hologram recording material as defined in Clause (2) or (3), wherein the acid generator defined in Clause (2) is a diaryl iodonium salt, a sulfonium salt, a diazonium salt, a metal-allene complex, a trihalomethyl-substituted triazine or a sulfonic acid ester.
(5) The hologram recording material as defined in Clause (4), wherein the acid formula defined in Clause (4) is a diaryl iodonium salt, a sulfonium salt or a sulfonic acid ester.
(6) The hologram recording material as defined in any one of Clauses (2) to (5), wherein the interference fringes recording defined in Clause (2) involves refractive index modulation by color development reaction and the dye produced from the acid-colorable dye precursor is a xanthene(fluorane) dye, a triphenylmethane dye or a cyanine dye produced by proton addition to cyanine base.
(7) The hologram recording material as defined in any one of Clauses (2) to (5), wherein the interference fringes recording defined in Clause (2) involves refractive index modulation by discoloration reaction and the acid-discolorable is a dissociation product of a dissociative benzylidene dye, a dissociative oxonol dye, a dissociative xanthene dye or a dissociative azo dye.
(8) The hologram recording material as defined in Clause (1)7 wherein the interference fringes-recording component comprises at least a base generator and a base-colorable dye precursor or base-discolorable dye at least one of which is a polymer or oligomer.
(9) The hologram recording material as defined in Clause (8), whew the base-colorable dye precursor or base-discolorable dye in Clause (8) is a polymer or oligomer.
(10) The hologram recording material as defined in Clause (8) or (9), wherein the base generator defined in Clause (8) is represented by any one of the following formulae (3-1) to (34): 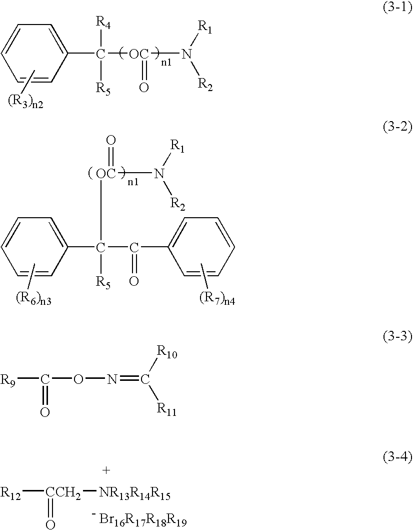
   wherein R₁, R_{2,} R₁₃, R₁₄ and R₁₅ in the formulae (3-1) to (3-4) each independently represent a hydrogen atom, alkyl group, alkenyl group, cycloalkyl group, aryl group or heterocyclic group: R₁ and R₂ may be connected to each other to form a ring; R₁₃, R₁₄ and R₁₅ may be connected to each other to form a ring; R₃, R₆, R₇ and R₉ each independently represent a substituent; R₄, R₅, R₈, R₁₀ ad R₁₁, each independently represent a hydrogen atom or substituent; R₁₀ and R₁₁ may be connected to each other to form a ring; R₁₆, R₁₇, R₁₈ and R₁₉ each independently represent an alkyl group or aryl group; R₁₂ represents an aryl group or heterocyclic group; n1 represents an integer of from 0 or 1; and n2 to n4 each independently represent an integer of from 0 to 5.
(11) The hologram recording material as defined in Clause (10), wherein n1 in the formulae (3-1) and (3-2) is 1.
(12) The hologram recording material as defined in Clause (10) or (11), wherein n1 in the formula (3-1) is a nitro group on the 2- or 2,6-position or an alkoxy group on the 3,5-position
(13) The hologram recording material as defined in Clause (10) or (11), wherein R₃ in the formula (3-2) is an alkoxy group on the 3,5-position.
(14) The hologram recording material as defined in any one of Clauses (8) to (13), wherein the interference fringes recording defined in Clause (8) involves refractive index modulation by color development reaction and the base-colorable dye precursor is a non-dissociation product of a dissociative azo dye, a dissociative azomethine dye, a dissociative benzylidene dye, a dissociative oxonol dye, a dissociative xanthene dye, a dissociative xanthene(fluorane) dye or a dissociative triphenylmethane dye.
(15) The hologram recording material as defined in any one of Clauses (8) to (13), wherein the interference fringes recording defined in Clause (8) involves refractive index modulation by discoloration reaction and the base-discolorable dye is an acid-colorable dye coloring material such as triphenylmethane dye, xanthene dye, fluorane dye and cyanine dye produced by proton addition to cyanine base.
(16) The hologram recording material as defined in any one of Clauses (1) to (15), wherein the interference fringes-recording component comprises at least a colorable dye precursor polymer or oligomer represented by the following formula (1):
   (A1−PD)m1 (1)
   wherein A1 and PD are covalently bonded to each other in the formula (1); A1 represents a site capable of disconnecting the covalent bond to PD upon the movement of electron or energy from and to the excited state of the sensitizing dye; PD represents a site capable of causing color development reaction when released upon the disconnection of the covalent bond to A1, with the proviso that the molecules of the formula (1) are connected to each other with covalent bond of any of A1 and PD to form a polymer or oligomer, and m1 represents an integer of from not smaller than 3 to not greater than 1,000,000.
(17) The hologram recording material as defined in Clause (16), wherein PD is, in the formula (1) a group formed by any of dissociative azo dye, dissociative azomethine dye, dissociative benzylidene dye, dissociative oxonol dye, triphenylmethane dye and xanthene dye and is covalently bonded to A1 on chromophore.
(18) The hologram recording material as defined in any one of Clauses (1) to (15), wherein the interference fringes-recording component comprises at least a discolorable dye polymer or oligomer represented by the following formula (2):
   (A2−DD)m² (2)
   wherein A2 and DD are covalently bonded to each other in the formula (2); A2 represents a site capable of disconnecting the covalent bond to DD upon the movement of electron or energy from and to the excited state of the sensitizing dye; DD represents a site which stays in the form of dye when covalently bonded to A2 but is discolored when released upon the disconnection of the covalent bond to A2, with the proviso that the molecules of the formula (2) are connected to each other with covalent bond of any of A2 and DD to form a polymer or oligomer; and m2 represents an integer of from not smaller than 3 to not greater than 1,000,000.
(19) The hologram recording material as defined in Clause (18), wherein DD is a group formed by cyanine base in the formula (2) and is covalently bonded to A1 on chromophore.
(20) The hologram recording material as defined in any one of Clauses (1) to (19), wherein the dye produced by color development of colorable dye precursor or the discolorable dye defined in Clauses (1) to (19) exhibits a molar absorption coefficient of 1,000 or less at hologram recording wavelength.
(21) The hologram recording material as defined in Clause (20), wherein the dye produced by color development of colorable dye precursor or the discolorable dye in Clause (20) has no absorption at hologram recording wavelength.
(22) The hologram recording material as defined in any one of Clauses (1) to (21), further comprising an electron-donating compound capable of donating electron to the sensitizing dye radical cation from which electron has been moved to the interference fringes-recording component.
(23) The hologram recording material as in Clause (22), wherein the electron-donating compound is an alkylamine, aniline, phenylene diamine, triphenylamine, carbazole, phenothiazine, phenoxazine, phenazine, hydroquinone, catechol, alkoxybenzene, aminophenol, imidazole, pyridine, metalocene, metal complex or particulate semiconductor in Clause (22).
(24) The hologram recording material as defined in Clause (22), wherein the electron-donating compound is a triphenylazine, phenothiazine, phenoxazine or phenazine in Clause (22)
(25) The hologram recording material as defined in Clause (22), wherein the electron-donating compound is a phenothiazine in Clause (22).
(26) The hologram recording material as defined in any one of Clauses (22) to (25), wherein the electron-donating compound defined in Clause (22) is a polymer or oligomer.
(27) The hologram recording material as defined in any one of Clauses (1) to (26), wherein the hologram recording material defined in Clause (1) further comprises an electron-receiving compound capable of receiving electron from the sensitizing dye radical anion to which electron has been moved from the interference fringes-recording component.
(28) The hologram recording material as defined in Clause (27), wherein in Clause (27) the electron-receiving compound is an aromatic compound having an electrophilic group such as dinitrobenzene and dicyanobenzene incorporated therein, a heterocyclic compound, a heterocyclic compound having an electrophilic group incorporated therein, an N-alkylpyridinium salt, a benzoquinione, an imide, a metal complex or a particulate semiconductor.
(29) The hologram recording material as defined in any one of Clauses (1) to (26), comprising a polymer or oligomer obtained by the copolymerization of at least two of the sensitizing dye, the interference fringes-recording component and the electron-donating compound defined in Clauses (1) to (26).
(30) The hologram recording material as defined in any one of Clauses (1) to (29), wherein in Clauses (1) to (29) the sensitizing dye exhibits a molar absorption coefficient of from not smaller than 1 to not greater than 10,000 at hologram exposure wavelength.
(31) The hologram recording material as defined in Clause (30), wherein in Clause (30) the sensitizing dye exhibits a molar absorption coefficient of from not smaller than 5 to not greater than 5,000 at hologram exposure wavelength.
(32) The hologram recording material as defined in any one of Clauses (1) to (31), wherein in Clauses (1) to (31) the sensitizing dye is any of cyanine dye, squarilium cyanine dye, styryl dye, pyrilium dye, melocyanine dye, benzylidine dye, oxonol dye, azlenium dye, conmarine dye, ketocoumarine dye, styrylcoumarine dye, pyrane dye, xanthene dye, thioxanthene dye, phenothiazine dye, phenoxazine dye, phenazine dye, phthalocyanine dye, azaporphyrin dye, porphyrin dye, condensed aromatic dye, perylene dye, azomethine dye, anthraquinone dye, metal complex dye and metalocene dye.
(33) The hologram recording, material as defined in Clause (32), wherein Clause (32) the sensitizing dye is a cyanine dye, melocyanine dye, oxonol dye, metal complex dye or metalocene dye.
(34) The hologram recording material as defined in Clause (33), wherein in Clause (33) the metal complex dye is a Ru complex dye.
(35) The hologram recording material as defined in Clause (33), wherein the in Clause (33) metalocene dye is a ferrocene derivative.
(36) The hologram recording method as defined in any one of Clauses (1) to (35), which comprises performing any of (1) a color development reaction, (2) a latent image color development-coloring material self-sensitized amplification color development reaction (i.e., a color development reaction amplified by a self-sensitization with a coloring material of a latent image), (3) a latent image color development-coloring material sensitizing polymerization reaction (i.e., a polymerization reaction sensitized with a coloring material of a latent image), (4) a dye discoloration reaction and (5) a remaining discolorable dye latent image-latent image sensitization polymerization reaction (i.e., a latent image-sensitized polymerization reaction sensitized by a latent image of a residual of a discolorable dye), using a hologram recording material defined in any one of Clauses (1) to (35) to record an interference fringes as refractive index modulation.
(37) The hologram recording method as defined in Clause (36), wherein hologram recording involving (2) latent image color development-coloring material sensitized polymerization reaction defined in Clause (36) comprises at least a first step of forming a coloring material having no absorption at hologram reproducing light wavelength as a latent image by hologram exposure and a second step of irradiating the coloring material latent image with light having a wavelength different from hologram exposure wavelength and a wavelength at which the sensitizing dye exhibits a molar absorption coefficient of 5,000 or less to make self-sensitized amplified production of a coloring material, whereby an interference fringes is recorded as refractive index modulation, which steps being effected in a dry process.
(38) The hologram recording method as defined in Clause (36) or (37), which comprises using as a group of compounds capable of performing hologram recording by (1) color development reaction or (2) latent image color development-coloring material self-sensitized amplification color development reaction defined in Clause (36) at least:
   1) a sensitizing dye which absorbs light upon hologram exposure to generate excited state; and
   2) an interference fringes-recording component containing a dye precursor which can form a coloring material that has absorption at longer wavelength than in the original state (i.e., absorption shifted to a longer wavelength than that of the dye precursor) and no absorption at hologram reproducing light wavelength, which interference fringes-recording component can undergo electron movement or energy movement from the excited state of the sensitizing dye or coloring material to cause color development leading to refractive index modulation by which an interference fringes is recorded.
(39) The hologram recording method as defined in Clause (36), wherein hologram recording involving 3) latent image color development-coloring material sensitized polymerization reaction defined in Clause (36) comprises at least a first step of forming a coloring material having no absorption at hologram reproducing light wavelength as a latent image by hologram exposure and a second step of irradiating the coloring material latent image with light having a wavelength different from hologram exposure wavelength to cause polymerization, whereby an interference fringes is recorded as refractive index modulation, which steps being effected in a dry process.
(40) The hologram recording method as defined in Clause (39), which comprises using as a group of compounds capable of performing hologram recording defined in Clause (39) at least;
   1) a sensitizing dye represented which absorbs light upon hologram exposure to generate excited state at the first step; and as an interference fringes-recording component:
   2) an interference fringes-recording component containing a dye precursor which can form a coloring material that has absorption at longer wavelength than in the original state at which wavelength the sensitizing dye exhibits a molar absorptivity of 5,000 or less and no absorption at hologram reproducing light wavelength when electron or energy moves from the excited state of the sensitizing dye at the first step or from excited state of coloring material at the second step;
   3) a polymerization initiator which can initiate the polymerization of a polymerizable compound when electron or energy moves from the excited state of the sensitizing dye at the first step and from excited state of coloring material at the second step;
   4) a polymerizable compound; and
   5) a binder.
(41) The hologram recording method as defined in Clause (36), which comprises using as a group of compounds capable of performing (4) dye discoloration reaction defined in Clause (36) at least:
   1) a sensitizing dye which absorbs light upon hologram exposure to generate excited state; and
   2) a discolorable dye or discolorable agent precursor and discoloring dye as interference fringes-recording component wherein when subjected to hologram exposure, the sensitizing dye generates excited state in which it then undergoes direct energy movement or electron movement to the discolorable dye to discolor the discolorable dye or undergoes energy movement or electron movement with the discolorable agent precursor to cause the discolorable agent precursor to generate a discolorable agent which then discolors the discolorable dye, causing refractive index modulation by which an interference fringes is formed, with the proviso that the discolorable agent precursor or is any of radical generator, acid generator, base generator, nucleophilic agent generator, electrophilic agent generator and triplet oxygen.
(42) The hologram recording method as defined in Clause (36) or (41), wherein hologram recording involving (5) remaining discolorable dye latent image-latent image polymerization reaction defined in Clause (36) comprises a first step at which the sensitizing dye having absorption at hologram exposure wavelength absorbs light during hologram exposure to generate excited state in which it undergoes direct energy movement or electron movement to the discolorable dye defined in Clause (41) to discolor the discolorable dye or undergoes energy movement or electron movement with the discolorable agent precursor to cause the discolorable agent precursor to generate a discolorable agent which then discolors the discolorable dye, whereby the discolorable dye left undiscolored forms a latent image and a second step at which the latent image of discolorable dye left undiscolored is irradiated with light having a wavelength different from that used for hologram exposure to activate the polymerization initiator to cause polymerization by which an interference fringes is recorded as reactive index modulation.
(43) The hologram recording method as defined in Clause (42), which comprises using as a group of compounds capable of performing hologram recording defined in Clause (42) at least:
   1) a sensitizing dye which absorbs light upon hologram exposure to generate excited state at the first step; and as an interference fringes-recording component:
   2) a discolorable dye having a molar absorptivity of 1,000 or less at hologram reproducing light wavelength capable of performing direct energy or electron movement to the discoloring agent precursor from the excited state of the sensitizing dye to generate a discoloring agent with which discoloration can be made at the first step;
   3) a polymerization initiator (optionally acting as a discoloring agent precursor 2) as well) which can undergo electron movement or energy movement from excited state of remaining discolorable dye to initiate the polymerization of the polymerizable compound at the second step;
   4) a polymerizable compound; and
   5) a binder.
(44) A hologram recording method involving volume phase type hologram recording using a hologram recording material defined in any one of Clauses (1) to (35) or a hologram recording method defined in any one of Clauses (36) to (43).
(45) The hologram recording material as defined in any one of Clauses (1) to (35) or the hologram recording method as defined in any one of Clauses (36) to (44), wherein hologram recording defined in Clauses (1) to (44) is effected in a non-rewritable process. That is, the interference fringes recorded are non-rewritable.
(46) The hologram recording method as defined in any of Clauses (1) to (44) involving multiplexed recording comprising 10 or more recording jobs (i.e., subjecting a hologram recording material to holographic exposure 10 or more times) using a hologram recording material defined in Clauses (1) to (35) and a hologram recording method defined in Clauses (36) to (43).
(47) The hologram recording method as defined in Clause (46), which performs multiplexed recording comprising 50 or more recording jobs using a hologram recording material or a hologram recording method defined in Clause (46).
(48) The hologram recording method as defined in Clause (46), which performs multiplexed recording comprising 100 or more recording jobs using a hologram recording material or a hologram recording method defined in Clause (46).
(49) The hologram recording method as defined in any one of Clauses (46) to (48), wherein multiplexed recording defined in Clause (46) can be effected from beginning to end with the exposure kept constant. That is, the multiplexed recording is performed under a common exposure amount in each holographic exposure.
(50) The hologram recording material as defined in any one of Clauses (1) to (49), comprising a light-screening filter provided on either side or both sides thereof capable of cutting part of wavelength of ultraviolet rays, visible light and infrared rays other than recording light and reproducing light.
(51) An optical recording medium comprising a hologram recording material defined in Clauses (1) to (51) and according to a method of recording on an optical recording medium comprising a hologram recording method defined in Clauses (1) to (51).
(52) An optical recording medium comprising a hologram recording material defined in Clauses (1) to (51) stored in a light-screening cartridge during storage.
(53) A three-dimensional display hologram using a hologram recording material and a hologram recording method defined in any one of Clauses (1) to (50) and a method of producing the three-dimensional display hologram.
(54) A holographic optical element using a hologram recording material and a hologram recording method defined in any one of Clauses (1) to (50) and a method of producing the holographic optical element.

It was found that when the hologram recording material and method of the invention are used, hologram recording can be effected at a high diffraction efficiency, a small shrinkage, good dark storage properties and a linear rise of diffraction efficiency relative to exposure. Thus, the invention can be applied to holographic memory, etc. to advantage from the standpoint of capacity (recording density), system simplification by improvement of multiplexed recording properties, storage properties, etc.

### BRIEF DESCRIPTION OF THE DRAWINGS

FIG. 1 is a schematic diagram illustrating a two-flux optical system for hologram exposure.

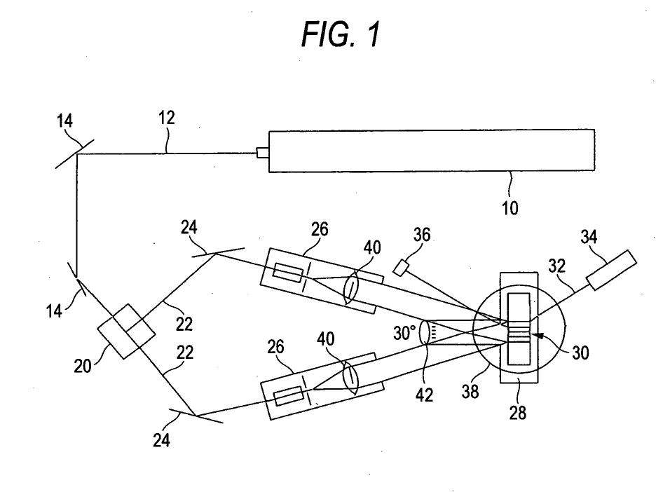

Reference numerals and signs in FIG. 1 are set forth below.

10: YAG laser; 12: Laser beam; 14: Mirror, 20: Beam splitter; 22: Beam segment; 24: Mirror, 26: Spatial filter, 28; Sample; 30: Hologram recording material; 32: He—Ne laser beam; 34: He—Ne laser; 36: Detector; 38: Rotary stage; 40: Beam expander; and 42: Fixing xenon lamp+band pass filter.

### DETAILED DESCRIPTION OF THE INVENTION

Exemplary embodiments of a hologram recording material of the invention will be further described hereinafter.

A hologram recording material of the invention comprises at least: a sensitizing dye which, when subjected to hologram exposure, absorbs light to generate an excited state thereof; and an interference fringes-recording component which undergoes element movement (transfer) or energy movement (transfer) from the excited state of the sensitizing dye to cause color development reaction or discoloration reaction to record interference fringes providing a refractive index modulation, wherein at least one of the sensitizing dye or the interference fringes-recording component is a polymer or oligomer.

The polymer or oligomer of the invention has from not smaller than 2 to not greater than 1,000,000, preferably from not smaller than 3 to not greater than 1,000,000, more preferably from 5 to 500,000, the most preferably from not smaller than 10 to not greater than 100,000 repeating units.

The polymer or oligomer of the invention has a molecular weight of preferably from not smaller than 500 to not greater than 10,000,000, more preferably from not smaller than 1,000 to not greater than 5,000,000, even more preferably from not smaller than 2,000 to not greater than 1,000,000, most preferably from not smaller than 3,000 to not greater than 1,000,000.

The hologram recording method of the invention preferably involves any of (1) color development reaction, (2) latent image color development-coloring material self-sensitized amplification color development reaction, (3) latent image color development reaction-coloring material sensitizing polymerization reaction, (4) dye discoloration reaction and (5) remaining discolorable dye latent image-latent image sensitization polymerization reaction, more preferably any of (1) color development reaction (3) latent color development reaction-coloring material sensitizing polymerization reaction, (4) dye discoloration reaction and (5) remaining discolorable dye latent image-latent image sensitization polymerization reaction to record an interference fringes as refractive index modulation.

It is preferred that the hologram recording material of the invention be not subjected to wet process after hologram exposure.

The hologram recording material of the invention is preferably not of rewritable type. The term “not of rewritable type” as used herein is meant to indicate the type which causes irreversible reaction to perform recording. Once recorded, data can be stored without being rewritten even in an attempt to overwrite thereon. Thus, the hologram recording material of the invention is suitable for the storage of important data which are needed to be stored over an extended period of time. It goes without saying that data can be additionally recorded on unrecorded area. In this sense, this type of a recording material is called “write-once-read-many type” recording material.

The light to be used in the hologram recording method of the invention is preferably any of ultraviolet ray, visible light and ink ray having a wavelength of from 200 to 2,000 nm, more preferably ultraviolet ray or visible light having a wavelength of from 300 to 700 nm, even more preferably visible light having a wavelength of from 400 to 700 nm.

The radiation to be used in the hologram recording method of the invention is preferably coherent laser beam (having uniform phase and wavelength). As the laser to be used herein there may be used any of solid laser, semiconductor laser, gas laser and liquid laser. Preferred examples of laser beam include YAG laser second harmonic having a wavelength of 532 nm, YAG laser third harmonic having a wavelength of 355 nm, semiconductor laser such as GaN laser or InGaN laser having a wavelength of from about 400 to 415 mn, semiconductor laser such as AlGaInP having a wavelength of about 650 nm to 660 nm, Ar ion laser having a wavelength of from 488 nm or 515 nm, He—Ne laser having a wavelength of 632 nm to 633 nm, Kr ion laser having a wavelength of 647 nm, ruby laser having a wavelength of 694 nm, and He—Cd laser having a wavelength of 636 nm, 634 nm, 538 nm, 534 nm and 442 nm.

Further, pulse laser on the order of nanosecond or picosecond is preferably used.

In the case where the hologram recording material of the invention is used as an optical recording medium, YAG laser second harmonic having a wavelength of 532 nm or semiconductor laser such as GaN laser or InGaN laser having a wavelength of from about 400 to 415 nm and AlGaInP laser having a wavelength of from about 650 to 660 nm is preferably used.

The wavelength of the light for use in hologram reproduction is preferably the same as or longer than, more preferably the same as that of the light for use in hologram exposure (recording).

The hologram recording material which has been subjected to hologram exposure may be fixed by either or both of light and heat.

In the case where the hologram recording material of the invention comprises an acid proliferator or base proliferator, it is particularly preferred that fixing be carried out by heating to cause the acid proliferator or base proliferator to act effectively.

In the case of light fixing, the hologram recording material is entirely irradiated with ultraviolet ray or visible light (non-interference exposure). Preferred examples of the light employable herein include visible light laser, ultraviolet laser, carbon are, high voltage mercury vapor lamp, xenon lamp, a halide lamp, fluorescent lamp, tungsten lamp, LED, and organic EL.

In the case of heat fixing, fixing is preferably effect at a temperature of from 40° C. to 160° C., more preferably from 60° C. to 130° C.

In the case where both light fixing and heat fixing are effect, light and heat may be applied at the same time or separately.

The refractive index modulation during recording of interference fringes is preferably from 0.00001 to 0.5, more preferably from 0.0001 to 0.3. It is preferred that the more the thickness of the hologram recording material is, the less is the refractive index modulation. It is preferred that the less the thickness of the hologram recording material is, the more is the refractive index modulation.

The (relative) diffraction efficiency η of a hologram recording material is given by the following equation:
η=Idiff/Io (equation 1)
where Io is the intensity of incident light; and Idiff is the intensity of light which is diffracted (transmitted type) or reflected (reflected type). The diffraction on efficiency may range from 0% to 100%, preferably 30% or more, more preferably 60% or more, most preferably 80% or more.

The sensitivity of a hologram recording material is normally represented by exposure per unit area (mJ/cm²). The less this value is, the higher is the sensitivity. The exposure at which the sensitivity is defined differs from literature or patent to literature or patent. In some cases, the exposure at which recording (refractive index modulation) begins is defined as sensitivity. In other cases, the exposure at which the maximum diffraction efficiency (refractive index modulation) is given is defined as sensitivity. In further cases, the exposure at which half the maximum diffraction efficiency is given is defined as sensitivity. In still further cases, the exposure at which the gradient of diffraction efficiency relative to exposure E becomes maximum is defined as sensitivity.

According to Kugelnick's theoretical equation, the refractive index modulation An at which a certain diffraction efficiency is given is inversely proportional to the thickness d. In other words, the sensitivity at which a certain diffraction efficiency is given differs with thickness. Thus, the more the thickness d is, the less is the required refractive index modulation Δn. Accordingly, the sensitivity cannot be unequivocally compared unless the conditions such as thickness are uniform.

In the invention, sensitivity is defined by “exposure at which half the maximum diffraction efficiency is given (mJ/cm²)”. The sensitivity of the hologram recording material of the invention is preferably 2 J/cm² or less, more preferably 1 J/cm² or less, even more preferably 500 mJ/cm² or less, most preferably 200 mJ/cm² or less if the thickness is from about 10 μM to 200 μm.

In the case where the hologram recording material of the invention is used in holographic memory as an optical recording medium, it is preferred that many two-dimensional digital data (referred to as “signal light”) be recorded using a spatial light modulation element (SLM) such as DMD and LCD. Recording is preferably accomplished by multiplexed recording to raise the recording density. Examples of multiplexed recording methods include angular multiplexed, phase multiplexed, wavelength multiplexed and shift multiplexed recording methods. Preferred among these multiplexed recording methods are angular multiplexed recording and shift multiplexed recording. In order to read reproduced three-dimensional data, CCD or CMOS is preferably used.

In the case where the hologram recording material of the invention is used in holographic memory as an optical recording medium, it is essential that multiplexed recording be effected to enhance the capacity (recording density). In this case, multiplexed recording involving preferably 10 or more times, more preferably 50 times or more, most preferably 100 times or more of recording jobs is performed. More preferably, any multiplexed recording can be effected always at a constant exposure to simplify recording system and enhance S/N ratio.

In the case where the hologram recording material of the invention is used as an optical recording medium, the hologram recording material is preferably stored in a light-shielding cartridge during storage. It is also preferred that the hologram recording material be provided with a light filter capable of cutting part of wavelength range of ultraviolet ray, visible light and infrared ray other than recording light and reproduced light on the surface or back surface or on the both surface thereof.

In the case where the hologram recording material of the invention is used as an optical recording medium, the optical recording medium may be in the form of disc, card or tape or in any other form.

The various hologram recording methods of the invention and various components of the hologram recording material allowing these recording methods will be further described hereinafter.

1) Interference Fringes Recording by Color Development Reaction

The term color “development reaction” as used herein is meant to indicate a reaction involving the change of absorption spectrum form or preferably either or both of the shift of λmax to longer wavelength and rise of e in absorption spectrum in the range of ultraviolet ray, visible light and infrared ray having a wavelength of from 200 nm to 2,000 nm. The color development reaction preferably occurs at a wavelength of from 200 mn to 1,000 nm more preferably from 300 nm to 900 nm.

In the case where recording involves color development reaction, the hologram recording material of the invention preferably contains at least:
1) A sensitizing dye absorbing light upon hologram exposure to generate excited state; and
2) An interference fringe-recording component containing a dye precursor which can form a coloring material that has absorption at longer wavelength than in the original state (i.e., the dye precursor) and no absorption at hologram reproducing light wavelength, which interference fringe-recording component can undergo electron or energy transfer from the excited state of the sensitizing dye to cause color development leading to refractive index modulation by which an interference fringe is recorded.

At least one of the sensitizing dye and the interference fringes-recording component is preferably a polymer or oligomer. More preferably, at least one of the interference fringes-recording components is a polymer or oligomer.

The refractive index of the dye rises in the range of from close to linear absorption maxima wavelength (λmax) to wavelength longer linear absorption maxima wavelength (λmax), rises drastically in the range of from λmax to wavelength about 200 nm longer than λmax. In this wavelength range, some dyes show a refractive index of more than 1.8, as high as more than 2 in some cases. On the other hand, organic compounds which are not a dye, such as binder polymer, normally have a refractive index of from about 1.4 to 1.6.

It is thus made obvious that the color development of the dye precursor by hologram exposure makes it possible to fairly make not only a difference in absorbance but also a great difference in refractive index.

In the hologram recording material of the invention, the refractive index of the dye formed by the recording component preferably maximum in the vicinity of laser wavelength at which reproduction is effected.

The sensitizing dye of the invention which, when subjected to hologram exposure, absorbs light to generate excited state will be further described hereinafter.

Preferred examples of the sensitizing dye include those which absorb any of ultraviolet rays, visible light and infrared rays having a wavelength range of from 200 to 2,000 nm, preferably ultraviolet rays and visible light having a wavelength range of from 300 to 700 nm, more preferably visible light having a wavelength range of from 400 to 700 nm to generate excited state.

Preferred examples of the sensitizing dye include cyanine dye, squarilium dye, styryl dye, pyrilium dye, melocyanine dye, benzylidine dye, oxonol dye, azlenium dye, coumarine dye, ketocoumarine dye, styrylcoumarine dye, pyrane dye, xanthene dye, thioxanthene dye, phenothiazine dye, phenoxazine dye, phenazine dye, phthalocyanine dye, azaporphyrin dye, porphyrin dye, condensed aromatic dye, perylene dye, azomethane dye, anthraquinone dye, metal complex dye, and metalocene dye. More desirable among these sensitizing dyes are cyanine dye, squarilium cyanine dye, pyrilium dye, melocyanine dye, oxonol dye, coumarine dye, ketocoumarine dye, styrylcoumarine dye, pyrane dye, xanthene dye, thioxanthene dye, condensed aromatic dye, metal complex dye, and metalocene dye. Even more desirable among these sensitizing dyes are cyanine dye, melocyanine dye, oxonol dye, benzylidne dye, and styryl dye. As the metal complex dyes, Ru complex dyes are particularly preferred. As the metalocene dyes, ferrocenes are particularly preferred.

In addition to these sensitizing dyes, dyes and dyestuffs disclosed in Sinya Ogawara, “Shikiso Handobukku (Handbook of Dyes)”, Kodansha, 1986, Shinya Ogawara, “Kinosei Shikiso no Kagaku (Chemistry of Functional Dyes)” , CMC, 1981, and Tadasaburo Ikemori, “Tokushu Kino Zairyo (Specially Functional Materials)”, CMC, 1986 may be used as sensitizing dye of the invention. The sensitizing dye to be used in the invention is not limited to these examples. Any dye or dyestuff may be used so far as it absorbs light in the visible range. These sensitizing dyes may be selected such that they are adapted for the wavelength of radiation from the light source depending on the purpose. Two or more sensitizing dyes may be used in combination depending on the purpose.

Since the hologram recording material needs to be used in the form of thick layer and light needs to be transmitted by the layer, the molar absorption coefficient of the sensitizing dye at the wavelength of hologram exposure is preferably reduced to maximize the added amount of the sensitizing dye for the purpose of enhancing sensitivity. The molar absorption coefficient of the sensitizing dye at the wavelength of hologram exposure is preferably from not smaller than 1 to not greater than 10,000, more preferably from not smaller than 1 to not greater than 5,000, even more preferably from not smaller than 5 to not greater than 2,500, most preferably from not smaller than 10 to not greater than 1,000.

The transmittance of the hologram recording material at the recording wavelength is preferably from 10% to 99%, more preferably from 20% to 95%, even more preferably from 30% to 90%, particularly from 40% to 85% from the standpoint of diffraction efficiency, sensitivity and recording density (multiplexity). To this end, the molar absorption coefficient of the sensitizing dye at the recording wavelength and the molarity of the sensitizing dye to be added are preferably adjusted according to the thickness of the hologram recording material.

λmax of the sensitizing dye is preferably shorter than the wavelength of hologram recording, more preferably between the wavelength of hologram recording and the wavelength of 100 nm shorter than the wavelength of hologram recording.

Further, the molar absorption coefficient of the sensitizing dye at the recording wavelength is preferably one fifth or less, more preferably one tenth or less of that at λmax. In particular, when the sensitizing dye is an organic dye such as cyanine dye and melocyanine dye, the molar absorption coefficient of the sensitizing dye at the recording wavelength is more preferably one twentieth or less, even more preferably one fiftieth or less, particularly one hundredth or less of that at λmax.

Specific examples of the sensitizing dye of the invention which is neither a polymer nor an oligomer will be given below, but the invention is not limited thereto.

<Cyanine dye>

| | |
|---|---|
| S-1 | S-2 |
| 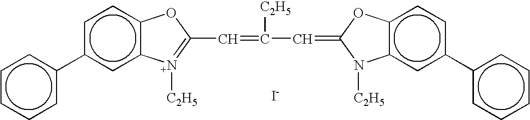 | 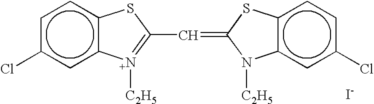 |
| S-3 | S-4 |
| 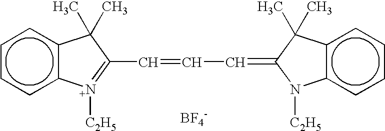 | 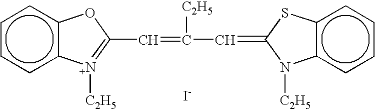 |

S-5

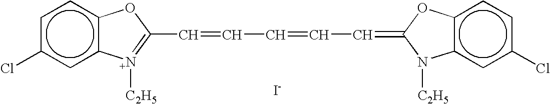

| | |
|---|---|
| S-6 | S-7 |
| 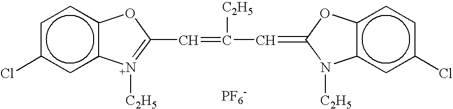 | 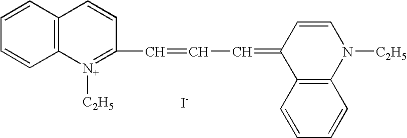 |

S-8

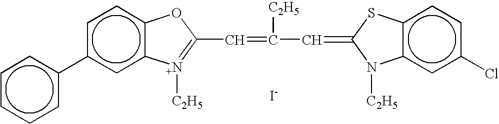

| | |
|---|---|
| S-9 | S-10 |
| 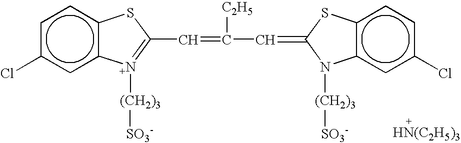 | 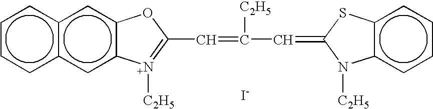 |
| S-11 | |
| 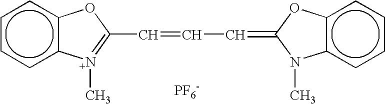 | |
| <Squarilium cyanine dye> | |

| | |
|---|---|
| S-12 | S-13 |
| 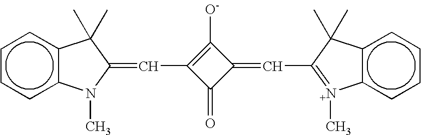 | 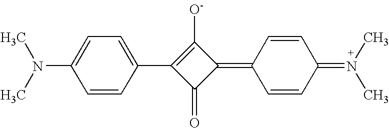 |
| <Styryl dye> | |
| S-14 | S-15 |
| 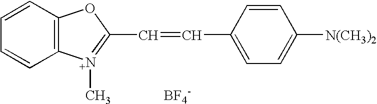 | 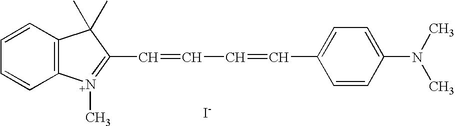 |
| <Pyrilium dye> | |

| | |
|---|---|
| 8-16 | 8-17 |
| 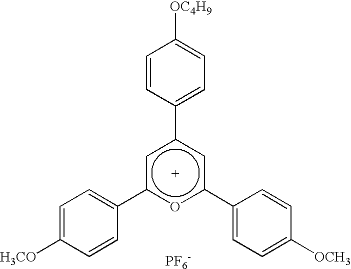 | 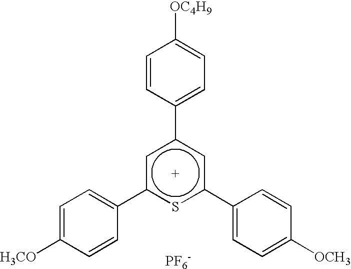 |
| <Melocyanine dye> | |

| | | n51 |
|---|---|---|
| 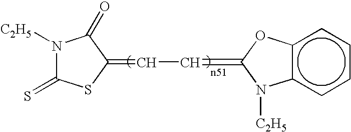 | S-18 S-19 S-20 | 0 1 2 |
| | | n51 |
| 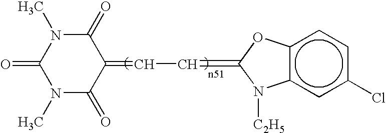 | S-21 S-22 | 1 2 |
| | | n51 |
| 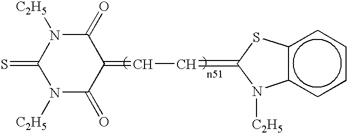 | S-23 S-24 | 1 2 |

Q₅₁═CH—CH═Q₅₂

| | Q₅₁ | Q₅₂ | | Q₅₁ | Q₅₂ |
|---|---|---|---|---|---|
| S-25 | 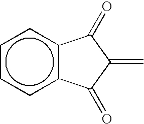 | 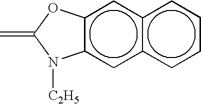 | S-26 | get,0023 | 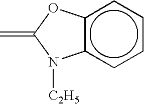 |
| S-27 | 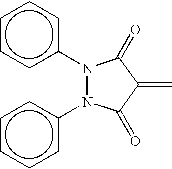 | 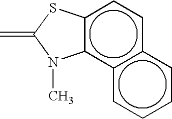 | S-28 | 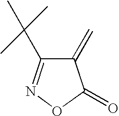 | 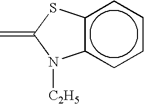 |
| S-29 | 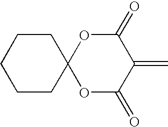 | 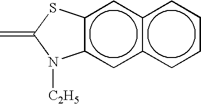 | | | |

S-30

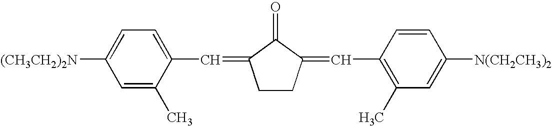

S-31

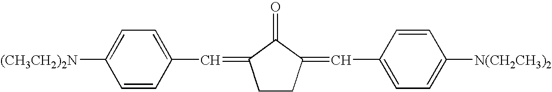

| | |
|---|---|
| S-32 | S-33 |
| 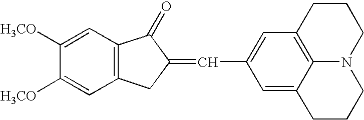 | 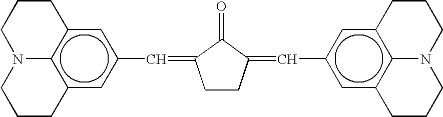 |

S-34

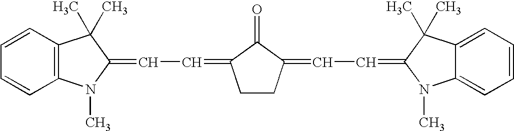

S-35

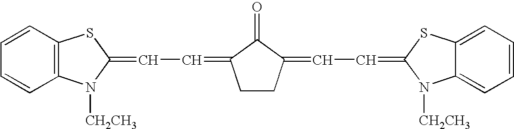

S-36

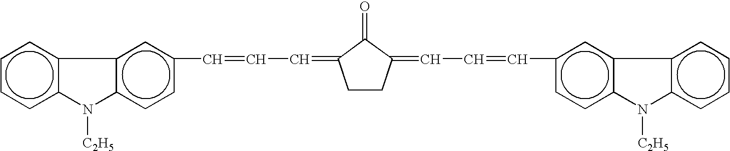

<Arylidene dye>

| S-37 | | |
|---|---|---|
| 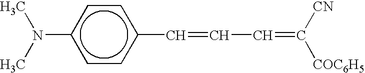 | | |
| | | n52 |
| 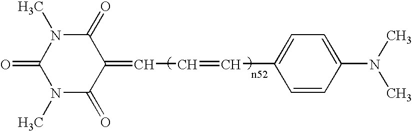 | S-38 S-39 | 0 1 |
| 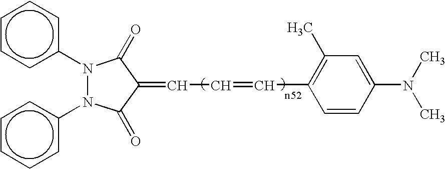 | S-40 S-41 | 0 1 |

<Oxonal dye>

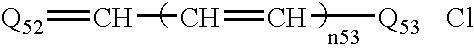

| | Q₅₂ | Q₅₃ | n₅₃ | Cl |
|---|---|---|---|---|
| S-42 | 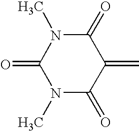 | 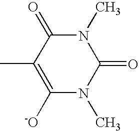 | 2 | H⁺ |
| S-43 | 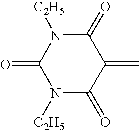 | 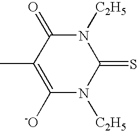 | 1 | 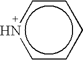 |
| S-44 | 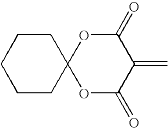 | 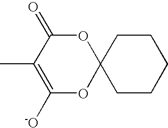 | 2 | H⁺ |
| S-45 | 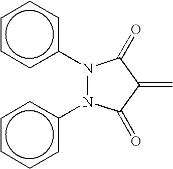 | 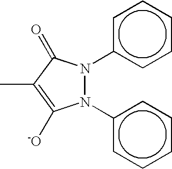 | 1 | H⁺ |
| S-46 | 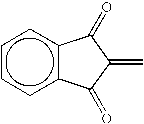 | 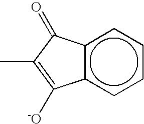 | 1 | 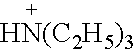 |

<Axionium dye>

S-47

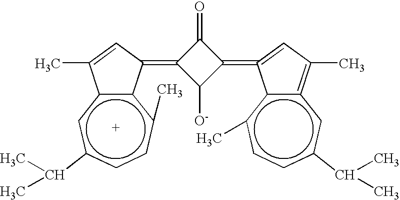

<Coumarine dye>

| | |
|---|---|
| S-48 | S-49 |
| 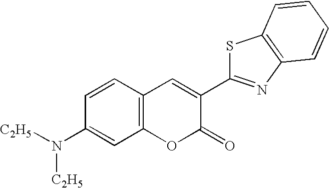 | 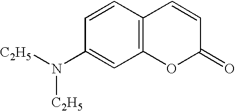 |

<Kotocoumarine dye>

| | |
|---|---|
| S-50 | S-51 |
| 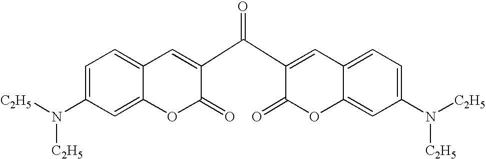 | 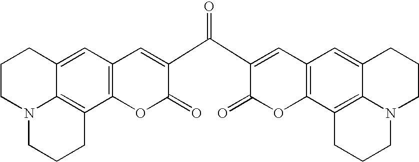 |

<Styrylcoumarine dye>

| | |
|---|---|
| S-52 | S-53 |
| 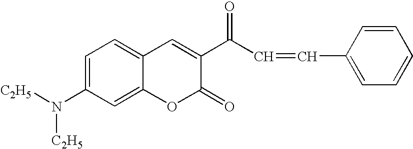 | 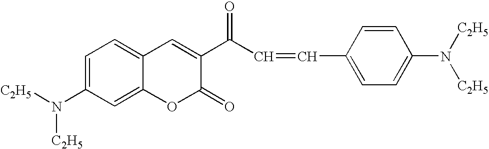 |

| | |
|---|---|
| <Pyrane dye> | <Xanthane dye> |
| | S-57 |
| 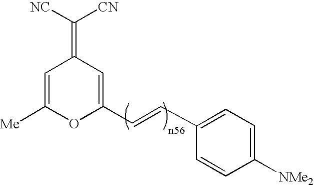 | 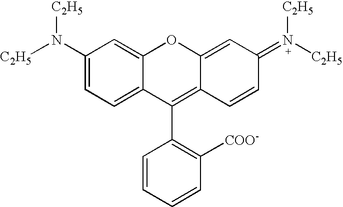 |

| | n55 | |
|---|---|---|
| S-54 | 1 | S-58 |
| S-55 S-56 | 2 3 | 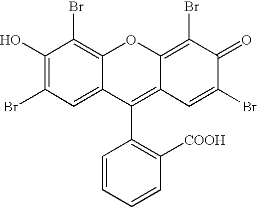 |

| | |
|---|---|
| <Thioxanthane dye> | <Phenothiazine dye> |
| S-59 | S-60 |
| 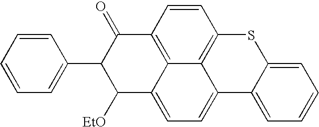 | 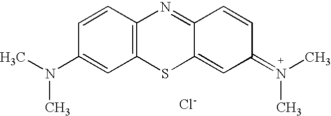 |

| | |
|---|---|
| <Phenoxazine dye> | <Phenazine dye> |
| S-61 | S-62 |
| 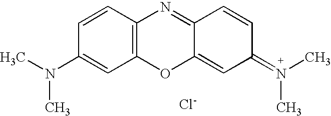 | 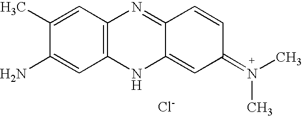 |

| | |
|---|---|
| <Phthalocyanine dye> | <Azaparphiline dye> |
| S-63 | S-64 |
| 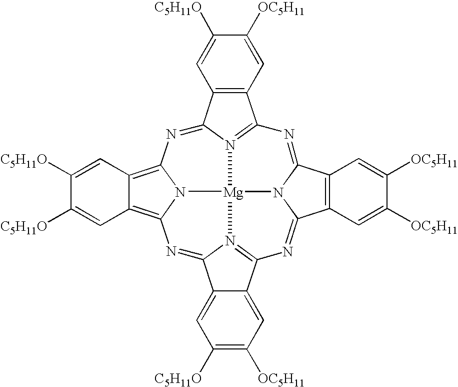 | 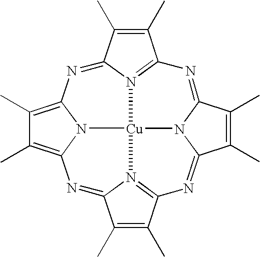 |

| | | |
|---|---|---|
| <Porphiline dye> | <Condenced aromatic dye> | |
| S-65 | S-68 | S-67 |
| 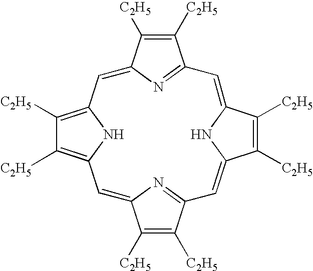 | 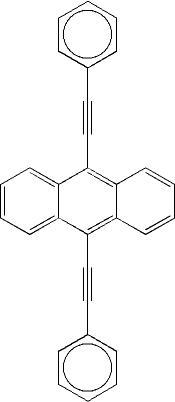 | 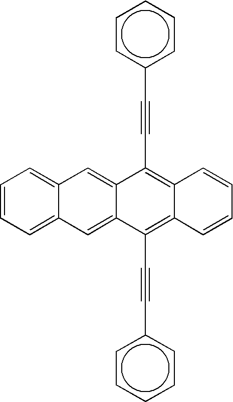 |

| | |
|---|---|
| <Porylorte dye> | <Azomethine dye> |
| S-68 | S-69 |
| 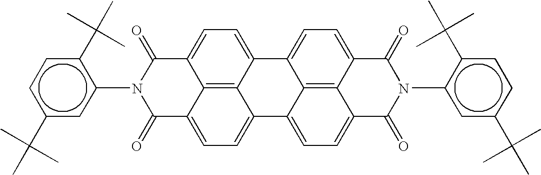 | 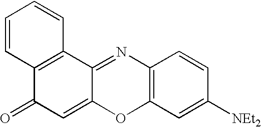 |

| | | |
|---|---|---|
| <Anthraquinone dye> | <Metal complex dye> | |
| S-70 | S-71 | S-72 |
| 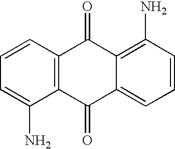 | 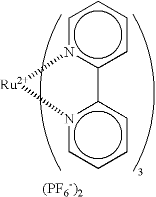 | 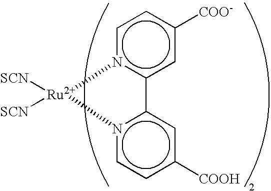 |

| | | | |
|---|---|---|---|
| S-73 | S-74 | S-75 | S-76 |
| 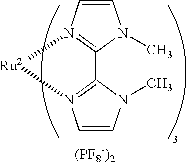 | 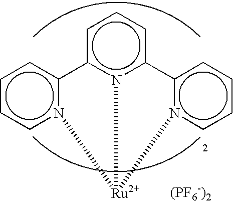 | 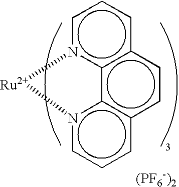 | 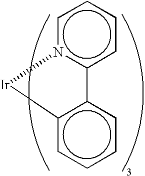 |

| | | | |
|---|---|---|---|
| S-77 | S-78 | S-79 | S-80 |
| 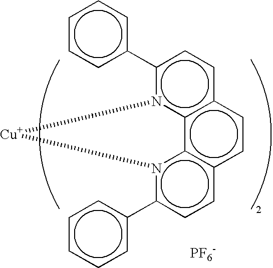 | 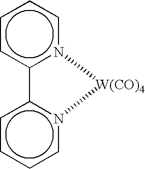 | 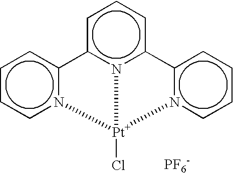 | 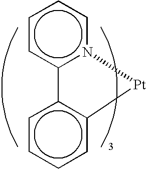 |

| <Metalocene dye> | | |
|---|---|---|
| | | R₅₁ |
| S-81 | S-82 | —CHO |
| 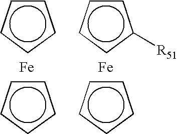 | S-83 S-84 S-85 | —CH₂CH₂COOH —CH₂CH₂COOCH₃ 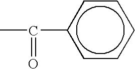 |
| | S-86 | —CH₂OH |
| | S-87 | —COOCH₃ |

| | | |
|---|---|---|
| S-88 | S-89 | S-90 |
| 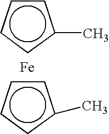 | 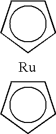 | 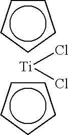 |

<Cyanine dye (continued)>

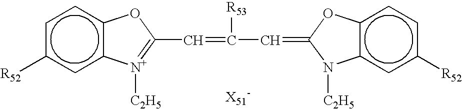

| | R₅₂ | R₅₃ | X₅₁⁻ |
|---|---|---|---|
| S-91 | —Cl | —H | I⁻ |
| S-92 | —H | —C₂H₅ | I⁻ |
| S-93 | —H | —H | I⁻ |
| S-94 | —H | —H | I⁻ |
| S-95 | —Br | —H | BF₄⁻ |
| S-96 | —CH₃ | —H | I⁻ |
| S-97 | —OCH₃ | —C₂H₅ | PF₆⁻ |

| 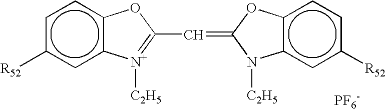 | | 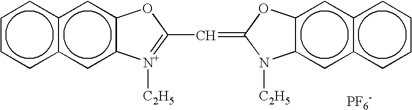 |
|---|---|---|
| | R₅₂ | |
| S-96 | —H | S-103 |
| S-99 S-100 S-101 S-102 | —Cl —Ph —CH₃—OCH₃ | 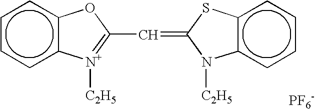 |

In the hologram recording material, the polymer or oligomer which is a sensitizing dye may contain a sensitizing dye in its main chain or in its side chains, preferably in its side chains. The polymer or oligomer containing a sensitizing dye in its side chains may be a homopolymer, a copolymer of two or more monomers containing a sensitizing dye in its side chains or a copolymer of a monomer containing a sensitizing dye in its side chains with a monomer free of a sensitizing dye in its side chains.

In the invention, however, the sensitizing dye is preferably not a polymer or oligomer.

In the case where the sensitizing dye in the hologram recording material of the invention is a polymer or oligomer, it is preferably a polymer or oligomer containing the sensitizing dye exemplified above in its main chain or in its side chains.

Particularly preferred examples of sensitizing dye polymer or oligomer will be given below, but the invention is not limited thereto.

| | | R₆₁ | R₆₂ |
|---|---|---|---|
| 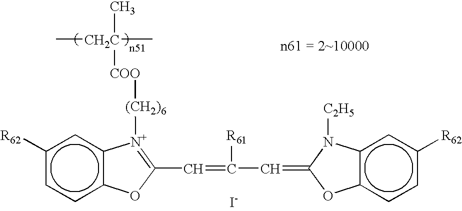 | PS-1 PS-2 PS-3 | —H —C₂H₅—H | —H —H —Cl |

| | | R₆₁ | R₆₂ | n64 |
|---|---|---|---|---|
| 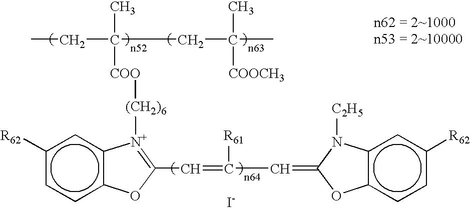 | PS-4 PS-5 PS-6 PS-7 PS-8 | —H —C₂H₅—H —H —H | —H —H —Cl —H —Cl | 1 1 1 0 2 |

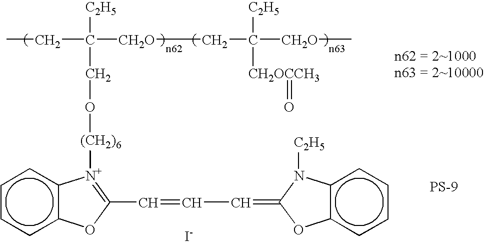

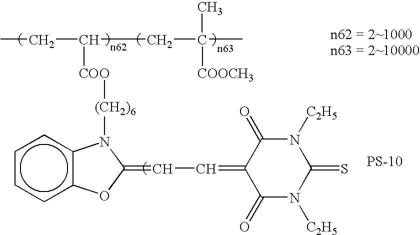

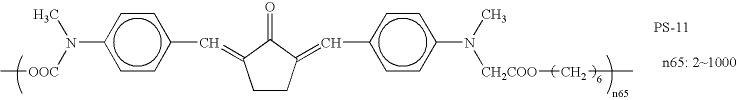

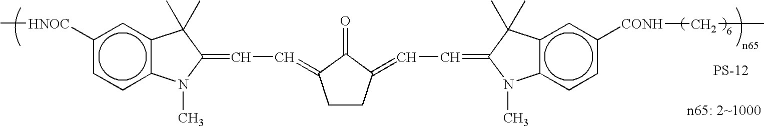

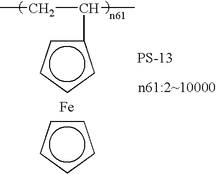

| | |
|---|---|
| 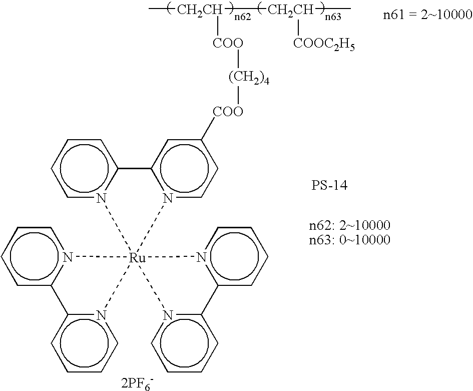 | 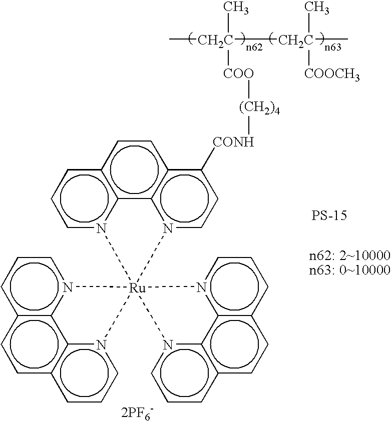 |

In the case where hologram recording is effected using frequency-doubled YAG laser beam of 532 nm, the sensitizing dye to be used is particularly preferably a trimethinecyamine dye having a benzoxazole ring, Ru complex dye or ferrocene. In the case hologram recording is effected using GaN laser beam of 400 to 415 nm, the sensitizing dye to be used is particularly preferably a monomethinecyanic dye having a benzoxazole ring, Ru complex dye or ferrocene.

Other preferred examples of sensitizing dye of the invention are disclosed in Japanese Patent Application No. 2004-238427. The sensitizing dye of the invention is commercially available or can be synthesized by any known method.

Preferred combinations of interference fringes-recording components in the hologram recording material capable of performing 1) interference fringes recording involving color development reaction will be given below. Specific preferred examples of these combinations include those disclosed in Japanese Patent Application No. 2004-238077.
i) Combination of at least an acid-colorable dye precursor as dye precursor, an acid generator and optionally an acid proliferator
ii) Combination of at least a base-colorable dye precursor as dye precursor, a base generator and optionally a base proliferator
iii) A compound having an organic compound moiety capable of disconnecting covalent bond upon electron movement or energy movement from or to the excited state of the sensitizing dye and an organic compound moiety capable of forming a coloring material during covalent bonding and when released, which moieties being covalently bound, optionally combined with a base.
iv) Compound capable of reacting upon electron movement from or to the excited state of the sensitizing dye to change absorption form. A so called electrochromic compound is preferably used.

These combinations will be further described hereinafter.

i) Combination of at Least an Acid-Colorable Dye Precursor as Dye Precursor, an Acid Generator and Optionally an Acid Proliferator

In the hologram recording material of the invention in this form, it is preferred that either the acid-colorable dye precursor or the acid generator is a polymer or oligomer. Both the acid-colorable dye precursor and the acid generator may be a polymer or oligomer. It may also be a copolymer.

An acid generator is a compound capable of generating an acid upon the movement of energy or electron from the excited state of the sensitizing dye. The acid generator preferably stays stable in the dark. The acid generator in the invention is preferably a compound capable of generating an acid upon the movement of electron from the excited state of the sensitizing dye.

The acid generator is preferably any of trihalomethyl-substituted triazine-based acid generator, diazonium salt-based acid generator, diaryl iodonium salt-based acid generator, sulfonium salt-based acid generator, metal-allene complex-based acid generator and sulfonic acid ester-based acid generator, more preferably diaryl iodonium salt-based acid generator, sulfonium salt-based acid generator or sulfonic acid ester-based acid generator. Preferred examples of acid generator include those disclosed in Japanese Patent Application No. 2004-238077.

The polymer or oligomer which is an acid generator may contain an acid generator in its main chain or in its side chains, preferably in its side chains. The polymer or oligomer containing an acid generator in its side chains may be a copolymer of two or more monomers containing an acid generator in its side chains or a copolymer of a monomer containing an acid generator in its side chains with a monomer free of an acid generator in its side chains.

Specific preferred examples of acid generator which is neither a polymer nor an oligomer will be given below, but the invention is not limited thereto.

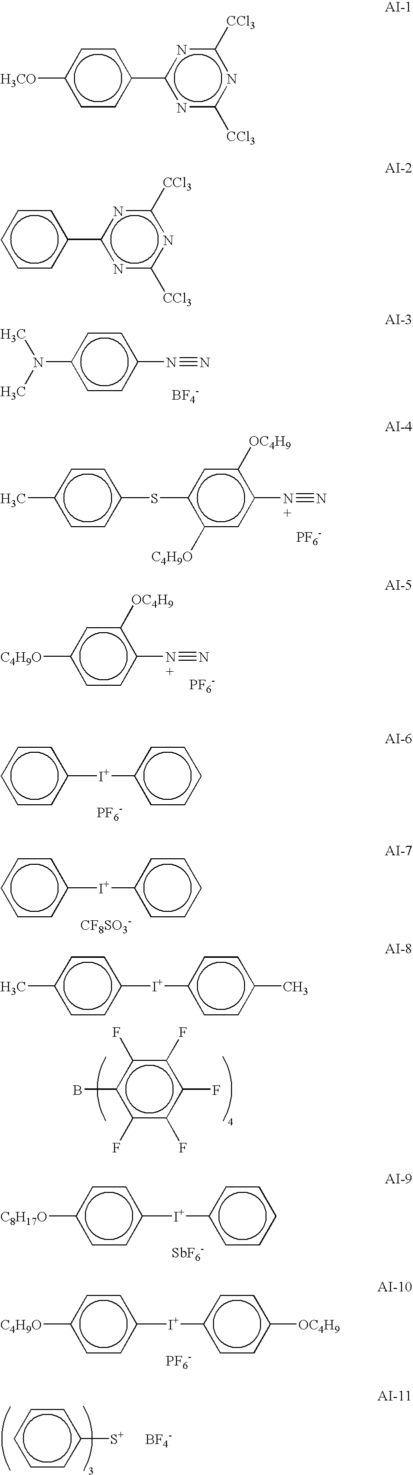

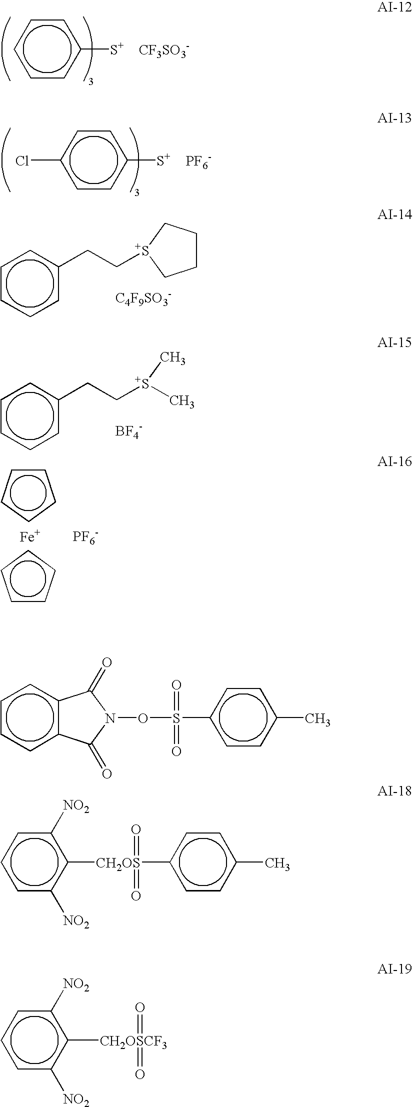

When the acid generator in the hologram recording material of the invention is a polymer or oligomer, it is preferably a polymer or oligomer containing the acid generator exemplified above in its main chain or in its side chains.

Particularly preferred examples of the acid generator polymer or oligomer will be given below, but the invention is not limited thereto.

| | | R₆₃ |
|---|---|---|
| 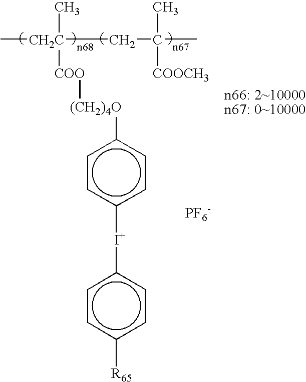 | PAI-1 PAI-2 | —H —OCH₃ |

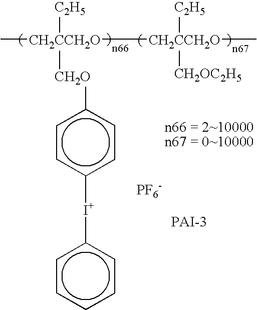

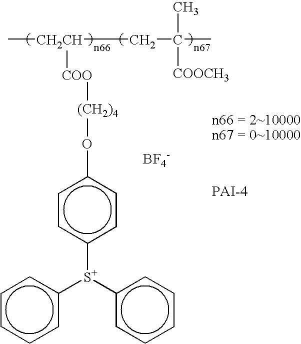

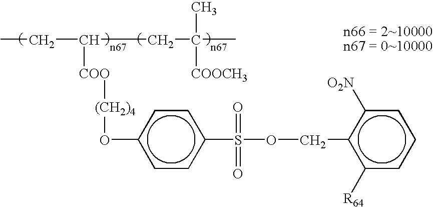

| | R₆₄ |
|---|---|
| PAI-5 | H |
| PAI-6 | —NO₂ |

An acid proliferator is preferably used to enhance sensitivity. Specific preferred examples of acid proliferator include those disclosed in Japanese Patent Application No. 2003-182849.

The acid-colorable dye precursor will be further described hereinafter.

The polymer or oligomer which is an acid-colorable dye: precursor may contain an acid-colorable dye precursor in its main chain or in its side chains, preferably in its side chains. The polymer or oligomer containing an acid-colorable dye precursor in its side chains may be a copolymer of two or more monomers containing an acid-colorable dye precursor in its side chains or a copolymer of a monomer containing an acid-colorable dye precursor in its side chains with a monomer free of an acid-colorable dye precursor in its side chains.

Preferred examples of the coloring material produced from the acid-colorable dye precursor include xanthene dyes, fluorane dyes, and triphenylmethane dyes. Particularly preferred examples of the acid-colorable dye precursor will be given below, but the invention is not limited thereto.

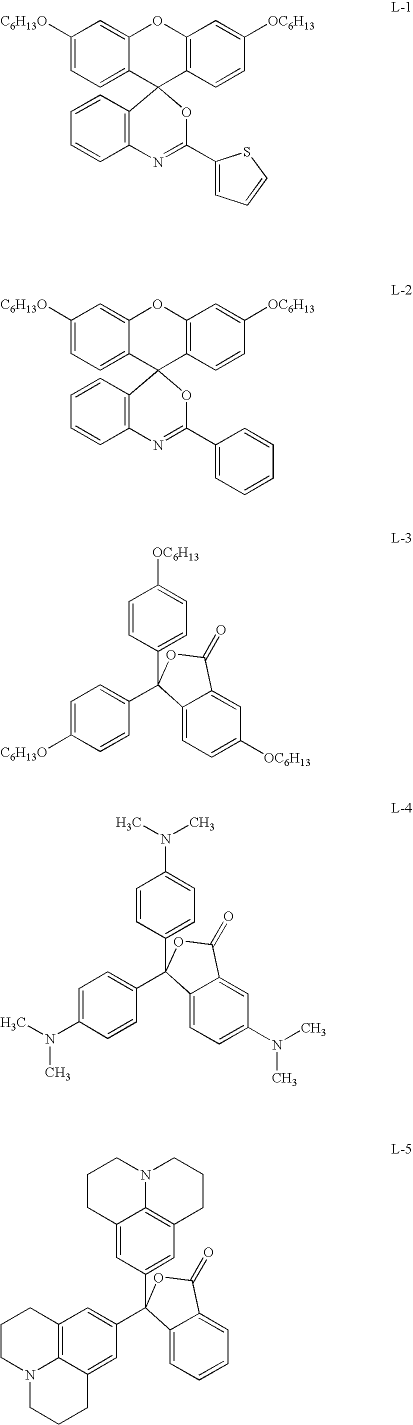

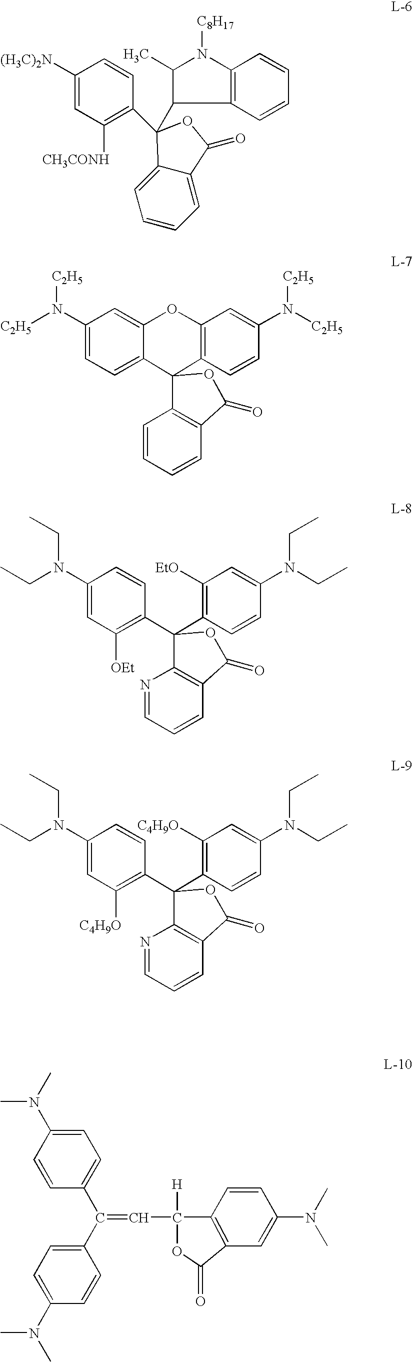

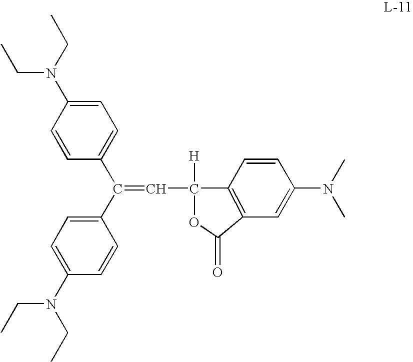

As the acid generation type dye precursor of the invention there is preferably used a cyanine base (leucocyanine dye) which develops color when an acid (proton) is added thereto. Specific preferred examples of the cyanine base will be given below, but the invention is not limited thereto.

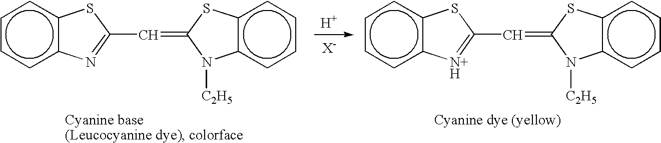

| | | n₅₆ |
|---|---|---|
| 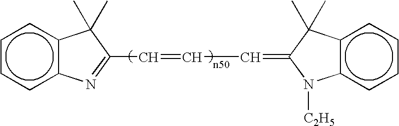 | LC-1 LC-2 LC-3 | 0 1 2 |
| | | n₅₆ |
| 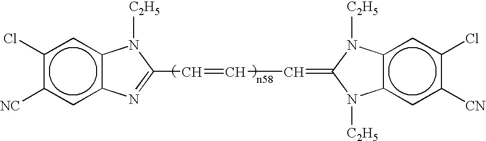 | LC-4 LC-5 LC-6 | 0 1 2 |
| | | n₅₆ |
| 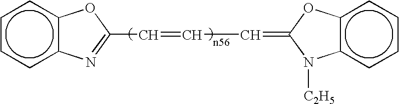 | LC-7 LC-8 | 0 1 |
| | | n₅₆ |
| 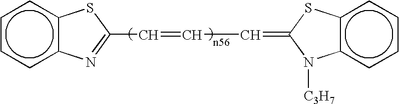 | LC-9 LC-10 | 0 1 |

| | |
|---|---|
| 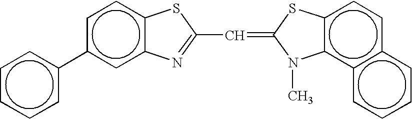 | 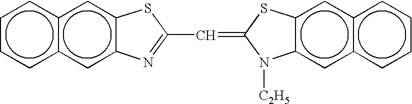 |
| 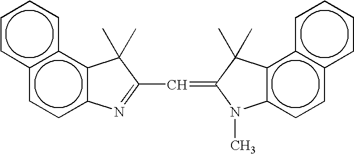 | 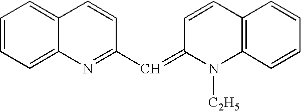 |
| | 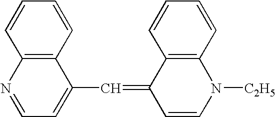 |

When the acid-colorable dye precursor in the hologram recording material of the invention is a polymer or oligomer, it is preferably a polymer or oligomer containing the acid-colorable dye precursor exemplified above in its main chain or in its side chains.

Particularly preferred examples of the acid-colorable dye precursor polymer or oligomer will be given below, but the invention is not limited thereto.

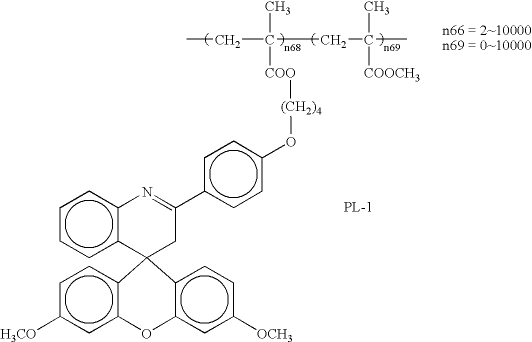

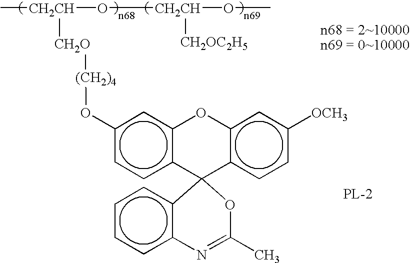

| | | n70 | R₆₄ | X₆₁ |
|---|---|---|---|---|
| 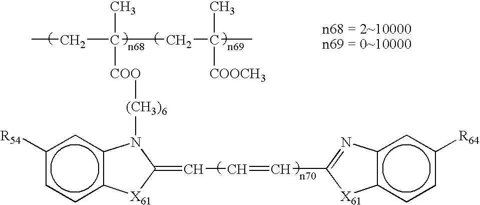 | PL-3 PL-4 PL-5 PL-6 PL-7 PL-8 | 0 0 1 1 0 1 | —Cl —OCH₃—H —Cl —H —H | —S——S——S——S——C(CH₃)₂——C(CH₃)₂— |

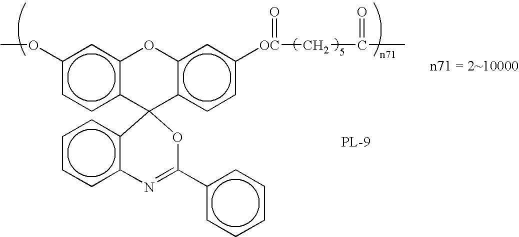

It is also preferred that the hologram recording material of the invention comprise a polymer or oligomer which is a copolymer of a monomer containing an acid generator in its side chains with a monomer containing an acid-colorable dye precursor in its side chains as exemplified below.

| | | R₆₃ |
|---|---|---|
| 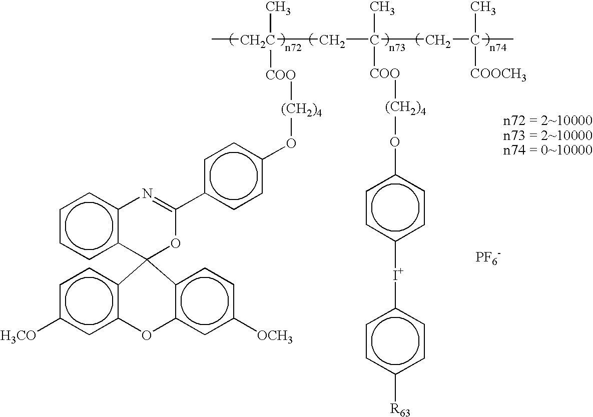 | PAL-1 PAL-2 | H —OCH₃ |

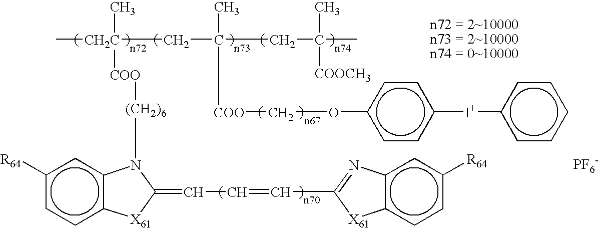

| | n70 | R₆₄ | X₆₁ |
|---|---|---|---|
| PAL-3 | 0 | —Cl | —S— |
| PAL-4 | 0 | —OCH₃ | —S— |
| PAL-5 | 1 | —Cl | —S— |
| PAL-6 | 0 | H | —C(CH₃)₂— |
| PAL-7 | 1 | H | —C(CH₃)₂— |

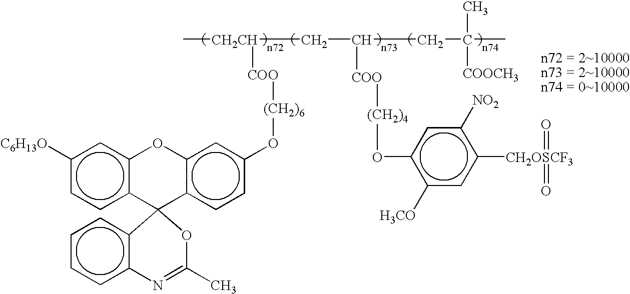

ii) Combination of at Least a Base-Colorable Dye Precursor as Dye Precursor, a Base Generator and Optionally a Base Proliferator

In the hologram recording material of the invention in this form, either the base-colorable dye precursor or the base generator is a polymer or oligomer. Both the base-colorable dye precursor and the base generator may be a polymer or oligomer, It may also be a copolymer.

A base generator is a compound capable of generating an acid upon the movement of energy or electron from the excited state of the sensitizing dye. The base generator preferably stays stable in the dark. The base generator in the invention is preferably a compound capable of generating a base upon the movement of electron from the excited state of the sensitizing dye.

The base generator of the invention preferably generates a Bronsted base, more preferably an organic base, particularly an amino as organic base when irritated with light.

The base generator of the invention is represented by any of the formulae (3-1) to (3-4). Two or more of these base generators may be used in admixture at an arbitrary ratio.

In the formula (3-1) or (3-2), R₁ and R₂ each independently represent a hydrogen atom, alkyl group (preferably C₁-C₂₀ alkyl group such as methyl, ethyl, n-propyl, isopropyl, n-butyl, n-pentyl, n-octadecyl, benzyl, 3-sulfopropyl, 4-sulfobutyl, carboxylmethyl and 5-carboxypentyl), alkenyl group (preferably C₁₂-C₂₀ alkenyl group such as vinyl, allyl, 2-butenyl, 1,3-butadienyl), cycloalkyl group (preferably C₃C₂₀ cycloalkyl group such as cyclopentyl and cyclohexyl), aryl group (preferably C₆-C₂₀ aryl group such as phenyl, 2-chlorophennyl 4-methoxyphenyl, 3-methylphenyl and 1-naphthyl, 2-naphthyl) or heterocyclic group (preferably C₁-C₂₀ heterocyclic group such as pyridyl, chenyl, furyl, thiazolyl, imidazolyl, pyrazolyl, pyrrolidino and morpholino), preferably hydrogen atom, alkyl group or cycloalkyl group, more preferably hydrogen atom, methyl group, ethyl group, cyclohexyl group or cyclopentyl group.

R₁ and R₂ may be connected to each other to form a ring. Preferred examples of the heterocyclic ring thus formed include piperidine ring, pyrrolidine ring, piperazine ring, morpholine ring, pyridine ring, quinoline ring, and imidazole ring. More desirable among these heterocyclic rings are piperidine ring, pyrrolidine ring, and imidazole ring. Most desirable among these heterocyclic rings is piperidine ring.

Referring to preferred combination of R₁ and R₂, R₁ may be a cyclohexyl group which may be substituted and R₂ may be a hydrogen atom. Alternatively, R₁ may be an alkyl group which may be substituted and R₂ may be a hydrogen atom. Further, R₁ and R₂ may be connected to each other to form a piperidine ring or imidazole ring.

In the formula (3-1) or (3-2), n1 represents 0 or 1. preferably 1.

In the formula (3-1), R₃'s each independently represent a substituent. Preferred examples of the substituent R₃ include alkyl group (preferably alkyl group having from 1 to 20 carbon atoms such as methyl, ethyl, n-propyl, isopropyl, n-butyl, n-pentyl, benzyl, 3-sulfopropyl, 4-sulfobutyl, carboxymethyl, 5-carboxypentyl), alkenyl groups (preferably alkenyl group having from 2 to 20 carbon atoms such as vinyl, allyl, 3-butenyl and 1,3-butadienyl), cycloalkyl groups (preferably cycloalkyl group having from 3 to 20 carbon atoms such as cyclopentyl and cyclohexyl), aryl groups (preferably aryl group having from 6 to 20 carbon atoms such as phenyl, 2-chlorophenyl, 4-methoxyphenyl, 3-methylphenyl and 1-naphthyl), heterocyclic groups (preferably heterocyclic group having from 1 to 20 carbon atoms such as pyridyl, chenyl, furyl, thiazolyl, imidazolyl, pyrazolyl, pyrrolidino, piperidino, morpholino), alkinyl groups (preferably having from 2 to 20 carbon atoms such as ethinyl, 2-propinyl, 1,3-butadinyl and 2-phenylethinyl), halogen atoms (e.g., F, Cl, Br, I), amino groups preferably amino group having from 0 to 20 carbon atoms such as amino, dimethylamino, dimethylamino, dibutylamino and anilino), cyano groups, nitro groups, hydroxyl groups, mercapto groups, carboxyl groups, sulfo groups, phosphonic acid groups, acyl groups (preferably acyl group having from 1 to 20 carbon atoms such as actyl, benzoyl, salicyloyl, pivaloyl), alkoxy groups (preferably alkoxy group having form 1 to 20 carbon atoms such as methoxy, butoxy and cyclohexyloxy), aryloxy groups (preferably aryloxy group having from 6 to 26 carbon atoms such as phenoxy and 1-npahthoxy), alkylthiho groups preferably alkylthio group having from 1 to 20 carbon atoms such as methylthio and ethylthio), arylthio groups (preferably arylthio group having from 6 to 20 carbon atoms such as phenylthio and 4-chlorophenylthio), alkylsulfonyl groups (preferably alkylsulfonyl group having from 1 to 20 carbon atoms such as methane sulfonyl and butanesulfonyl), arylsulfonyl groups (preferably arylsulfonyl group having from 6 to 20 carbon atoms such as benzenesulfonyl and paratoluenesulfonyl), sulfamoyl groups (preferably sulfamoyl group having from 0 to 20 carbon atoms such as sulfamoyl, N-methylsulfamoyl and N-phenylsulfamoyl), carbamoyl groups (preferably carbamoyl group having from 1 to 20 carbon atoms such as carbamoyl, N-methylcarbamoyl, N,N-dimethylcarbamoyl and N-phenylcorbamoyl), acylamino groups (preferably acylamino group having from 1 to 20 carbon atoms such as acetylamino and benzoylamino), imino groups (preferably imino group having from 2 to 20 carbon atoms such as phthalimino), acyloxy groups (preferably acryloxy group having from 1 to 20 carbon atoms such as acetyloxy and benzoyloxy), alkoxycarbonyl groups (preferably alkoxyonyl group having from 2 to 20 carbon atoms such as methoxycarbonyl and phenoxycarbonyl), and carbamoylamino groups (preferably carbamoylamino group having from 1 to 20 carbon atoms such as carbamoylamino, N-methylcarbamoylamino and N-phenylcarbamoylamino. More desirable among these substituents are allyl groups, aryl groups, heterocyclic groups, halogen atoms, amino groups, cyano groups, nitro groups, carboxyl groups, sulfo groups, alkoxy groups, alkylthio groups, arylslfonyl groups, sulfamoyl groups, carbamoyl groups, and alkoxycarbonyl groups.

In the formula (3-1), R₃ is preferably a nito group or alkoxy group, more preferably nitro group or methoxy group, most preferably nitro group.

In the formula (3-1), n2 represents an integer of from 0 to 5, preferably from 0 to 3, more preferably 1 or 2. When n2 is 2 or more, the plurality of R₃'s may be the same or different and may be connected to each other to form a ring. Preferred examples of the ring thus formed include benzene ring, and naphthalene ring.

In the formula (3-1), the nitro group represented by R₃ is preferably on the 2-position or 2,6-position. The alkoxy group represented by R₃ is preferably on the 3,5-position.

In the formula (3-1), R₄ and R₅ each independently represent a hydrogen atom or substituent (preferred examples of the substituent include those exemplified with reference to R₃) (preferred examples include those exemplified with reference to R₃), preferably hydrogen atom, alkyl group or aryl group, more preferably hydrogen atom, methyl group or 2-nitrophenyl group.

Referring to preferred combinations of R₄ and R₅, R₄ and R₅ are both a hydrogen atom. Alternatively, R₄ is a methyl group and R₅ is a hydrogen atom. Alternatively, R₄ and R₅ are both a methyl group. Alteratively, R₄ is a 2-nitrophenyl group and R₅ is a hydrogen atom. More preferably, R₄ and R₅ are both a hydrogen atom.

In the formula (3-2), R₆ and R₇ each represent a substituent (Preferred examples of the substituent include those exemplified with reference to R₃), preferably alkoxy group, alkylthio group, nitro group or alkyl group, more preferably methoxy group.

In the formula (3-2), n3 and n4 each independently represent an integer of from 0 to 5, preferably from 0 to 2, When n3 and n4 each are 2 or more, the plurality of R₆'s and R₇'s may be the same or different and may be connected to each other to form a ring. Preferred examples of the ring thus formed include benzene ring, and naphthalene ring.

In the formula (3-2), R₆ is more preferably an alkoxy group on the 3,5-position, even more preferably methoxy group on the 3,5-position.

In the formula (3-2), R₆ represents a hydrogen atom or substituent (Preferred examples of the substituent include those exemplified with reference to R₃), preferably a hydrogen atom or aryl group, more preferably hydrogen atom.

In the formula (3-3) R₉ represents a substituent (Preferred examples of the substituent include those exemplified with reference to R₃), preferably alkyl group, aryl group, benzyl group or amino group, more preferably alkyl group which may be substituted, t-butyl group, phenyl group, benzyl group, anilino group which may be substituted or cyclohexylamino group.

The compound represented by the formula (3-3) may be a compound connected to a polymer chain at R₉.

In the formula (3-3), R₁₀ and R₁₁ each independently represent a hydrogen atom or substituent (Preferred examples of the substituent include those exemplified with reference to R₃), preferably alkyl group or aryl group, more preferably methyl group, phenyl group or 2-naphthyl group.

R₁₀ and R₁₁ may be connected to each other to form a ring. Preferred examples of the ring thus formed include fluorene ring.

In the formula (3-4), R₁₂ represents an aryl group or heterocyclic group, more preferably the following aryl group or heterocyclic group.

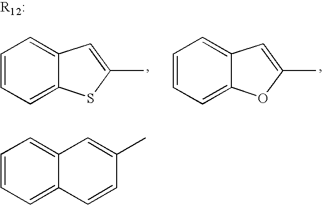

In the formula (3-4), R₁₃, R₁₄ and R₁₅ each independently represent a hydrogen atom, alkyl group, alkenyl group, cycloalkyl group, aryl group or heterocyclic group (Preferred examples of these groups include those exemplified above with reference to R₁ and R₂), preferably alkyl group, more preferably butyl group. R₁₃, R₁₄ and R₁₅ may be connected to each other to form a ring. Preferred examples of the heterocyclic ring thus formed include piperdine ring, pyrrolidine ring, piperazine ring, morpholine ring, pyridine ring, quinoline ring, and imidazole ring. More desirable among these heterocyclic rings are piperidine ring, pyrrolidine ring, and imidazole ring.

In the formula (3-4), R₁₆, R₁₇, R₁₈ and R₁₉ each independently represent an alkyl group or aryl group, R₁₆, R₁₇ and R₁₈ each are preferably a phenyl group. R₁₉ is preferably an an-butyl group or phenyl group.

The base generator of the invention is preferably represented by the formula (3-1) or (3-3), more preferably the formula (3-1).

The polymer or oligomer which is a base generator may contain a base generator in its main chain or in its side chains, preferably in its side chains. The polymer or oligomer containing a base generator in its side chains may be a copolymer of two or more monomers containing a base generator in its side chains or a copolymer of a monomer containing a base generator in its side chains with a monomer free of a base generator in its side chains.

Specific preferred examples of base generator which is another a polymer nor an oligomer will be given below, but the invention is not limited thereto.

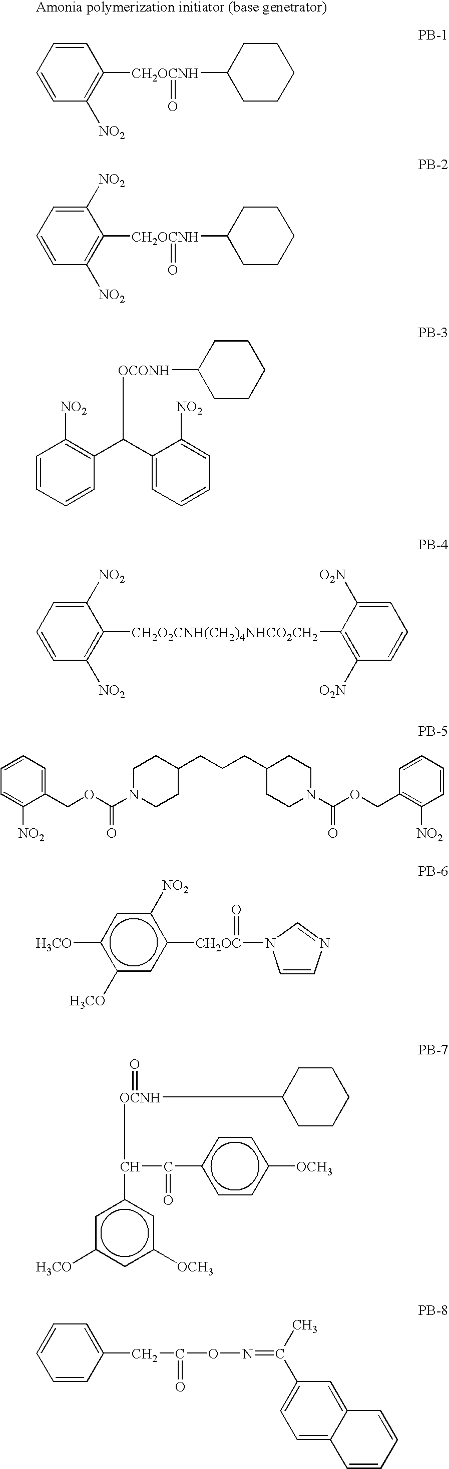

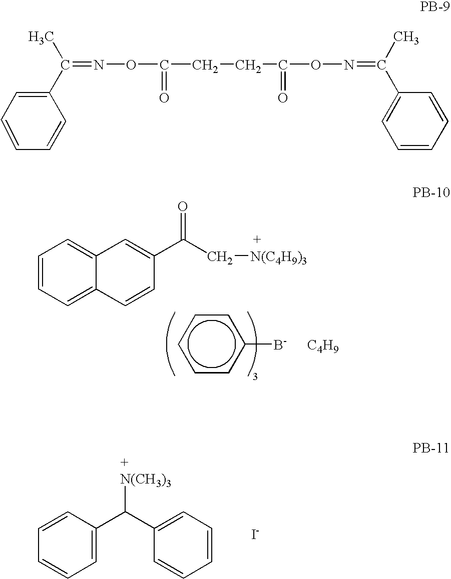

Preferred examples of the base generator include this disclosed in Japanese Patent Application No. 2003-178083.

When the base generator in the hologram recording material of the invention is a polymer or oligomer, it is preferably a polymer or oligomer containing the base generator exemplified above in its main chain or in its side chains.

Particularly preferred examples of the base generator polymer or oligomer will be given below, but the invention is not limited thereto.

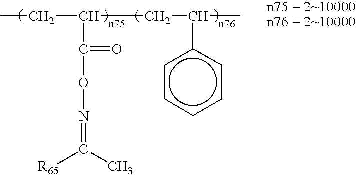

| | R₆₅ |
|---|---|
| PPB-1 | 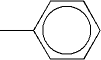 |
| PPB-2 | 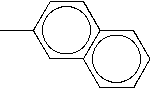 |

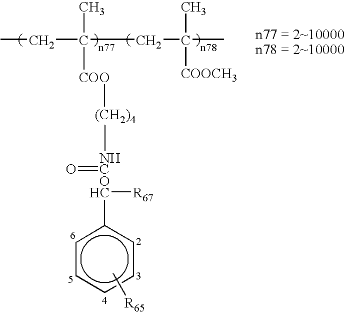

| | R₆₆ | R₆₇ |
|---|---|---|
| PPB-3 | 2-NO₂ | H |
| PPB-4 | 2-NO₂, 5-NO₂ | H |
| PPB-5 | 2-NO₂ | 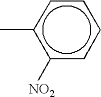 |
| PPB-6 | 3-OCH₃, 4-OCH₃ | H |
| PPB-7 | 3-OCH₃, 5-OCH₃ | 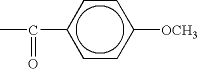 |
| PPB-8 | 2-NO₂, 4-OCH₃, 5-OCH₃ | H |

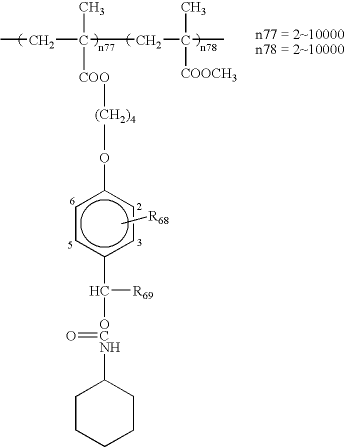

| | R₆₈ | R₆₉ |
|---|---|---|
| PPB-9 | 2-OCH₃ | H |
| PPB-10 | 2-OCH₃ | 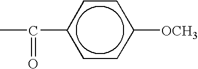 |
| PPB-11 | 3-NO₂ | H |
| PPB-12 | 3-NO₂, 5-NO₂ | H |
| PPB-13 | 3-No₂ | 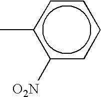 |
| PPB-14 | 3-NO₂, 6-OCH₃ | H |

A base proliferator is preferably used to enhance sensitivity. Specific preferred examples of base proliferator include those disclosed in Japanese Patent Application No. 2003-178083.

The base-colorable dye precursor will be further described hereinafter.

The polymer or oligomer which is a base-colorable dye precursor may contain a base-colorable dye precursor in its main chain or in its side chains, preferably in its side chains. The polymer or oligomer containing a base-colorable dye precursor in its side chains may be a polymer of two or more monomers containing a base-colorable dye precursor in its side chains or a copolymer of a monomer containing a base-colorable dye precursor in its side chains with a monomer free of a base-colorable dye precursor in its side chains.

Examples of the base-colorable dye precursor include dissociative azo dyes, dissociative azomethine dyes, dissociative benzylidene dyes, dissociative oxonol dyes, dissociative xanthene dyes, dissociative fluorane dyes and dissociative triphenylmethane dyes in undissociated form. Preferred among these base-colorable dye precursors are dissociative azo dyes, dissociative oxonol dyes and dissociative benzylidene dyes in undissociated form.

Specific preferred examples of the base-colorable dye which is neither a polymer nor an oligomer will be given below, but the invention is not limited thereto.

| | | n61 |
|---|---|---|
| 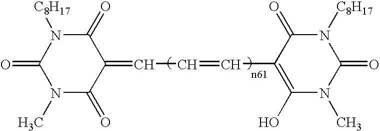 | DD-1 DD-2 DD-3 | 1 2 3 |
| | | n61 |
| 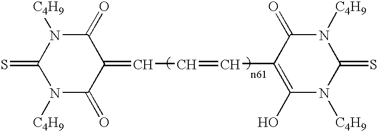 | DD-4 DD-5 DD-6 | 0 1 2 |
| | | n61 |
| 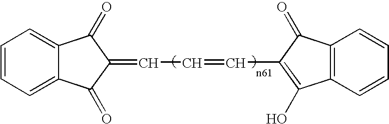 | DD-7 DD-8 DD-9 | 0 1 2 |
| | | n61 |
| 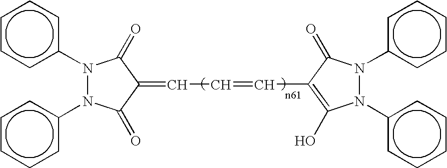 | DD-10 DD-11 DD-12 | 0 2 3 |
| | | n62 |
| 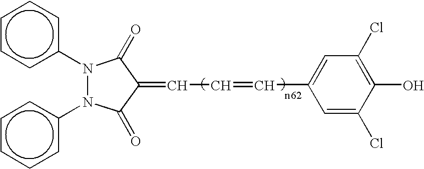 | DD-13 DD-14 | 0 1 |
| | | n62 |
| 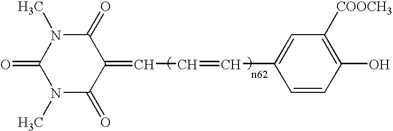 | DD-15 DD-16 | 0 1 |

| | |
|---|---|
| 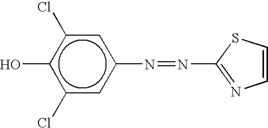 | DD-17 |

| | |
|---|---|
| DD-18 | DD-19 |
| 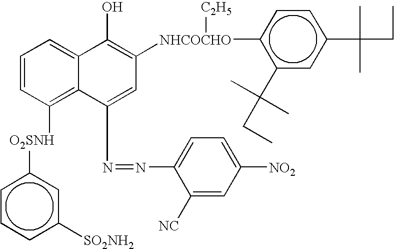 | 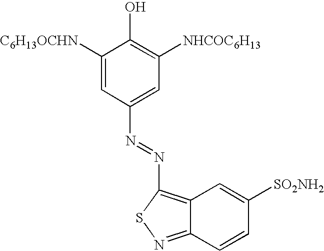 |

| | |
|---|---|
| DD-20 | DD-21 |
| 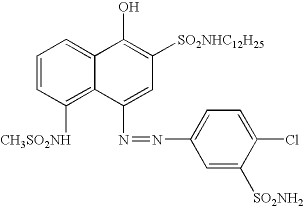 | 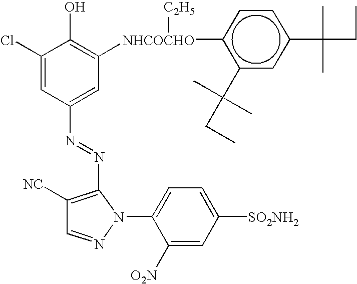 |

DD-22

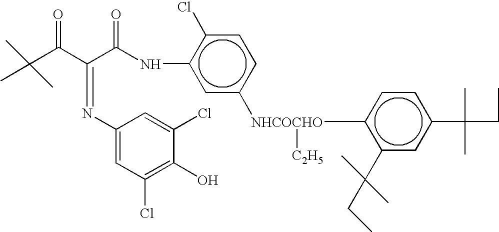

| | |
|---|---|
| DD-23 | DD-24 |
| 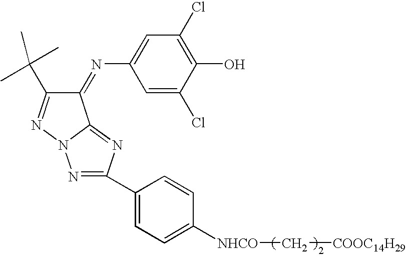 | 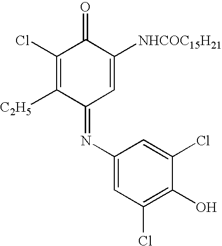 |

| | |
|---|---|
| DD-25 | DD-26 |
| 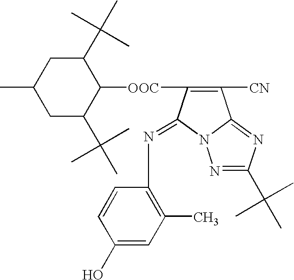 | 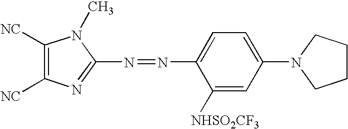 DD-27 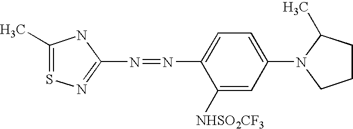 |

| | |
|---|---|
| DD-28 | DD-29 |
| 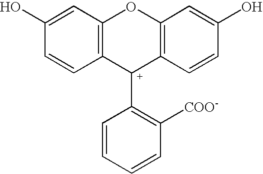 | 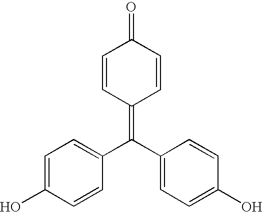 |

| | | R₅₁ | R₅₂ |
|---|---|---|---|
| 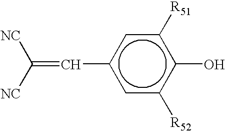 | DD-30 DD-31 DD-32 | —H —Cl —Cl | —H —H —Cl |
| | | R₅₁ | R₅₂ |
| 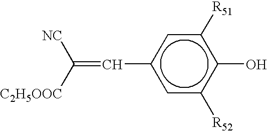 | DD-33 DD-34 DD-35 DD-36 DD-37 DD-38 | —H —Cl —Cl —H —CH₃—C₃H₇-i | —H —H —Cl —OCH₃—CH₃—C₃H₇-i |
| 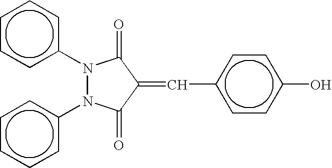 | DD-39 | | |

In the case where the base-colorable dye precursor in the hologram recording material of the invention is a polymer or oligomer, it is preferably a polymer or oligomer containing the base-colorable dye precursor exemplified above in its main chain or in its side chains.

Particularly preferred examples of base-colorable dye precursor polymer or oligomer will be given below, but the invention is not limited thereto.

| | | n81 |
|---|---|---|
| 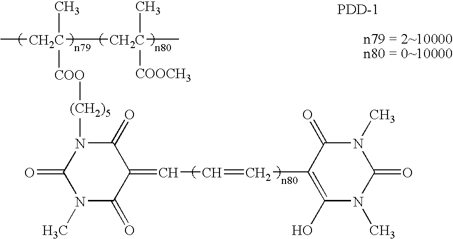 | PDD-1 PDD-2 | 0 1 |

| | | R₇₀ | R₇₁ |
|---|---|---|---|
| 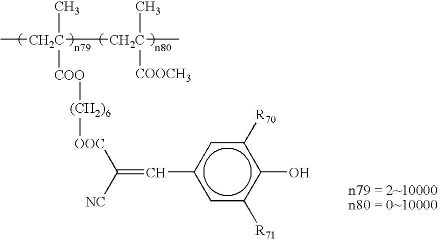 | PDD-3 PDD-4 PDD-5 | —H Cl —Cl | —H —H —Cl |

| | R₆₂ |
|---|---|
| 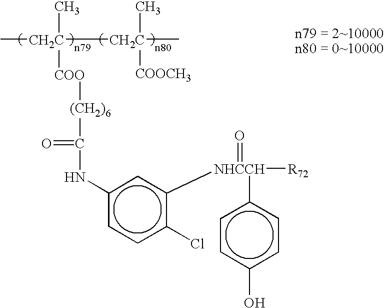 | 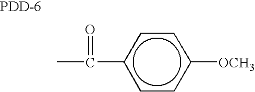 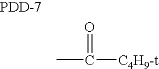 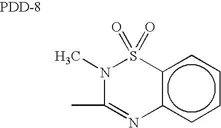 |

| | | R₇₃ | R₇₄ |
|---|---|---|---|
| 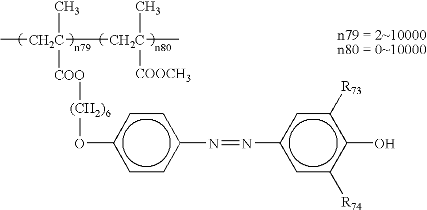 | PDD-9 PDD-10 PDD-11 PDD-12 | H —Cl —Cl —H | H H —Cl —CN |

More preferably, the hologram recording material of the invention comprises a polymer or oligomer which is a copolymer of a monomer containing a base generator in is side chains with a monomer containing a base-colorable dye precursor in its side chain as mentioned below.

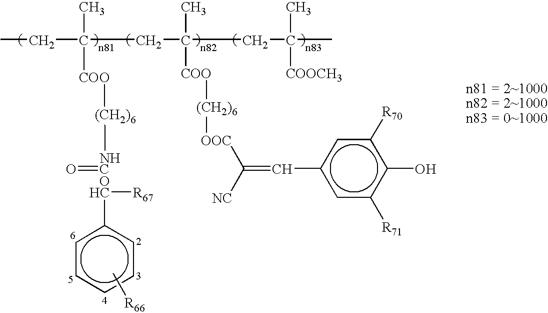

| | R₇₀ | R₇₁ | R₆₆ | R₆₇ |
|---|---|---|---|---|
| PBD-1 | —Cl | —Cl | 2-NO₂ | H |
| PBD-2 | ″ | ″ | 2-NO₂, 6-NO₂ | H |
| PBD-3 | ″ | ″ | 2-NO₂ | 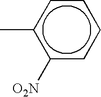 |
| PBD-4 | ″ | ″ | 3-OCH₃, 4-OCH₃ | H |
| PBD-5 | ″ | ″ | 2-NO₂, 4-OCH₃, 5-OCH₃ | H |
| PBD-5 | ″ | H | 2-NO₂, 6-NO₂ | H |
| PBD-6 | H | ″ | ″ | H |

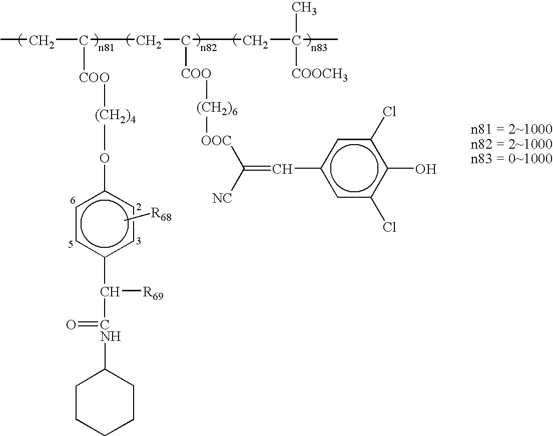

| | R₆₈ | R₆₉ |
|---|---|---|
| PBD-8 | 3-NO₂ | H |
| PBD-9 | 3-NO₂, 5-NO₂ | H |
| PBD-10 | 3-NO₂ | 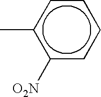 |
| PBD-11 | 3-NO₂, 6-OCH₃ | H |
| PBD-12 | 2-OCH₃ | H |

iii) A compound having an organic compound moiety capable of disconnecting covalent bond upon electron movement or energy movement from or to the excited state of the sensitizing dye and an organic compound moiety capable of forming a coloring material during covalent bonding and when released, which moieties being covalently bound, optionally combined with a base.

Specific preferred examples of this combination will be given below, but the invention is not limited thereto.

| | | PD | | PD | | PD |
|---|---|---|---|---|---|---|
| 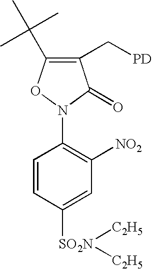 | E-1 E-2 E-3 E-4 E-5 | PD-1 PD-2 PD-22 PD-27 PD-8 | E-6 E-7 E-8 E-9 E-10 | PD-10 PD-12 PD-13 PD-16 PD-18 | E-11 E-12 E-13 E-14 E-15 | PD-18 PD-20 PD-24 PD-25 PD-29 |
| | | PD | | PD | | PD |
| 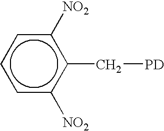 | E-16 E-17 E-18 E-19 E-20 | PD-22 PD-2 PD-27 PD-7 PD-8 | E-21 E-22 E-23 E-24 E-25 | PD-11 PD-14 PD-15 PD-17 PD-18 | E-26 E-27 E-28 E-29 E-30 | PD-20 PD-23 PD-25 PD-26 PD-29 |

| | |
|---|---|
| | PD-1 |
| 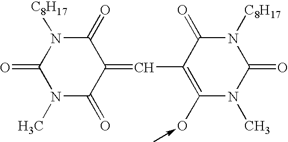 | |

| | | n57 |
|---|---|---|
| 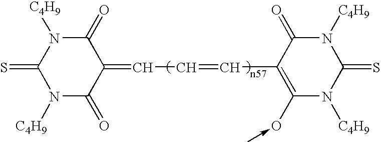 | PD-2 PD-3 PD-4 | 0 1 2 |
| | | n57 |
| 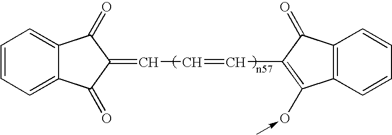 | PD-5 PD-5 | 0 2 |

| | |
|---|---|
| | PD-7 |
| 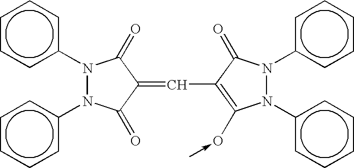 | |

| 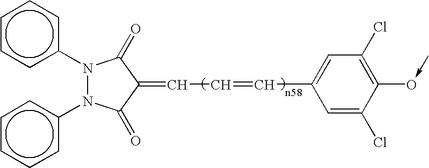 | | 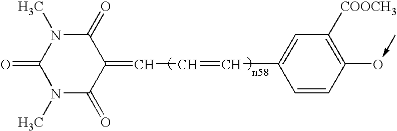 | |
|---|---|---|---|
| | n58 | | n58 |
| PD-8 | 0 | PD-10 | 0 |
| PD-9 | 1 | PD-11 | 1 |

| | |
|---|---|
| PD-12 | PD-13 |
| 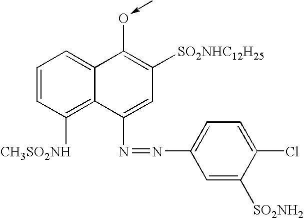 | 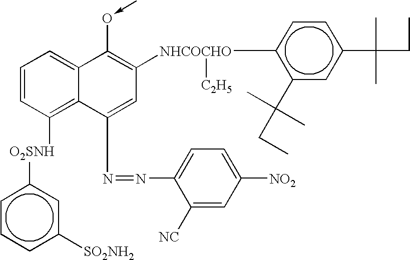 |

| | |
|---|---|
| PD-14 | PD-15 |
| 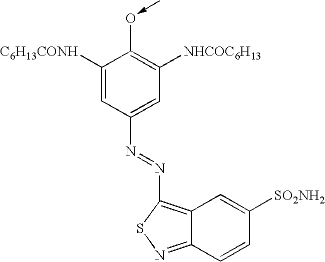 | 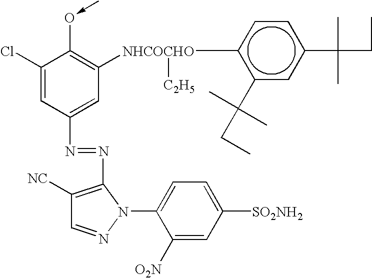 |

| | |
|---|---|
| PD-16 | PD-17 |
| 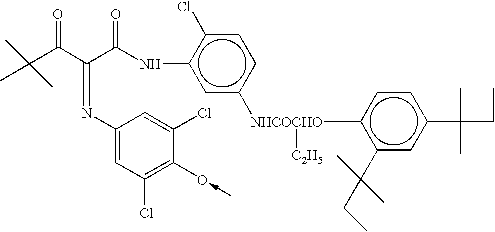 | 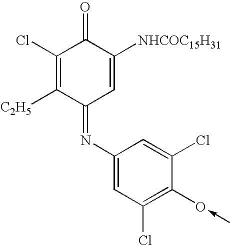 |

| | |
|---|---|
| PD-18 | PD-19 |
| 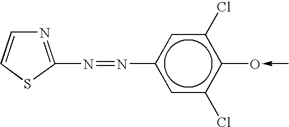 | 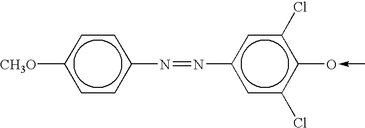 |

| | | R₅₁ | R₅₂ |
|---|---|---|---|
| 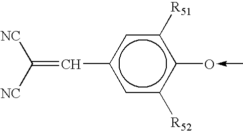 | PD-20 PD-21 PD-22 PD-23 PD-24 | —H —Cl —Cl —Cl —Cl | —H —H —Cl —COOC₂H₅—CN |
| | | R₅₁ | R₅₂ |
| 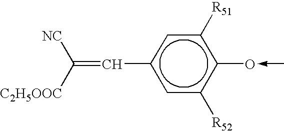 | PD-25 PD-26 PD-27 PD-28 PD-29 PD-30 | —H —Cl —Cl —OCH₃—CH₃—C₃H₇-i | |

The aforementioned compounds each are a colorable dye precursor polymer or oligomer represented by the following formula (1)
(A1−PD)m1 (1)

In the formula (1), A1 and PD are covalently bonded to each other. A1 represents a site capable of disconnecting the covalent and to PD upon the movement of electron or energy from and to the excited state of the sensitizing dye. PD represents a site capable of causing color development reaction when released upon the disconnection of the covalent bond to A1.

The molecules of the formula (1) are connected to each other with covalent bond of any of A1 and PD to form a polymer or oligomer. The suffix m1 represents an integer of from not smaller than 3 to not greater than 1000,000.

In the formula (1), it is desirable that PD be a group formed by any of dissociative azo dye, dissociative azomethine dye, dissociative benzylidene dye, dissociative oxonol dye, triphenylmethane dye and xanthene dye and be covalently bonded to A1 on chromophore. PD is more preferably a dissociative azo dye or dissociative benzylidene dye.

Preferred examples of the colorable dye precursor polymer or oligomer of the invention represented by the formula (1) will be given below, but the invention is not limited thereto.

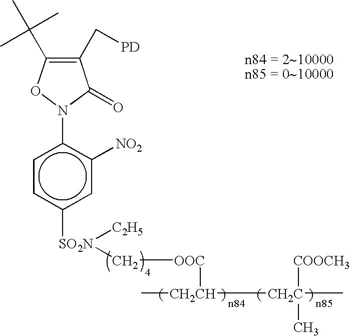

| | PD |
|---|---|
| PE-1 | PD-1 |
| PE-2 | PD-18 |
| PE-3 | PD-16 |
| PE-4 | PD-22 |
| PE-5 | PD-20 |
| PE-6 | PD-25 |
| PE-7 | PD-27 |
| PE-8 | PD-30 |

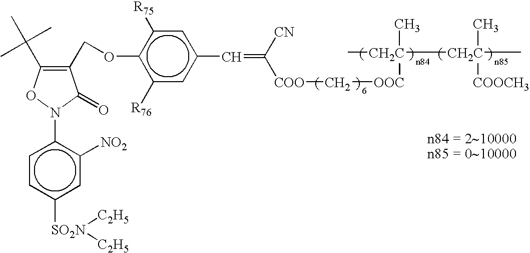

| | R₇₅ | R₇₆ |
|---|---|---|
| PE-9 | —H | —H |
| PE-10 | —H | —Cl |
| PE-11 | —Cl | —Cl |
| PE-12 | —i-C₃H₇ | —i-C₃H₇ |
| PE-13 | —H | —COOCH₃ |

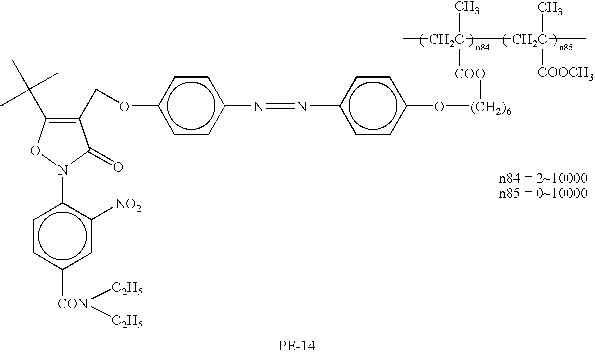

iv) Compound capable of reacting upon electron movement from or to the excited state of the sensitizing dye to change absorption form. A so-called electrochromic compound is preferably used. The electrochromic compound is preferably a polymer or oligomer.

In the interference fringe-recording process involving 1) color development process of the invention, it is more desirable that a binder polymer be incorporated in addition to the sensitizing dye and the interference fringes-recording component. Preferred examples of the binder polymer include those exemplified later with reference to 3) latent image color development-coloring material sensitized polymerization reaction and those disclosed in Japanese Patient Application No. 2004-238077.

Interference fringes recording involving latent image color development-coloring material self-sensitized amplification color development reaction

This hologram recording method comprises at least a first step of forming a coloring material having no absorption at hologram reproducing light wavelength as a latent image by hologram exposure and a second step of irradiating the coloring material latent image with light having a wavelength different from hologram exposure wavelength, at which the sensitizing dye exhibits a molar absorption coefficient of 5,000 or less to cause the self-sensitized amplification of the coloring material, whereby an interference fringes is recorded as refractive index modulation, which steps being effected in a dry process. This hologram recording method is advantageous in high speed writing properties, high S/N ratio reproducibility, etc.

The term “latent image” as used herein is meant to indicate that the refractive index difference formed after the second step is preferably one second or less (that is, magnification or 2 or more is preferably effected at the second step), more preferably one fifth, even more preferably one tenth, most preferably one thirtieth (that is, magnification of 5 or more, more preferably 10 or more, most preferably 30 or more is effected at the second step).

The second step preferably involves the irradiation with light or both of the irradiation with light and the application of heat, more preferably the irradiation with light. The irradiation with light preferably involves entire exposure (so-called solid exposure, blanket exposure or non-imagewise exposure).

Preferred examples of the light source to be used herein include visible light laser, ultraviolet laser, infrared laser, carbon arc, high voltage mercury vapor lamp, xenon lamp, metal halide lamp, fluorescent lamp, tungsten lamp, LED, and organic EL. In order to irradiate the hologram recording material with light having a specific wavelength, a sharp cut filter, band pass filter, diffraction grating or the like is preferably used as necessary.

Further, the hologram recording material allowing the aforementioned hologram recording method preferably comprises at least:
1) A sensitizing dye absorbing light upon hologram exposure to generate excited state; and
2) An interference fringe-recording component containing a dye precursor which can form a coloring material that has absorption at longer wavelength than in the original state and no absorption at hologram reproducing light wavelength, which interference fringe-recording component can undergo electron or energy transfer from the excited state of the sensitizing dye or coloring material to cause color development leading to refractive index modulation by which an interference fringes is recorded.

At least one of the sensitizing dye and the interference fringes-recording component is preferably a polymer or oligomer. More preferably, at least one of the interference fringes-recording components is a polymer or oligomer.

Preferred examples of the interference fringe-recording component include those exemplified with reference to 2) color development reaction.

The light emitted at the second step preferably has a wavelength range at which the sensitizing dye exhibits a molar absorption coefficient of 1,000 or less, more preferably 500 or less.

Further, the light emitted at the second step preferably has a wavelength range at which the coloring material exhibits a molar absorption coefficient of 1,000 or more.

The concept of “latent image color development-coloring material self-sensitized amplification color development reaction process” will be described hereinafter.

For example, the hologram recording material is irradiated with YAG-SHG laser beam having a wavelength of 532 nm so that the laser beam is absorbed by the sensitizing dye to generate excited state. Energy or electron is then moved from the the excited state of the sensitizing dye to the interference fringe-recording component to cause the dye precursor contained in the interference fringe-recording component to change to a coloring material whereby a latent image is formed by color development (first step). Subsequently, the hologram recording material is irradiated with light having a wavelength of from 350 nm to 420 nm so that the light is absorbed by the coloring material which is then self-sensitized to cause the amplification thereof (second step). At the area which has become a dark interference area at the first step, there is produced little latent image. Therefore, little self-sensitized color development reaction occurs at the second step as well. As a result, a great refractive index modulation can be performed between the bright interference area and the dark interference area. The reactive index modulation can be recorded as interference fringes. For example, when the hologram recording material having data, image, etc. recorded thereon is again irradiated with a laser beam having a wavelength of 532 nm, the data, image, etc. can be reproduced.

Specific preferred examples of the latent image color development-coloring material self-sensitized amplification color development reaction include those exemplified in Japanese Patent Application No. 2004-238427.
3) Interference fringes recording involving latent image color development-coloring material sensitized polymerization reaction

This hologram recording method preferably comprises at least a first step of forming a coloring material having no absorption at hologram reproducing light wavelength as a latent image by hologram exposure and a second step of irradiating the coloring material latent image with light having a wavelength different from hologram exposure wavelength to cause polymerization, whereby an interference fringes is recorded as refractive index modulation, which steps being effected in a dry process. This hologram recording method is excellent in high speed writing properties, storage properties, etc.

It is also preferred that the polymerization be effected while causing self-sensitized amplification of coloring material at the second step.

At the second step, it is preferred that the sensitizing dye of the invention, too, be discolored and fixed at the same time with the other compounds. As a result, even upon irradiation with hologram reproducing light, recorded data cannot be destroyed nor absorbed, making it possible to obtain a high absolute diffraction efficiency.

Further, the hologram recording material allowing the aforementioned hologram recording method comprises at least:
1) A sensitizing dye absorbing light upon hologram exposure to generate excited state at the first step;
2) An interference fringe-recording component containing a dye precursor which can form a coloring material that has absorption at longer wavelength than in the original state, at which wavelength the sensitizing dye exhibits a molar absorption coefficient of 5,000 or less, and that no absorption at hologram reproducing light wavelength when electron or energy moves from the excited state of the sensitizing dye at the first step or from excited state of coloring material at the second step;
3) A polymerization initiator which can initiate the polymerization of a polymerizable compound when electron or energy moves from the excited state of the sensitizing dye at the first step and from excited state of coloring material at the second step;
4) A polymerizable compound; and
5) A binder.

At least one of the sensitizing dye and the dye precursor group is preferably a polymer or oligomer. More preferably, at least one of the dye precursor is a polymer or oligomer.

Preferred examples of the sensitizing dye and the interference fringe-recording component include those exemplified with reference to 2) color development reaction.

The light emitted at the second step preferably has a wavelength range at which the sensitizing dye exhibits a molar absorption coefficient of 1,000 or less, more preferably 500 or less.

Further, the light emitted at the second step preferably has a wavelength range at which the coloring material exhibits a molar absorption coefficient of 1,000 or more.

Preferred examples of the polymerization initiator, polymerizable compound and binder will be described hereafter.

The binder preferably has a refractive index different from that of the polymerizable compound. In order to enhance the refractive index modulation, it is preferred that the refractive index difference between the polymerizable compound and the binder in bulky form be great, more preferably 0.01 or more, even more preferably 0.05 or more, particularly 0.1 or more.

To this end, it is preferred that one of the polymerizable compound or the binder contain at least one aryl group, aromatic heterocyclic group, chlorine atom, bromine atom, iodine atom and sulfur atom and the other be free of these groups or atoms. Either the polymerizable compound or the binder may have a greater refractive index than the other.

The term “polymerizable compound” as used herein is meant to indicate a compound which can undergo addition polymerization with a radical, acid (Bromsted acid or Lewis acid) or base (Bronsted base or Lewis base) generated when the sensitizing dye (or coloring material) or polymerization initiator with light to form an oligomer or polymer.

The polymerizable compound of the invention may be monofunctional or polyfunctional, may be of one-component system or multi-component system or may be a monomer, prepolymer (e.g., dimer, oligomer) or mixture thereof, preferably monomer.

The polymerizable compound may stay liquid or solid at room temperature but is preferably a liquid having a boiling point of 100° C. or more or a mixture of a liquid monomer having a boiling point of 100° C. or more and a solid monomer.

The polymerizable compound of the invention can be roughly divided into radical-polymerizable compound and cationically- or anioniocally-polymerizable compound.

Preferred examples of the radical-polymerizable compound and the cationically- or anioniocally-polymerizable compound will be described hereinafter in connection with the two groups: A) case where the refractive index of polymerizable compound is greater than that of binder and B) case where the refractive index of binder is greater than that of polymerizable compound.

A) Preferred Examples of Radical-Polymerizable Compound Having a Greater Refractive Index Than Binder

In this case, the radical-polymerizable compound preferably has a high refractive index. The high refractive index radical-polymerizable compound of the invention is preferably a compound having at least one ethylenically-unsaturated double bond per molecule and at least one aryl group, aromatic heterocyclic group, chlorine atom, brominc atom, iodine atom or sulfur atom per molecule, more preferably a liquid having a boiling point of 100° C. or more.

Specific examples of the radical-polymerizable compound include the following monomers and prepolymers (dimer, oligomer) comprising these polymerize monomers.

Preferred examples of the high refractive index radical-polymerizable monomer include styrene, 2-chlorostyrene, 2-bromostyrene, methoxystyrene, phenyl acrylate, p-chlorophenyl acrylate, 2-phenylethyl acrylate, 2-phenoxyethyl acrylate, 2-phenoxyethyl methacrylate, 2-(p-chlorophenoxy)ethyl acrylate, benzyl acrylate, 2-(1-naphthyloxy)ethyl acrylate, 2,2-di(p-hydroxyphenyl)propane diacrylate, 2,2di(p-hydroxyphenyl)propane dimethacrylate, di(2-methacryloxyethyl)ether of bisphenol A, di(2-acryloxy ethyl)ether of bisphenol A, di(2-methacryloxy)ether of tetracloro-bisphenol A, di(2-methacryloxy)ether of tetrabromo-bisphenol A, 1,4-benzenediol dimethacrylate, and 1,4-diisopropenylbenzene. Even more desirable among these compounds are 2-phenoxyethyl acrylate, 2-phenoxyethyl methacrylate, 2(p-chlorophenoxy)ethyl acrylate, p-chlorophenyl acrylate, phenyl acrylate, 2-phenylethyl acrylate, di(2-acryloxyethyl)ether of bisphenol A, and 2-(1-naphthyloxy)ethyl acrylate.

The preferred polymerizable compound is a liquid but may be used in admixture with a second solid polymerizable compound such as N-vinylcarbazole, 2-naphthyl acrylate, pentachlorophenyl acrylate, 2,4,6-tribromophenyl acrylate, disphanol A diacrylate 2-(2-naphthyloxy)ethyl and N-phenylmaleimide

B) Prefer Examples of Radical-Polymerizable Compound Having a Smaller Refractive Index Than Binder

In this case, the radical-polymerizable compound preferably has a low refractive index. The low refractive index radical-polymerizable compound of the invention preferably has at least one ethylenically-unsaturated double bond per molecule but is free of aryl group, aromatic heterocyclic group chlorine atom, bromine atom, iodine atom and sulfur atom.

The radical-polymerizable compound of the invention is preferably a liquid having a boiling point of 100° C. or more.

Specific examples of the radical-polymerizable compound of the invention include the following polymerizable monomers and prepolymers (dimer, oligomer, etc.) comprising these polymerizable monomers.

Preferred examples of the low refractive index radical-polymerizable compound employable herein include t-butyl acrylate, cyclohexyl acrylate, isobomyl acrylate, 1,5-pentanediol diacrylatc, ethylene glycol diacrylate, 1,4-butanediol diacrylate, diethylene glycol diacrylate, hexamethylene glycol diacrylate, 1,3-propanediol diacrylatc, docamethylene glycol diacrylate, 1,4-cyclohexyldiol dicrylate, 2,2-ethylolpropane dimethylolpromane, diacrylate, glycerol diacrylate, trimethylolpropane diacrylate, pentaerythritol triacrylate, pentacrythritol tetraacrylate, triethylene glycol diacrylate, triethylene glycol dimethacrylate, ethylene glycol dimethacrylate, 1,3-propanediol dimethacrylate, 1,2,4-butanetriol trimethacrylate, 2,2,4-trimethyl-1,3-propanediol dimethacrylate, pentaerythritol trimethacrylate, pentaerythritol tetramethacrylate, trimethylolpropane trimethacrylate, 1,5-pentanediol dimethacrylate, diallyl fumarate, 1H,1H-perfluorooctyl acrylate, 1H,1H, 2H,2H-perfluorooctyl methacrylate, 1H,1H, 2H,2H-perfluorooctyl acrylate, and 1-vinyl-2-pyrrolidone. More desirable among these low refractive index radical-polymerizable compounds are decanediol diacrylate, isobornyl acrylate, triethylene glycol diacrylate, diethylene glycol discrylate, trichylene glycol diemethacrylate, ethoxyethoxy acrylate, triacrylate ester of ethoxylated trimethylopropane, and 1-vinyl-2-pyrrolidine. Even more desriable among these low refractive index radical-polymerizable compounds are decanediol diacrylate, isobornyl acrylate, triethylene glycol diacrylate, diethylene glycol diacrylate, triethylene glycol diemethacrylate, ethoxyethoxy acrylate, 1H,1H-perfluorooctyl acrylate, 1H,1H,2H,2H-perfluorooctyl methacrylate, 1H,1H, 2H,2H-perfluorooctyl acrylate, and 1-vinyl-2-pyrrolidone.

The preferred polymerizable compound is a liquid but may be used in admixture with a second solid polymerizable compound monomer such as N-vinylcaprolatam.

The term “cationically-polymerizable compound” as used herein is meant to indicate a compound which begins polymerization with an acid generated when the sensitizing dye and the cation polymerization initiator are irradiated with light. The term “anionically-polymerizable compound” as used herein is meant to indicate a compound which begins polymerization with a base generated when the sensitizing dye and the anion polymerization initiator are irradiated with light.

The cationically-polymerizable compound of the invention is preferably a compound having at least one oxirane ring, oxethanone ring, vinylether group or N-vinylcarbazole moiety, more preferably N-vinylcarbazole moiety per molecule.

The anionically-polymerizable compound of the invention is preferably a compound having at least one oxirane ring, oxethanone ring, vinylether group, N-vinyl carbazole moiety, ethylenic double bond moiety provided with an electrophilic substituent, lactone moiety, lactam moiety, cyclic urethane moiety, cyclic urea moiety or cyclic siloxane moiety per molecule, more preferably oxirane ring moiety.

A) Preferred Examples of Cationically- or Anionically-Polymerizable Compound Having a Greater Refractive Index Than Binder

In this case, the cationically- or anionically-polymerizable compound preferably has a high refractive index. The high refractive index cationically- or anionically-polymerizable compound of the invention is preferably a compound having at least one oxirane ring, oxethanone ring, vinylether group or N-vinylcarbazole moiety per molecule and at least aryl group, aromatic heterocyclic group, chlorine atom, bromine atom, iodine atom or sulfur atom per molecule, more preferably at least one aryl group. The cationically- or anionically-polymerizable compound of the invention is preferably a liquid having a boiling point of 100° C. or more.

Specific examples of the cationically- or anionically-polymerizable compound of the invention include the following polymerizable monomers and prepolymers (dimer, oligomer, etc.) comprising these polymerizable monomers.

Preferred examples of the high refractive index cationically- or anionically-polymerizable monomers having oxirane ring include phenylglycidyl ether, phthalic acid diglycidyl ester, trimellitic acid triglycidyl ester, resorcine diglycidyl ether, dibromophenyl glycidyl ether, dibromoneopentyl glycol diglycidyl ether, 4,4′-bis(2,3-epoxypropoxyperfluro isopropyl)diphenyl ether p-bromstyrene oxide, bisphenol-A-diglycidyl ether, tetrabromobisphenol-A-diglycidyl ether, bisphenol-F-diglycidyl ether, and 1,3-bis(3′,4′-epoxycyclohexyl)ethyl)-1,3,-diphenyl-1,3,-dimethyldisiloxane.

Specific examples of the high refractive index cation or anionially-polymerizable monomer having oxethanone ring include compounds obtained by replacing the oxirane ring in the specific examples of the high refractive index cation or anionically-polymerizable monomer having oxirane ring by oxethanone ring.

Specific examples of the high refractive index cationically- or anionically-polymerizable monomer having vinylether group moiety include vinyl-2-chloroethyl ether, 4-vinyletherstyrene, hydroquinone divinyl ether, phenylvinyl ether, bisphenol A divinyl ether, tetrabromobisphenol A divinyl ether, bisphenol F divinyl ether, phenoxyethylenevinyl ether, and p-bromophenoxyethylenevinyl ether.

Further preferred examples of the high refractive index cationically-polymerizable monomer include styrene-based monomers such as styrene, 2-chlorostyrene, 2-bromostyrene and methoxystyrene and N-vinylcarbazole. B) Preferred Examples of Cationically- or Anionically-Polymerizable Compound Having a Smaller Refractive Index Than Binder

In this case, the cationically- or anionically- polymerizable compound preferably has a low refractive index. The low refractive index cationically- or anionically-polymerizable compound of the invention is preferably a compound having at least one oxirane ring, oxethanone ring, vinylether group or N-vinylcarbazole moiety per molecule but free of aryl group, aromatic heterocyclic group, chlorine atom, bromine atom, iodine atom and sulfur atom. The cationically- or anionically-polymerizable compound of the invention is preferably a liquid having a boiling point of 100° C. or more.

Specific examples of the cationically- or anionically-polymerizable compound of the invention include the following polymerizable monomers and prepolymers (dimer, oligomer, etc.) comprising these polymerizable monomers.

Specific examples of the low refractive index cationically- or anionically-polymerizable monomer having oxirane ring include glyceroldiglycidyl ether, glyceroltriglycidyl ether, pentaerythritol polyglycidyl ether, trimethylolpropanetiglycidyl ether, 1,6-hexanediolglycidyl ether, etylene glycol diglycidyl ether, ethylene glycol monoglycidyl ether, propylene glycol diglycidyl ether, neopentyl glycol diglycidyl ether, adipic acid diglycidyl ester, 1,2,7,8-diepoxyoctane, 1,6-dimenthylolperflourohexane diglycidyl ether, vinyl cyclohexone dioxide, 3,4-epoxycyclohexylmethyl-3′,4′-cpoxycylohexane carboxylate, 3,4-epoxycyclohexyloxirane, bis(3,4-epoxycyclohcxyl)adipate 2,2-bis(4-(2,3-epoxypropoxy) cyclohexyl)propane, 2,2-bis(4-(2,3-epoxypropoxy)cyclohexyl)hexafluoropropane, 2-(3,4-epoxycyclohexyl)-3′,4′-epoxy-1,3dioxane-5spirocyclohexane, 1,2-ethylenedioxy-bis(3,4-epoxycyclohexylmethane), ethyleneglycol-bis(3,4epoxycyclohexanecarboxylate), bis-(3,4epoxycyclohexylmethyl)adipate, di-2,3-epoxycyclopentyl ether, vinyl glycidyl ether, allyl glycidyl ether, 2-ethylhexyl glycidyl ether, and 1,3-bis(3′,4′-epoxycyclohexyl)ethyl)-1,1,3,3-tetramethyldisiloxane.

Specific examples of the low refractive index cationically- or anionically-polymerizable monomer having oxathanone ring include compounds obtained by replacing the oxirane ring in the aforementioned specific examples of low refractive index cationically- or anionically-polymerizable monomer having oxirane ring by oxethanone ring.

Specific examples of the low refractive index cationically- or anionically-polymerizable monomer having vinylether group moiety include vinyl-n-butylether, vinyl-t-butylether, ethylene glycol divinyl ether, ethylene glycol monovinyl ether, propylene glycol divinyl ether, neopentyl glycol divinyl glycol, glycerol divinyl ether, glycerol trivinyl ether, trichylene glycol divinyl ether, trimethylol propane monovinyl ether, trimethylol propane divinyl ether, trimethylol propane trivinyl ether, allyl vinyl ether, 2,2-bis(4-cyclohexanol)propanol divinyl ether, and 2,2-bis(4-cyclohexanol)trifluoropropane divinyl ether.

Specific preferred examples of the binder to be used in recording of interference fringes by polmerization reaction will be described hereinafter in connection with the two groups: A) case where the refractive index of polymerizable compound is greater than that of binder and B) case where the refractive index of binder is greater than that of polymerizable compound.

A) Preferred Example of Binder Having a Smaller Refractive Index than Polymerizable Compound

In this case, the binder preferably has a low refractive index. The binder of the invention is preferably a binder free of aryl group, aromatic heterocyclic group, chlorine atom, bromine atom, iodine atom and sulfur atom.

Specific preferred examples of the low refractive index binder include acrylates α-alkyl acrylates, acidic polymers, interpolymers (e.g., polymethacrylic acid methyl, polymetharcylic acid ethyl, copolymer of methyl methacylate with other (meth)acrylic acid akylesters), polyvinylesters (e.g., polyvinyl acetate, polyacetic acid/acrylic acid vinyl, polyacetic acid/methacrylic acid vinyl, hydrolyzable polyvinyl acetate), ethylene/vinyl acetate copolymers, saturated and unsaturated polyurethanes, butadiene polymers and copolymers, isoprene polymers and copolymers, high molecular polyethylene oxides of polyglycol having an average molecular weight of from about 4,000 to 1,000,000, epoxy compounds (e.g., epoxylated compounds having acrylate or methacrylate), polyamides (e.g., N-methoxy methylpolyhexamethylene adipamide), cellulose esters (e.g., cellulose acetate, cellulose acetate succinate, cellulose acetate butyrate), cellulose ether (e.g., methyl cellulose, ethyl cellulose, ethylbenzeyl cellulose), polycarbonates, polyvinyl acetals (e.g., polyvinyl butyral, polyvinyl formal), polyvinyl alcohols, and polyvinyl pyrrolidones.

Further preferred examples of the low refractive index binder include fluorine atom-containing polymers. A preferred example of the fluorine atom-containing polymers is an organic solvent-soluble polymer comprising a fluoroolefin as an essential component and one or more unsaturated monomers selected from the group consisting of alkylvinyl ether, alicyclic vinyl ether, hydroxyvinyl ether, olefin, haloolefin, unsaturated carboxylic acid, ester thereof and carboxylic acid vinyl ester as copolymerizable components. The fluorine atom-containing polymer preferably has a weight-average molecular weight of from 5,000 to 200,000 and a fluorine atom content of from 5 to 70% by weight.

Specific examples of the aforementioned fluorine atom-containing polymer include Lumiflon Series (e.g., Lumiflon LF200; weight-average molecular weight: approx. 50,000, produced by Asahi Glass Co., Ltd,), which are organic solvent-soluble fluorine atom-containing polymers having hydroxyl group. Besides these products, organic solvent-soluble fluorine atom-containing polymers have been marketed by DAIKIN INDUSTRIES, LTD., Central Glass Co., Ltd., Penwalt Corp., etc. These products, too, can be used.

Further preferred examples of the fluorine atom-containing polymer include silicon compounds such as pioly(dimethylsiloxane) and silicon oil free of aromatic group.

Besides the aforementioned compounds, epoxy oligomer compounds free of aromatic groups can be used as low refractive index reactive binders.

B) Preferred Examples of Binder Having a Greater Refractive Index than Polymerizable Compound

In this case, the binder preferably has a high refractive index. The binder of the invention is preferably a binder containing at least one aryl group, aromatic heterocyclic group, chlorine atom, bromine atom, iodine atom or sulfur atom, more preferably aryl group.

Specific preferred examples of the high binder index binder include polystyrene polymers, acrylonitrile, maleic anhydride, acrylic acid, methacrylic acid, methacrylic acid ester copolymer, vinylidene chloride copolymer (e.g., vinylidene cloride/acrylonitrile copolymer, vinylidene chloride/methacrylate copolymer, vinylidene/vinyl acetate copolymer), polyvinyl chloride copolymer (e.g., polyvinyl chloride/acetate vinyl chloride/acrylonitrile copolymer), polyvinyl benzal synthetic rubber (e.g., butadiene/acrylonitrile copolymer, acrylonitrile/butadiene/styrene copolymer, methacrylate/acrylonnitrile/styrene copolymor, 2-chlorobutadiene-1,3-polymer, chlorinated rubber styrene/butadiene/styrene, styrene/isoprene/styrene block copolymer), polymethylene glycol of copolyester (represented, e.g., by the formula HO(CH₂)ₙOH (in which n is an integer of from 2 to 10), those produced from the reaction product of (1) hexahydroterephthalic acid, sebacic acid and terephthalic acid, (2) terephthalic acid, isophthalic acid and sebacic acid, (3) terephthalic acid and sebacic acid, (4) tephthalic acid and isophthalic acid, (5) the glycol and mixture of copolyesters produced from (i) terephthalic acid, isophthalic acid and sebacic acid and (ii) terephthalic acid, isophthalic acid, sebacic acid and adipic acid, poly-N-vinylcarbazole, copolymer thereof, and polycarbonate made of carboxylic acid ester and bisphenol.

Further preferred examples of the high refractive index binder include silicon compounds such as poly (methylphenylsiloxane) and 1,3,5trimethyl-1,1,3,5,5-pentaphanyltrisiloxane and silicon oil containing much aromatic groups.

Besides these compounds, epoxy oligomer compounds containing much aromatic groups can be used as high refractive index reactive binder.

Preferred examples of the polymerization initiator to be used interference fringes recording involving polymerization reaction of the invention include ketone-based, organic peroxide-based, trihalomethyl-substituted triazine-based, diazonium salt-based, diaryl iodonium salt-based, sulfonium salt-based, borate-based, diaryl iodonium-organic boron complex-based, sulfonium-organic boron complex-based, ionic sensitizing dye-organic boron complex-based, anionic sensitizing dye-onium salt complex-based, metal-allene complex-based and sulfonic acid ester-based radical polymerization initiators (radical generators), cationic polymerization initiators (acid generators) and radical polymerization-cationic polymerization initiators.

In this case, an acid proliferator is preferably used to enhance sensitivity. Preferred examples of the acid proliferator employable herein include those exemplified in Japanese Patent Application No. 2003- 182849.

Further, an anionic polymerization initiator and a base generator (base generator) is preferably used. Moreover, in this case, a base proliferator is preferably used to enhance sensitivity. Specific preferred examples of the anionic polymerization initiator and base proliferator include those exemplified in Japanese Patent Application No. 2003-178083.

Specific preferred examples of the polymerization initiator, polymerization compound and binder of the invention include those exemplified in Japanese Patent Application No. 2004-238392.

Specific preferred examples of the polymerization initiator of the invention will be given below, but the invention is not limited thereto.

<Radical polymerization initiator (radical generator), antionic
polymerization initiator (acid generator)>

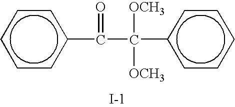

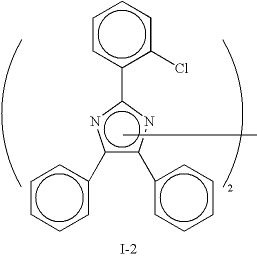

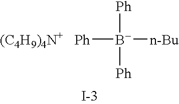

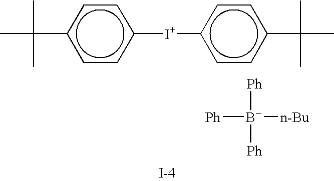

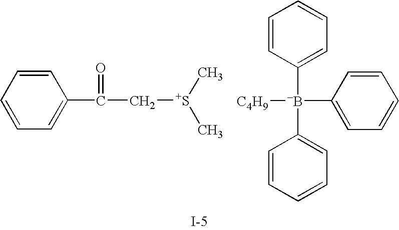

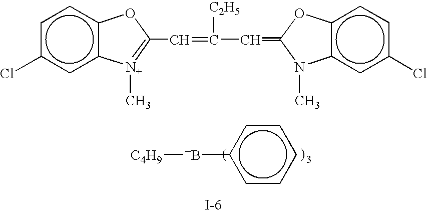

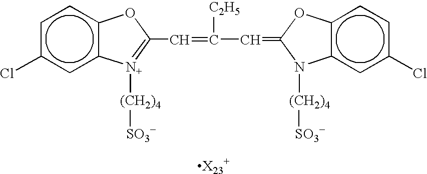

| | X₂₃⁺ | |
|---|---|---|
| I-7 | 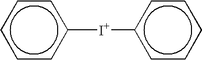 | (=C-1) |
| I-8 | 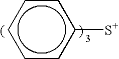 | (=C-2) |
| I-9 | 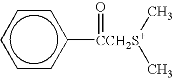 | (=C-3) |

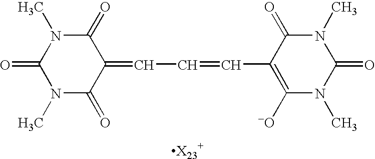

| | X₂₃⁺ |
|---|---|
| I-10 | C-1 |
| I-11 | C-2 |
| I-12 | C-3 |

Specific preferred examples of the cationic polymerization initiator or cationic polymerization initiator/radical polymerization initiator of the invention include the acid generators exemplified above with reference to 1) color development reaction.

Specific preferred examples of the cationic polymerization initiator of the invention include the base generators exemplified above with reference to 1) color development reaction.

In the hologram recording method of the invention and the hologram recording material allowing the hologram recording method, it is preferred that the sensitizing dye be decomposed and fixed at the first step, the second step or the subsequent fixing step involving either or both of irradiation with light and application of heat from the standpoint of storage properties and non-destructive reproduction. It is more desirable that the sensitizing dye be decomposed and fixed at the first step, the second step or the subsequent fixing step involving either or both of irradiation with light and application of heat and the coloring material be decomposed and fixed at the second step or the subsequent fixing step involving either or both of irradiation with light and application of heat.

The concept of “latent image color development-coloring material sensitized polymerization reaction process” will be described hereinafter.

For example, the hologram recording material is irradiated with YAG-SHG laser beam having a wavelength of 532 nm so that the laser beam is absorbed by the sensitizing dye to generate excited state. Energy or electron is then moved from the the excited state of the sensitizing dye to the interference fringe-recording component to cause the dye precursor contained in the interference fringe-recording component to change to a coloring material, whereby a latent image is formed by color development (first step). Subsequently, the hologram recording material is irradiated with light having a wavelength of from 350 nm to 420 nm so that the light is absorbed by the coloring material. Thus, electron or energy is moved to the polymerization initiator to activate the polymerization initiator to initiate polymerization. For example, when the polymerizable compound has a smaller refractive index than the binder, the polymerizable compound gathers at the polymerization area, causing the drop of refractive index (second step). At the area which has become a bright interference area at the first step, there is less remaining discolorable dye forming a latent image. Therefore, little polymerization occurs in the bright interference area at the second step. Thus, the proportion of binder is higher in the bright interference area. As a result, a great refractive index modulation can be performed between the bright interference area and the dark interference area. The refractive index modulation can be recorded as interference fringes. So far as the sensitizing dye and remaining discolorable dye can be decomposed and discolored at the first and second steps or the subsequent fixing step a hologram recording material excellent in non-destructive reproduction and storage properties can be provided.

For example, when the hologram recording material having a image, etc. recorded thereon is again irradiated with a laser beam having a wavelength of 532 nm, the data, image, etc. can be reproduced.

Specific preferred examples of the latent image-coloring material sensitized polymerization reaction include those exemplified in Japanese Patent Application No. 2004-238392.

4) Dye discoloration Reaction

In this hologram recording method, at least one discolorable dye is used and the discolorable dye is discolored during hologram exposure to cause refractive index modulation by which an interference fringes is formed.

The term “discolorable dye” as used herein generically indicates a dye which has absorption in the ultraviolet range of from 200 to 2,000 nm, visible light range and infrared range and directly or indirectly causes any, preferably both of shifting of λmax to shorter wavelength and reduction of molar absorption coefficient when irradiated with light. The discoloration reaction occurs preferably in the wavelength range of from 200 to 1,000 nm, more preferably from 300 to 900 nm.

Preferred examples of the hologram recording method include:
(A) A hologram recording method wherein the discolorable dye is a sensitizing dye having absorption in the hologram exposure wavelength and absorbs light during hologram exposure to discolor itself, causing refractive index modulation by which an interference fringes is formed; and
(B) A hologram recording method wherein there are provided at least a sensitizing dye having absorption at hologram exposure wavelength and a discolorable dye having a molar absorptivity of 1,000 or less, preferably 100 or less at hologram reproducing light wavelength and the sensitizing dye absorbs light during hologram exposure to generate excitation energy by which electron or energy moves to discolor the discolorable dye, causing refractive index modulation by which an interference fringes is formed. The hologram recording method (B) is preferred.

It is more preferred that there is provided a discoloring agent precursor other than the discolorable dye and the sensitizing and when subjected to hologram exposure, the sensitizing dyes or the discolorable dye generates excited state in which it then undergoes energy movement or electron movement with the discoloring agent precursor to cause the discoloring agent precursor to generate a discoloring agent which then discolors the discolorable dye, causing refractive index modulation by which an interference fringes is formed. The discoloring agent is preferably any of radical, acid, base, nucleophilic agent, electrophilic agent and singlet oxygen. Accordingly, the discoloring agent precursor is preferably any of radical generator, acid generator, base generator, nucleophilic agent generator, electrophilic agent generator and triplet oxygen. The discoloring agent precursor is preferably any of radical generator, acid generator and base generator.

Preferred examples of the acid generator and base generator include those exemplified above with reference to 1) interference fringes recording involving color development reaction. Preferred examples of radical generator include those exemplified above with reference to 3) interference fringes recording involving latent image color development-coloring material sensitized polymerization reaction.

In 4) interference fringes recording involving discoloration process of the invention, at least one of the sensitizing dye, the discolorable dye and the discoloring agent precursor is preferably a polymer or oligomer. More preferably, at least one of the discolorable dye and the discoloring agent precursor is a polymer or oligomer. Even more preferably, both the discolorable dye and the discoloring agent precursor are a polymer or oligomer. These components may each be a copolymer.

In 4) interference fringes recording involving discoloration process of the invention, at least one of the sensitizing dye, it is more desirable that a binder polymer be incorporated in addition to the sensitizing dye, discolorable dye, discoloring agent precursor, etc. Preferred examples of the binder polymer include those exemplified later with reference to 3) latent image color development-coloring material sensitized polymerization reaction and those disclosed in Japanese Patent Application No. 2004-238077.

The discolorable dye for making a difference in refractive index between bright interference area and dark interference area in the “dye discoloration reaction process” will be further described hereinafter.

In the aforementioned type (A), the discolorable dye also acts as a sensitizing dye. Thus, preferred examples of the discolorable dye include those exemplified above with reference to the sensitizing dye. λmax of the sensitizing dye/discolorable dye is preferably in between the wavelength of hologram recording and the wavelength 100 nm shorter than the wavelength of hologram recording.

In the aforementioned type (B), on the other hand, a discolorable dye is used separately of the sensitizing dye.

The discolorable dye preferably has a molar absorption coefficient in the hologram recording wavelength of 1,000 or less, more preferably 100 or less and most preferably 0, λmax of the discolorable dye is preferably in the range between the hologram recording wavelength and a wavelength shorter than the hologram recording wavelength by 200 nm.

In the process (B), the discolorable dye is preferably any of cyanine dye, squarilium cyanine dye, styryl dye, pyrilium dye, melocyanine dye, benzylidene dye, oxonol dye, coumarine dye, pyrane dye, xenthene dye, thioxanthene dye, phenothiazine dye, phenoxazine dye, phenazine dye, phthalocyanine dye, azaporphiline dye, porphiline dye, fused ring aromatic dye, perylene dye, azomethine dye, azo dye, anthraquinone dye and metal complex dye, more preferably any of cyanine dye, styryl dye, melocyanine dye, benzylidene dye, oxonol dye, coumarine dye, xanthene dye, azomethine dye, azo dye and metal complex dye.

The hologram recording material capable of performing B) interference fringes recording involving discoloration process preferably comprises the following components in addition to the sensitizing dye and binder.
i) Combination of at least an acid-discolorable dye and an acid generator
ii) Combination of at least a base-discolorable dye and a base generator
iii) The following discolorable dye which undergoes movement of electron or energy from and to the excited state of the sensitizing dye to severe the bond, making it possible to discolor itself

These components will be further described hereinafter.
i) Combination of at least an acid-discolorable dye and an acid generator

When the discoloring agent is an acid, that is, when the discoloring agent precursor is an acid generator, the discolorable dye which is preferably a dissociation product of acid-discolorable dye is preferably a dissociative benylidone dye, dissociative oxonol dye, dissociative xanthene dye or dissociative azo dye, more preferably a dissociation product of dissociative benzylidene dye, dissociative oxonol dye or dissociative azo dye. The term “dissociative dye” as used herein generically indicates a dye having an active hydrogen having pKa of from about 2 to 14 such as —OH group, —SH group, —COOH group, —NHSO₂R group and —CONHSO₂R group which undergoes deprotonation to have absorption in longer wavelength or with higher ε. Accordingly, such a dissociative dye can be previously treated with a base to form a dissociated dye from which a dye having absorption in longer wavelength or with higher ε can be prepared, making it possible to render the dye non-dissociative during photo-acid generation so that it is discolored (have absorption in lower wavelength or with lower ε).

In this case at least one of the acid generators as acid-discolorable dye or discoloring agent precursor is preferably a polymer or oligomer. It is also preferred that both the acid-discolorable dye and the acid generator are a polymer or oligomer. These components may be a copolymer.

Preferred examples of the acid generator which is a polymer or oligomer include those exemplified above with reference to 1) color development reaction.

The polymer or oligomer which is an acid-discolorable dye may contain an acid-discolorable dye in its main chain or in its side chains, preferably in its side chains. The polymer or oligomer containing an acid-discolorable dye in its side chains may be a copolymer of two or more monomers containing an acid-discolorable dye in its side chains or a copolymer of a monomer containing an acid-discolorable dye in its side chains with a monomer free of an acid-discolorable dye in its side chains.

Specific preferred examples of die acid-discolorable dye which is not a polymer or oligomer will be given below, but the invention is not limited thereto.

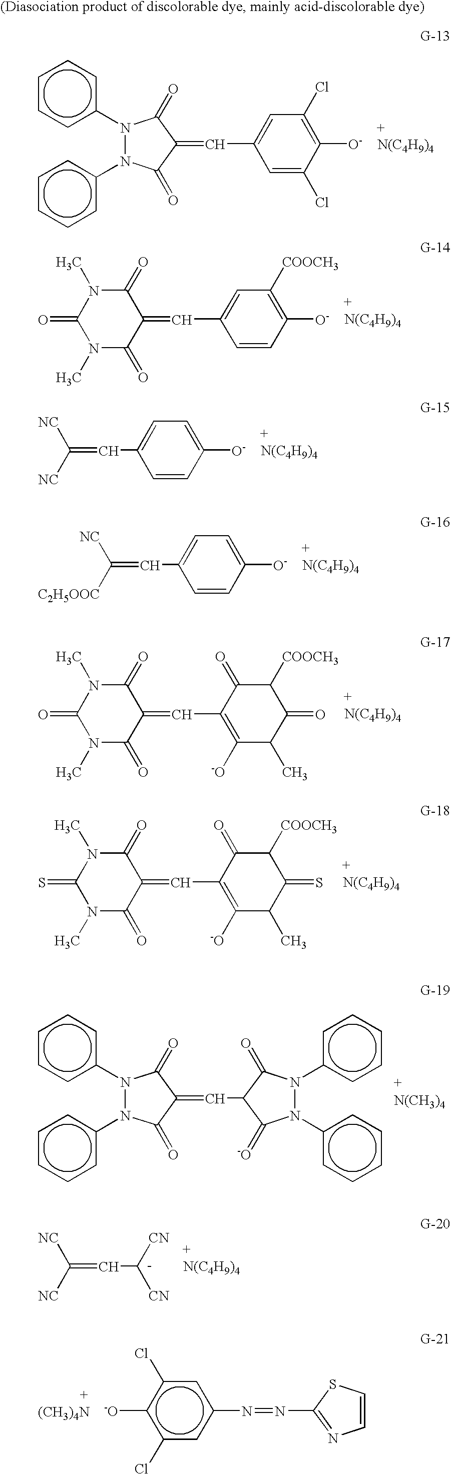

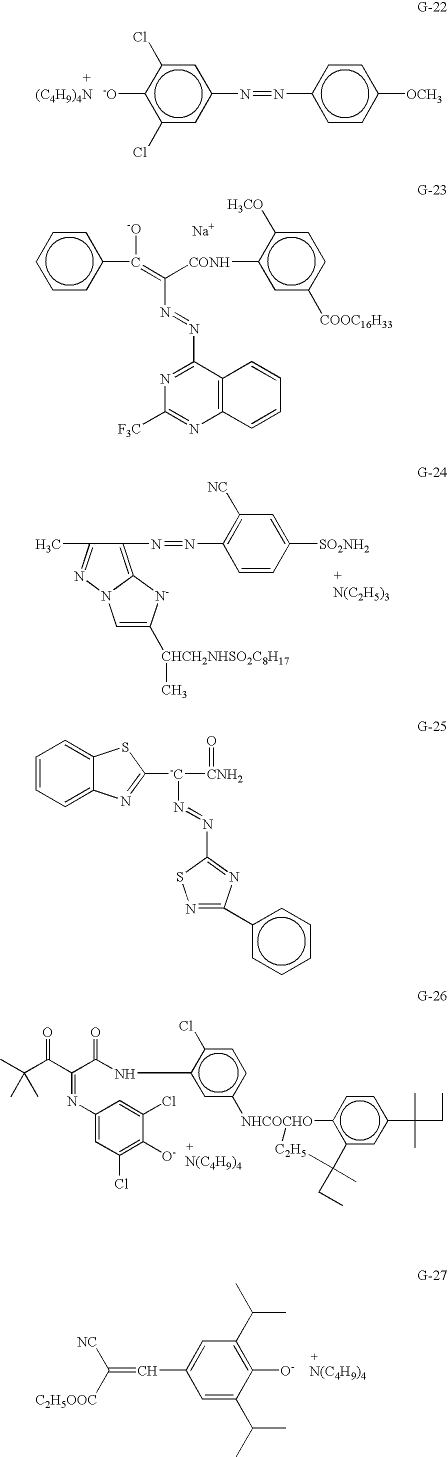

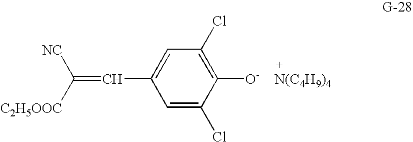

When the acid-discolorable dye in the hologram recording material of the invention is a polymer or oligomer, it is preferably a polymer or oligomer containing the aforementioned acid-discolorable dye incorporated in its main chain or in its side chains.

Particularly preferred examples of the acid-discolorable dye polymer or oligomer will be given below, but the invention is not limited thereto.

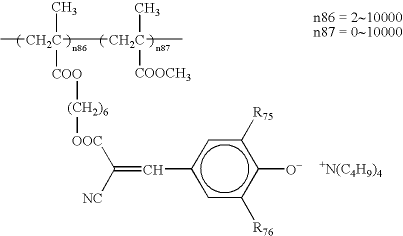

| | R₇₅ | R₇₆ |
|---|---|---|
| PG-1 | —Cl | —Cl |
| PG-2 | —Cl | —H |
| PG-3 | —H | —H |
| PG-4 | —i-C₃H₇ | —i-C₃H₇ |
| PG-5 | —COOCH₃ | —H |
| PG-6 | —NO₂ | —H |

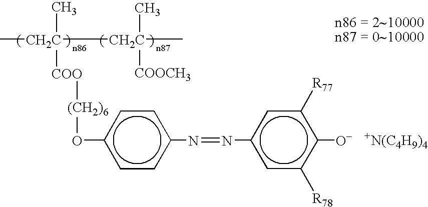

| | R₇₇ | R₇₈ |
|---|---|---|
| PG-7 | —H | —H |
| PG-8 | —Cl | —H |
| PG-9 | —Cl | —Cl |
| PG-10 | —CN | —H |

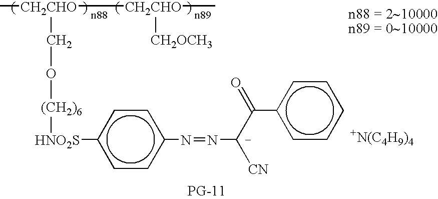

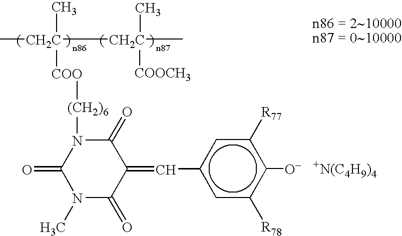

| | R₇₇ | R₇₈ |
|---|---|---|
| PG-12 | —Cl | —Cl |
| PG-13 | —CN | —H |
| PG-14 | —NO₂ | —H |
| PG-15 | —H | —H |

It is more desirable that the hologram recording material of the invention comprise a polymer or oligomer which is a copolymer of a monomer containing an acid generator in its side chains with a monomer containing an acid-discolorable dye in its side chains as exemplified below.

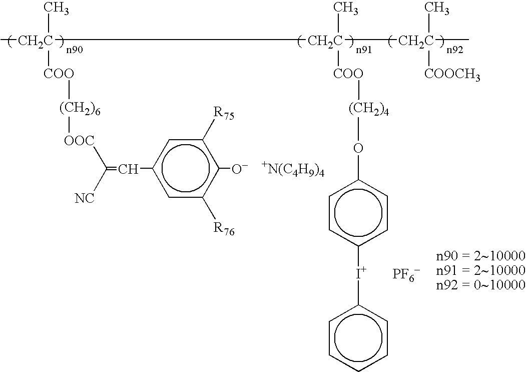

| | R₇₅ | R₇₆ |
|---|---|---|
| PAG-1 | —Cl | —Cl |
| PAG-2 | —Cl | —H |
| PAG-3 | —H | —H |
| PAG-4 | —COOCH₃ | —H |
| PAG-5 | —NO₂ | —H |

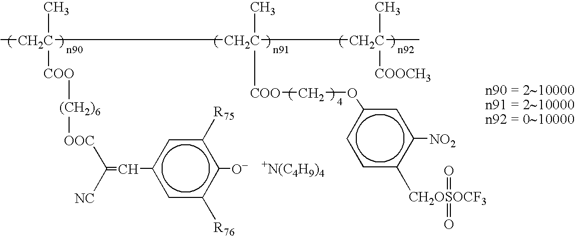

| | R₇₅ | R₇₆ |
|---|---|---|
| PAG-6 | —Cl | —Cl |
| PAG-7 | —Cl | —H |
| PAG-8 | —H | —H |
| PAG-9 | —COOCH₃ | —H |
| PAG-10 | —NO₂ | —H |

ii) Combination of at Least a Base-Discolorable Dye and a Base Generator

In the case where the discoloring agent is a base, that is, where the discoloring agent precursor is a base generator, when a product of color development of an acid-colorable dye such as triphenylmethane dye, xanthene dye and fluorane dye with an acid or cyanine dye formed by protonation of cyanine base is used as a base-discolorable dye, it can be converted to unprotonated product and thus discolored (have absorption in lower wavelength or with lower ε) during photo-base generation.

In this case, at least one of the base generators as base-discolorable dye or discoloring agent precursor is preferably a polymer or oligomer. It is also preferred that both the base-discolorable dye and the base generator be a polymer or oligomer. These components may be a copolymer.

Preferred examples of the base generator which is a polymer or oligomer include those exemplified above with reference to 1) color development reaction.

The polymer or oligomer which is a base-discolorable dye may contain a base-discolorable dye in its main chain or in its side chains, preferably in its side chains. The polymer or oligomer containing a base-discolorable dye in its side chains may be a copolymer of two or more monomers containing a base-discolorable dye in its side chains or a copolymer of a monomer containing a base-discolorable dye in its side chains with a monomer free of a base-discolorable dye in its side chains.

Specific preferred examples of the base-discolorable dye which is not a polymer or oligomer will be given below, but the invention is not limited thereto.

<Color development product of acid-colorable dye, mainly
base-discolorable dye>

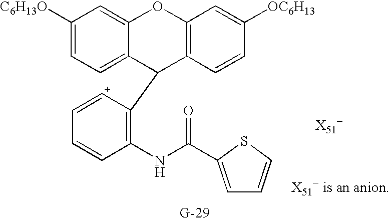

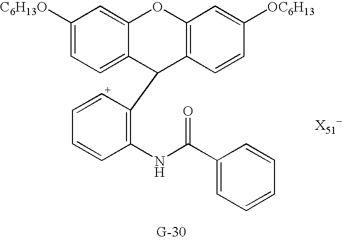

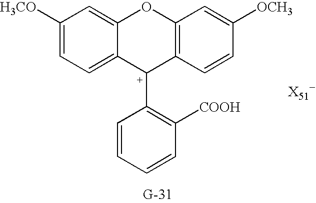

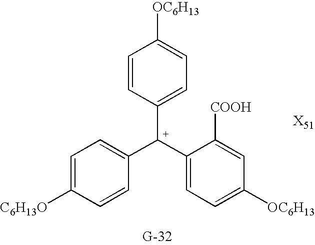

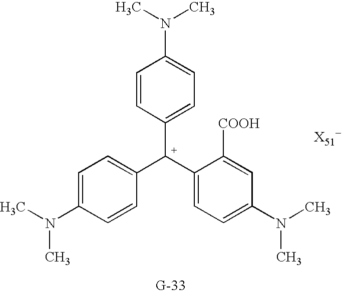

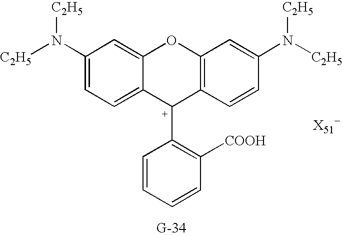

<Acid-color development product of cyanine base, mainly
base-discolorable dye>

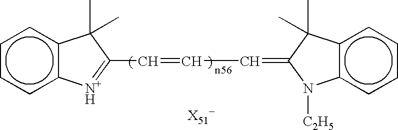

| | n₅₆ |
|---|---|
| G-35 | 0 |
| G-36 | 1 |
| G-37 | 2 |

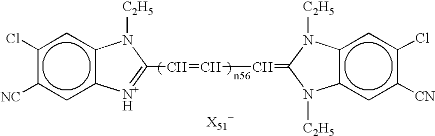

| | n₅₆ |
|---|---|
| G-38 | 0 |
| G-39 | 1 |

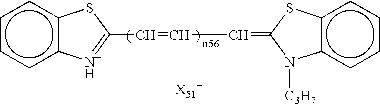

| | n₅₆ |
|---|---|
| G-40 | 0 |
| G-41 | 1 |

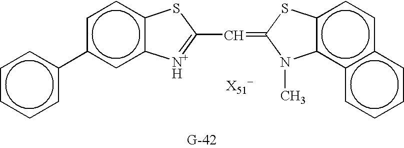

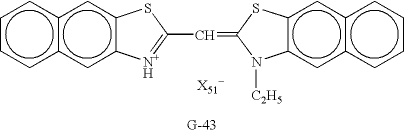

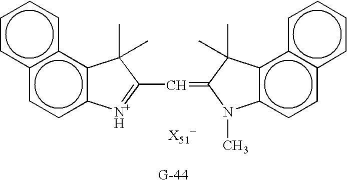

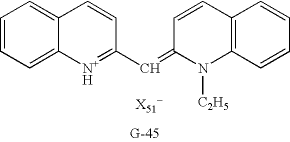

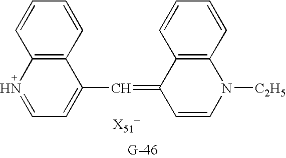

When the base-discolorable dye in the hologram recording material of the invention is a polymer or oligomer, it is preferably a polymer or oligomer containing the aforementioned base-discolorable dye incorporated in its main chain or in its side chains.

Particularly preferred examples of the base-discolorable dye polymer or oligomer will be given below, but the invention is not limited thereto.

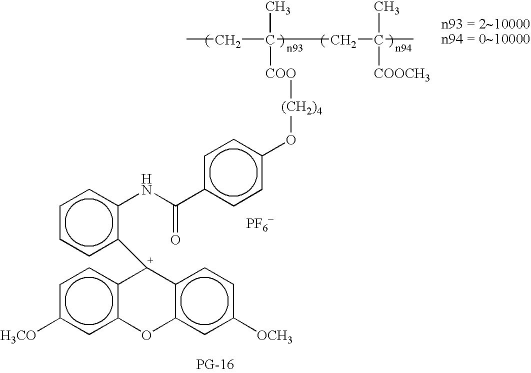

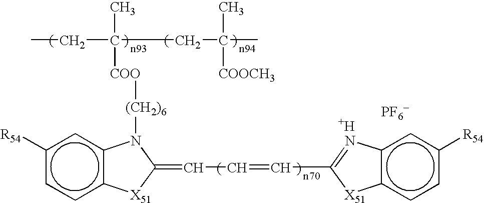

| | n70 | R₆₄ | X₅₁ |
|---|---|---|---|
| PG-17 | 0 | —Cl | —S |
| PG-18 | 0 | —H | —S |
| PG-19 | 1 | —H | —S |
| PG-20 | 1 | —Cl | —S |
| PG-21 | 0 | —H | —C(CH₃)₂— |
| PG-22 | 1 | —H | —C(CH₃)₂— |

It is more desirable that the hologram recording material of the invention comprise a polymer or oligomer which is a copolymor of a monomer containing a base generator in its side chains with a monomer containing a base-discolorable dye in its side chains as exemplified below.

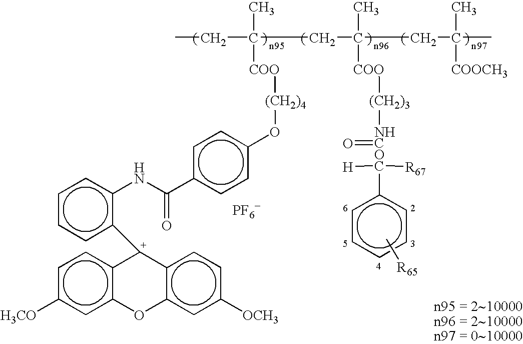

| | R₆₆ | R₆₇ |
|---|---|---|
| PBG-1 | 2-NO₂ | H |
| PBG-2 | 2-NO₂, 6-NO₂ | H |
| PBG-3 | 2-NO₂ | 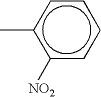 |
| PBG-4 | 3-OCH₃, 4-OCH₃ | H |
| PBG-5 | 2-NO₂, 4-OCH₃, 5-OCH₃ | H |

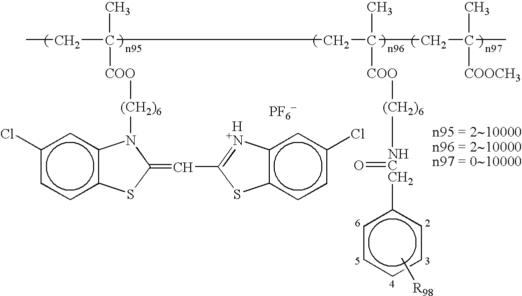

| | R₆₆ |
|---|---|
| PBG-6 | 2-NO₂ |
| PBG-7 | 2-NO₂, 6-NO₂ |
| PBG-8 | 3-OCH₃, 4-OCH₃ |
| PBG-9 | 2-NO₂, 4-OCH₃, 5-OCH₃ |

iii) The Following Discolorable Dye Which Undergoes Movement of Electron or Energy From and to the excited State of the Sensitizing Dye to Severe the Bond, Making it Possible to Discolor Itself

Preferred examples of the discolorable dye of the invention include a discolorable dye which undergoes movement of energy or electron, preferably electron from the excited state of the sensitizing dye generated by hologram exposure to severe the bond, making it possible to discolor itself.

Preferred examples of the discolorable dye will be given below, but the invention is not limited thereto.

Such a discolorable dye is originally a cyanine dye. However, when the electron movement causes the bond to be severed, the discolorable dye is converted to a cyanine base (leucocyanine dye), causing the absorption to be eliminated or shifted to lower wavelength.

<Discoloration by caveration of bond by electron movement>

| R₅₁ | 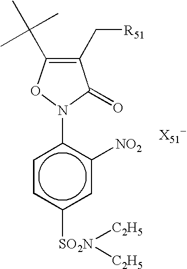 | 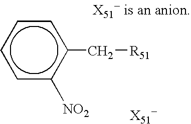 |
|---|---|---|
| GD-1 | G-47 | G-54 |
| GD-2 | G-48 | G-55 |
| GD-3 | G-49 | G-56 |
| GD-4 | G-50 | G-57 |
| GD-5 | G-51 | G-58 |
| GD-6 | G-52 | G-59 |
| GD-7 | G-53 | G-60 |

*: Substitution at position

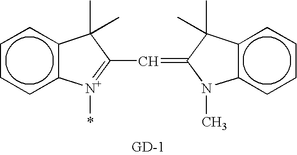

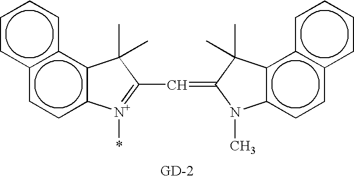

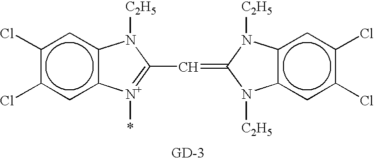

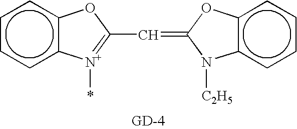

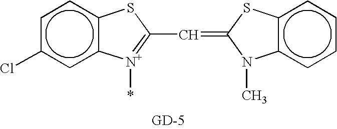

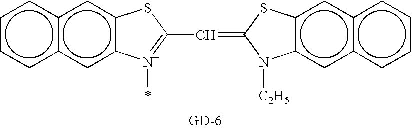

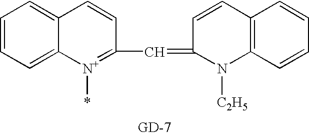

The aforementioned compound is preferably a discolorable dye polymer or oligomer represented by the following formula (2).
(A2−DD)m1 (1)

In the formula (2), A2 and DD are covalently bonded to each other. A2 represents a site capable of disconnecting the covalent bond to DD upon the movement of electron or energy from and to the excited state of the sensitizing dye. DD represents a site which stays in the form of dye when covalently bonded to A2 but is discolored when released upon the disconnection of the covalent bond to A2.

The molecules of the formula (2) are connected to each other with covalent bond of any of A2 and DD to form a polymer or oligomer. The suffix m2 represents an integer of from not smaller than 3 to not greater than 1,000,000.

In the formula (2), it is preferred that DD be a group formed by, cyanine base and be covalently bonded to A1 on chromophore.

Preferred examples of the discolorable dye polymer or oligomer of the invention represented by the formula (2) will be given below, but the invention is not limited thereto.

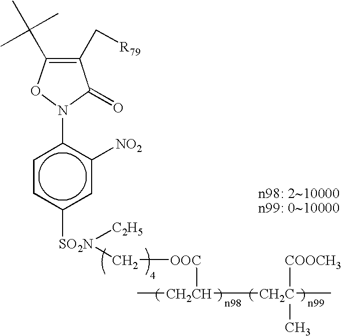

| | R₇₉ |
|---|---|
| PG-23 | GD-1 |
| PG-24 | GD-4 |
| PG-25 | GD-5 |
| PG-26 | GD-3 |

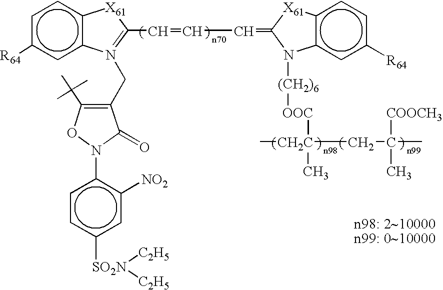

| | n70 | R₆₄ | R₆₁ |
|---|---|---|---|
| PG-27 | 0 | —Cl | —S— |
| PG-28 | 0 | —H | —S— |
| PG-29 | 1 | —Cl | —S— |
| PG-30 | 0 | —H | —C(CH₃)₂— |
| PG-31 | 1 | —H | —C(CH₃)₂— |

Specific preferred examples of the dye discoloration reaction include those exemplified in Japanese Patent Application No. 2004-88790.

5) Remaining Discolorable Dye Latent Image-Latent Image Sensitized Polymerization Reaction

This hologram recording method preferably comprises a first step at which the sensitizing dye having absorption at hologram exposure wavelength absorbs light during hologram exposure to generate excited state with the energy of which it then discolors the discolorable dye having a molar absorption coefficient of 1,000 or less, preferably 100 or less, most preferably 0 at hologram reproducing light wavelength whereby the discolorable dye left undiscolored forms a latent image and a second step at which the latent image of discolorable dye left undiscolored is irradiated with light having a wavelength different from that used for hologram exposure to cause polymerization by which an interference fringes is recorded as refractive index modulation. This hologram recording method is excellent in high speed recording properties, adaptability to multiplexed recording, storage properties after recording etc.

This hologram recording method more preferably comprises a first step at which the sensitizing dye represented having absorption at hologram exposure wavelength absorbs light during hologram exposure to generate excited state in which it then undergoes energy movement or electron movement with the discoloring agent precursor as defined in Clause 6) to cause the discoloring agent precursor to generate a discoloring agent which then discolors the discolorable dye whereby the discolorable dye left undiscolored forms a latent image and a second step at which the latent image of discolorable dye left undiscolored is irradiated with light having a wavelength different from that used for hologram exposure to cause energy movement or electron movement by which a polymerization initiator is activated to cause polymerization by which an inference fringes is recorded as refractive index modulation.

Further, the compound group allowing the aforementioned hologram recording method preferably comprises at least:
1) A sensitizing dye absorbing light upon hologram exposure to generate excited state at the first step;
2) A discolorable dye having a molar absorption coefficient of 1,000 or less at hologram reproducing light wavelength capable of performing direct energy or electron movement to the discoloring agent precursor from the excited state of the sensitizing dye to generate a discoloring agent with which discoloration can be effected at the first step;
3) A polymerization initiator (optionally acting as a discoloring agent precursor 2) as well) which can undergo electron or energy transfer from excited state of remaining discolorable dye to initiate the polymerization of the polymerizable compound at the second step;
4) A polymerizable compound; and
5) A binder.

At least one of the sensitizing dye, the discolorable dye and the discoloring agent precursor is preferably a polymer or oligomer. More preferably, at least one of the sensitizing dye and the discolorable dye is a polymer or oligomer. Both the discolorable dye and the discoloring agent precursor may be a polymer or oligomer. It may also be a copolymer.

Preferred examples of the sensitizing dye include those exemplified above with reference to 1) color development reaction.

Preferred examples of the polymerization initiator, polymerizable compound and binder include those exemplified above with reference to 3) latent image color development-coloring material sensitized polymerization reaction.

Preferred examples of the discolorable dye and the discoloring agent precursor include those exemplified above with reference to 4) discoloration reaction.

The light at the second step preferably has a wavelength range at which the sensitizing dye represented by any of the formulae (1) and (3-1) to (3-5) exhibits a molar absorption coefficient of 1,000 or less, more preferably 500 or less.

Further, at the wavelength range of the light emitted at the second step, the discolorable dye preferably exhibits a molar absorption coefficient of 1,000 or more.

In the “remaining discolorable dye latent image-latent image sensitized polymerization process” of the invention, it is also preferred that the discoloring agent precursor and the polymerization initiator partly or wholly act as each other.

In the case where a discolorable dye is added in addition to the sensitizing dye, when the discoloring agent precursor and the polymerization initiator are different from each other (e.g., when the discoloring agent precursor is an acid generator or base formula and the polymerization initiator is a radical polymerization initiator or when the discoloring agent precursor is a radical generator or nucleophilic agent generator and the polymerization initiator is an acid generator or base generator), it is preferred that the sensitizing dye can perform electron movement sensitization only on the discoloring agent precursor and the polymerization initiator can perform electron movement sensitization only by the discolorable dye.

In the hologram recording method of the invention and the hologram recording material allowing the hologram recording method, it is preferred that the sensitizing dye be decomposed and fixed at the first step, the second step or the subsequent fixing step involving either or both of irradiation with light and application of heat from the standpoint of storage properties and non-destructive reproduction. It is more desirable that the sensitizing dye be decomposed and fixed at the first step, the second step or the subsequent fixing step involving either or both of irradiation with light and application of heat and the remaining discolorable dye be decomposed and fixed at the second step or the subsequent fixing step involving either or both of irradiation with light and application of heat.

The concept of “remaining discolorable dye latent image-latent image sensitized polymerization reaction process” will be described hereinafter.

For example, the hologram recording material is irradiated with YAG-SHG laser beam having a wavelength of 532 nm so that the laser beam is absorbed by the sensitizing dye to generate excited state. Energy or electron is then moved from the the excited state of the sensitizing dye to the discoloring agent precursor to generate a discoloring agent by which the discolorable dye is then discolored. As a result, a latent image can be formed by the remaining discolorable dye (first step). Subsequently, the hologram recording material is irradiated with light having a wavelength of from 350 nm to 420 nm so that the light is absorbed by the remaining discolorable dye. Then, electron or energy is moved to the polymerization initiator to active the polymerization initiator to initiate polymerization. For example, when the polymerizable compound has a smaller refractive index than the binder, the polymerizable compound gathers at the polymerization area, causing the drop of refractive index (second step). At the area which has become a bright interference area at the first step, there is less remaining discolorable dye forming a latent image. Therefore, little polymerization occurs in the bright interference area at the second step. Thus, the proportion of binder is higher in the bright interference area. As a result, a great refractive index modulation can be performed between the bright influence area and the dark interference area. The refractive index modulation can be recorded as interference fringes. So far as the sensitizing dye and remaining discolorable dye can be decomposed aid discolored at the first and second steps or the subsequent fixing step, a hologram recording material excellent in non-destructive reproduction, storage properties and diffraction efficiency can be provided.

For example, when the hologram recording material having data, image, etc. recorded thereon is again irradiated with a laser beam having a wavelength of 532 nm, the data, image, etc. can be reproduced. Alternatively, the hologram recording material of the invention can act as a desired optical material.

Specific preferred examples of the remaining discolorable dye latent image-latent image sensitized polymerization reaction include those exemplified in Japanese Patent Application No. 2004-88790.

The hologram recording material of the invention may further comprise additives such as electron-donating compound, electron-accepting compound, chain transfer agent, crosslinking agent, heat stabilizer, placticizer and solvent incorporated therein besides the aforementioned sensitizing dyes, interference fringe-recording component polymerization initiator, polymerizable compound, binder, discolorable dye, discoloring agent precursor, etc. as necessary.

The electron-donating compound is capable of reducing the radical cation in the sensitizing dyes, coloring materials or discolorable dyes. The electron-accepting compound is capable of oxidizing the radical anion in the sensitizing dyes, coloring materials or discolorable dyes. Thus, both the electron-donating compound and the electron-accepting compound are capable of reproducing the sensitizing dye. Specific preferred examples of these compounds include those exemplified in Japanese Patent Application No. 2004-238077.

In particular, the electron-donating compound is useful for the enhancement of sensitivity because it can rapidly reproduce from the radial cation of the sensitizing dyes, coloring materials or discolorable dye produced by the movement of electron to the dye precursor group. As the electron-donating compound there is preferably used one having a more negative oxidation potential than sensitizing dye, coloring material and discolorable dye.

The electron-donating compound is preferably any of alkylamines, anilines, phenylenediamines, triphenylamines, carbazoles, phenothiazines, phenoxazines, phenazines, hydroquinones, catechols, alkoxybenzenes, aminophenols, imidazoles, pyridines, metalocenes, metal complexes and particulate semiconductor, more preferably triphenylamines, phenothiazines, phenoxazines and phenazines, particularly phenothiazine-based compounds (e.g., 10-methylphenothiazine, 10(4′-methoxphenyl) phanothiazine), triphenylamine-based compounds (e.g., triphenylamine, tri(4′-methoxyphenyl)amine), and TPD-based conpounds (e.g., TPD), even more preferably phenothiazine-based compounds, most preferably N-methyl phenothiazine.

Specific preferred examples of the electron-donating compound will be given below, but the invention is not limited thereto.

Examples of electron-donating compound for reproduction
of sensitizing dye

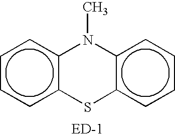

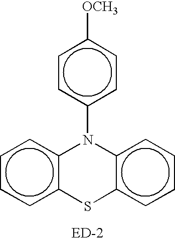

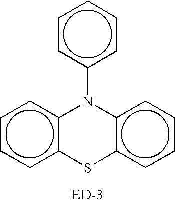

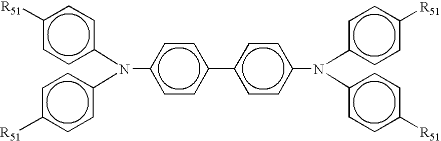

| | R₅₁ |
|---|---|
| ED-4 | H |
| ED-5 | —OCH₃ |

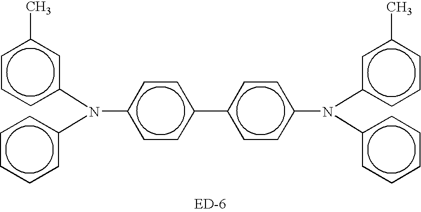

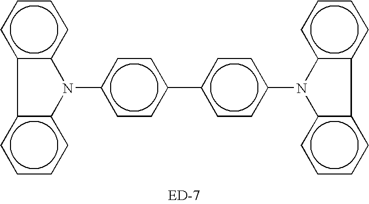

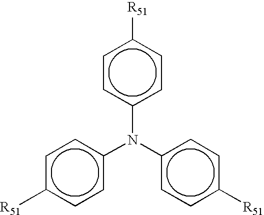

| | R₅₁ |
|---|---|
| ED-8 | H |
| ED-9 | —CH₃ |
| ED-10 | —OCH₃ |

| | | | |
|---|---|---|---|
| 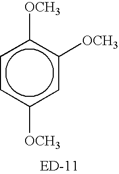 | 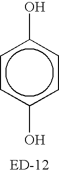 | 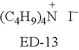 | 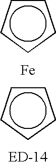 |

In the hologram recording material of the invention, the electron-donating compound is preferably a polymer or oligomer.

The polymer or oligomer which is an electron-donating compound may contain an electron-donating compound in its main chain or in its side chains, preferably in its side chains. The polymer or oligomer containing an electron-donating compound in its side chain may be a copolymer of two or more monomers containing an electron-donating compound in its side chains or a copolymer of a monomer containing an electron-donating compound in its side chains with a monomer free of an electron-donating compound in its side chains.

When the electron-donating compound in the hologram recording material of the invention is a polymer or oligomer, it is preferably a polymer or oligomer containing the aforementioned electron-donating compound incorporated in its main chain or in its side chains.

Particularly preferred examples of the electron-donating compound polymer or oligomer will be given below, but the invention is not limited thereto.

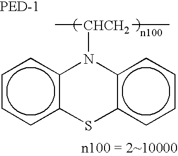

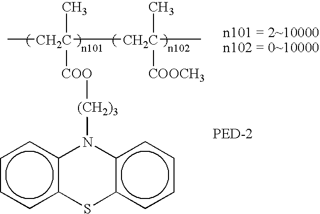

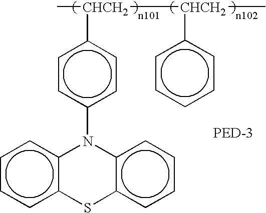

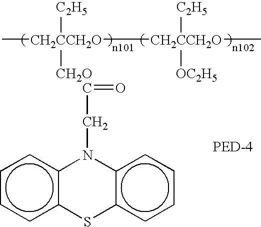

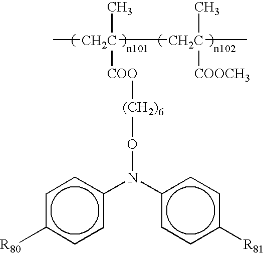

| | R₆₀ | R₆₁ |
|---|---|---|
| PED-5 | —H | —H |
| PED-6 | —OCH₃ | —OCH₃ |
| PED-7 | —CH₃ | —CH₃ |

It is also preferred that the hologram recording material of the invention comprise a polymer or oligomer which is a copolymer of a monomer containing an electron-donating compound in its side chains with a monomer containing a sensitizing dye or interference fringes-recording component in its side chains as exemplified below.

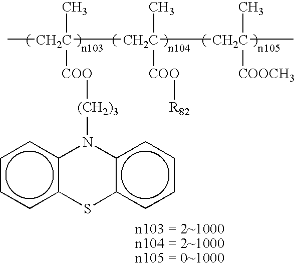

| | R₆₂ |
|---|---|
| PEDS-1 | 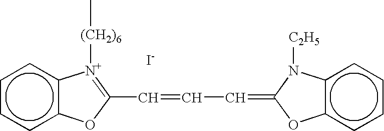 |
| PEDS-2 | 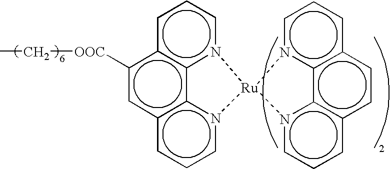 |

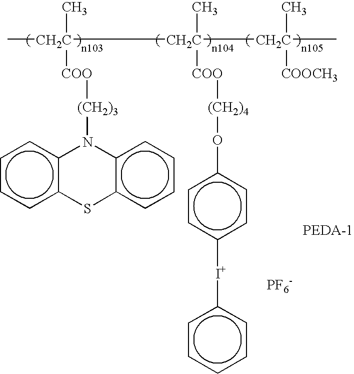

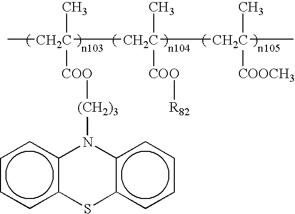

| | R₆₂ |
|---|---|
| PEDD-1 | 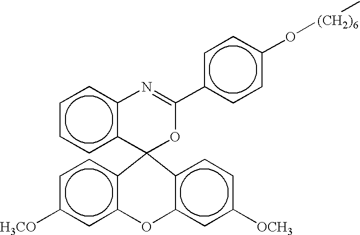 |
| PEDD-2 | 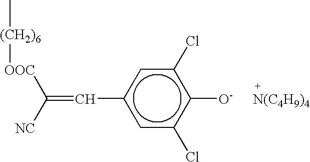 |

The electron-receiving compound is useful for the enhancement of sensitivity because it can rapidly reproduce the sensitizing dye or coloring material radical anion produced by the movement of electron from the dye precursor group. As the electron-donating compound there is preferably used one having a more negative oxidation potential than sensitizing dye and coloring material.

Preferred examples of the electron-receiving compound include an aromatic compound having an electrophilic group such as dinitrobenzene and dicyanobenzene incorporated therein, a heterocyclic compound, a heterocyclic compound having an electrophilic group incorporated therein, an N-alkylpyridinium salt a benzoquinione, an imide, a metal complex, and a particulate semiconductor.

Specific preferred examples of chain transfer agent crosslinking agent, heat stabilizer, placticizer, solvent, etc. include those exemplified in Japanese Patent Application No. 2004-238392.

Preferred examples of the chain transfer agent include thiols. Examples of these thiols include 2-mercaptobenzoxazole, 2-mercaptobenzthiazole, 2-mercaptobenzimidazole, 4-methyl-4H-1,2,4-triazole-3-thiol, p-bromobenzenethiol, thiocyanuric acid, 1,4-bis(mercapto)benzene, and p-toluenethiol.

In particular, in the case where the polymerization initiator is a 2,4,5-triphenylimidazolyl dimer, a chain transfer agent is preferably used.

The hologram recording material of the invention may comprise a heat stabilizer incorporated therein to enhance the storage properties thereof during storage.

Examples of useful heat stabilizers include hydroquinone, phenidone, p-methoxypheno, alkyl-substituted hydroquinone, alkyl-substituted quinone, aryl-substituted hydroquinone; aryl-substituted quinone; catechol, t-butylcatechol pyrogallol, 2-naphthol, 2,6-di-t-butyl-p-cresol, phenothiazine, and chloranyl.

The placticizer is used to change the adhesivity, flexibility, hardness and other mechanical properties of the hologram recording material. Examples of the placticizer employable herein include triethylene glycol dicaprylate, triethylene glycol bis(2-ethylhexanoate), tetraethylene glycol diheptanoate, diethyl sebacate, dibutyl sberate, tris(2-ethylhexyl) phosphate, tricrcsyl phosphate, dibutyl phthalate, alcohols, and phenols.

The hologram recording material of the invention may be prepared by any ordinary method.

For the production of the film of the hologram recording material of the invention, the aforementioned binder and various components may be spread over the substrate in the form of solution in a solvent or the like using a spin coater, bar coater or the like.

Preferred examples of the solvent to be used herein include ketone-based solvents such as methyl ethyl ketone, methyl isobutyl ketone, acetone and cyclohexanone, ester-based solvents such as ethyl acetate, butyl acetate, ethylene glycol diacetate, ethyl lacate and cellosolve acetate, hydocarbon-based solvents such as tetrahydrofurane, dioxane and diethyl ether, cellosolve-based solvents such as methyl cellosolve, ethyl cellosolve, butyl cellosolve and dimethyl cellosolve, alcohol-based solvents such as methanol, ethanol, n-propanol, 2-propanol, n-butanol and diacetone alcohol, fluorine-based solvents such as 2,2,3,3-tetrafluoropropanol, halogenated hydrocarbon-based solvents such as dichloromethane, chloroform and 1,2-dichlorethane, amide-based solvents such as N,N-dimethylformamide, and nitrile-based solvents such as acetonitrile and propionitrile.

The hologram recording material of the invention can be prepared by spreading the aforementioned coating solution directly over the substrate using a spin coater, roll coater, bar coater or the like or by casting the coating solution into a film which is then laminated on the substrate using an ordinary method.

The term “substrate” as used herein is meant to indicate an arbitrary natural or synthetic support, preferably one which can occur in the form of flexible or rigid film, sheet or plate.

Preferred examples of the substrate include polyethylene terephthalate, resin-undercoated polyethylne terephthalate, flame- or electostatically discharged polyethylene terephthalate, cellulose acetate, polycarbonate, polymethyl methacrylate, polyster, polyvinyl alcohol, and glass.

The solvent used can be evaporated away during drying. The evaporation may be effected under long or reduced pressure.

The film of the hologram recording material of the invention may be prepared by melting the binder comprising various components at a temperature of not lower than the glass transition temperature or melting point of the binder, and then melt-extruding or injection-molding the molten binder. During this procedure, a reactive crosslinkable binder may be used as the binder so that the binder thus extruded or molded can be crosslinked and cured to raise the strength of the film. In this case, the crosslinking reaction may involve radical polymerization reaction, cationic polymerization reaction, condensation polymerization reaction, addition polymerization reaction or the like. Alternatively, methods disclosed in JP-A-2000-250382, JP-A-2000-172154, etc. are preferably used,

Further, a method is preferably used which comprises dissolving various components in a monomer solution for forming a binder, and then subjecting the monomer to photopolymerization or photopolymerization to produce a polymer which is then used as a binder. Examples of the polymerization method employable herein include radical polymerization reaction, cationic polymerization reaction, condensation polymerization reaction, and addition polymerization reaction.

Moreover, a protective layer for blocking oxygen may be formed on the hologram recording material. The protective layer may be formed by laminating a film or sheet of a plastic such as polyolefin (e.g., polypropylene, polyethylene), polyvinyl chloride, polyvinylidene chloride, polyvinyl alcohol, polyethylene terephthalate and cellophane on the hologram recording material using an electrostatic contact method or an extrusion machine or by spreading the aforementioned polymer solution over the hologram recording material. Alternatively, a glass sheet may be laminated on the hologram recording material. Further, an adhesive or liquid material may be provided interposed between the protective layer and the photosensitive layer and/or between the substrate and the photosensitive layer to enhance airtightness.

In the case where the hologram recording material of the invention is used for holographic light memory, it is preferred from the standpoint of enhancement of S/N ratio during the reproduction of signal that the hologram recording material undergo no shrinkage after hologram recording.

To this end, it is preferred that the hologram recording material of the invention comprise an inflating agent disclosed in JP-A-2000-86914 incorporated therein or a shrinkage-resistant binder disclosed in JP-A-200-250382, JP-A-2000-172154 and JP-A-11-344917 incorporated therein.

Further, it is preferred that the interference fringes gap be adjusted using a diffusion element disclosed in JP-A-3-46687, JP-A-5-204288, JP-A-9-506441, etc.

When a known ordinary photopolymer as disclosed in JP-A63634, JP-A-2-3082, JP-A-50588, JP-A-5-107999, JP-A-8-16078, JP-T-2001-523842 and JP-T-11-512847 is subjected to multiplexed recording, the latter half of multiplexed recording is conducted on the area where polymerization has proceeded so much. Therefore, the latter half of multiplexed recording requires more exposure time to record the same signal than the former half of multiplexed recording (lower sensitivity). This has been a serious problem in system design. In other, it has been disadvantageous in that the range within which the refractive index modulation shows linear rise with respect to exposure is very narrow.

On the contrary, 1) color development reaction, 2) latent image color development-coloring material self-sensitized amplification color development reaction and 4) dye discoloration reaction process recording methods of the invention involve no polymerization during the recording of interference fringes. Even 3) latent image color development-coloring material sensitized polymerization reaction and 5) remaining discolorable dye latent image-latent image sensitized polymerization reaction process recording methods of the invention involve little polymerization reaction during hologram exposure (first step) and entire exposure causing block polymerization by which refractive index modulation is conducted at the second step. Accordingly, much multiplexed recording can be conducted in any of the recording methods 1) to 5). Further, any multiplexed recording can be conducted at a constant exposure, i.e., with a linear rise of refractive index modulation relative to exposure. Therefore, a broad dynamic range can be obtained. Thus, 1) to 5) process recording methods of the invention are very advantageous from the standpoint of the aforementioned adaptability to multiplexed recording.

This is advantageous from the standpoint of enhancement of density (capacity), simplification of recording system, enhancement of S/N ratio, etc.

As mentioned above, the hologram recording material of the invention gives drastic solution to the aforementioned problems. In particular, the hologram recording material of the invention allows quite a new recording method which attains high sensitivity, good storage properties, dry processing properties and multiplexed recording properties (high recording density). The hologram recording material is particularly suited for optical recording medium (holographic optical memory).

In particular, when the sensitizing dye is optically discolored and fixed after hologram recording, no deterioration can occur even upon irradiation with reproducing light after recording. In other words, non-destructive reproduction can be made, providing excellent storage properties. Further, when fixing is effected after recording, no absorption of hologram reproducing light can occur, making it possible to obtain a high absolute diffraction efficiency.

The hologram recording material of the invention can be used as three-dimensional display hologram, holographic optical element (HOE, such as headup display (HUD) for automobile, pickup lens for optical disc, head mount display, color filter for liquid crystal, reflector for reflective liquid crystal, lens, diffraction grating, interference filter, connector for optical fiber, light polarizer for facsimile, window glass for building), cover paper for book, magazine, and display for POP, etc. The hologram recording material of the invention is preferably used for gift and credit card, paper money and packaging for the purpose of security against forgery.

Specific examples of the invention will be described in connection with the results of experiments, but the invention is of course not limited thereto.

### EXAMPLE 1

### Hologram Recording Method Involving Color Development Process

The sensitizing dye, electron-donating compounds interference fringes recording component, additives and binder PMMA-EA (poly(methyl methacrylate)-5% ethyl acrylate) copolymer; Mw: 101,000) set forth in Table 1 were dissolved in a double to quadruple amount of methylene chloride (optionally acetone or acetonitrile as well) under a red light to prepare novel hologram recording material compositions 101 to 106 comprising the polymer component of the invention. Further, as opposed to these inventive compositions, comparative sample compositions 11 to 16 which are of novel recording type but free of polymer component were prepared. The term “%” as used herein is meant to indicate % by weight based on binder PMMA-EA.

TABLE 1

| | | |
|---|---|---|
| 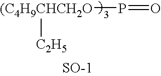 | 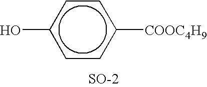 | 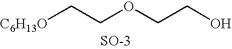 |

| | | | | |
|---|---|---|---|---|
| | Sensitizing | Electron-donating | Interference fringes | |
| Sample | dye | compound | recording component | Additives |

| | | | | | | |
|---|---|---|---|---|---|---|
| 101 | S-75 | 80% | | — | I-5 50% + PL-1 15% | SO-1 8% |
| Comparative 11 | ″ | | | — | I-5 50% + L-2 10% | ″ |
| 102 | S-81 | 30% | | — | I-5 50% + PL-1 15% | SO-2 36% |
| Comparative 12 | ″ | | | — | I-5 50% + L-2 10% | ″ |
| 103 | S-93 | 1.6% | A-1 | 42% | I-5 50% + PL-1 15% | SO-3 8% |
| Comparative 13 | ″ | | | ″ | I-5 50% + L-2 10% | ″ |
| 104 | S-92 | 0.84% | PED-2 | 42% | I-5 50% + PL-3 15% | ″ |
| Comparative 14 | | ″ | A-1 | 42% | I-5 50% + LC-9 10% | ″ |
| 105 | S-6 | 0.5% | | ″ | PB-2 20% + PDD-5 15% | ″ |
| Comparative 15 | | ″ | | ″ | PB-2 20% + DD-35 10% | ″ |
| 106 | S-93 | 1.6% | | ″ | PE-11 30% | Trioctylamine 10% |
| Comparative 16 | ″ | | | ″ | E-3 25% | ″ |

*PL-1:n68:n69 = 1:2; PL-3:n68:n69 = 1:2; PDD-5:n79:n80 = 1:2; PE-11:n84:n85 = 1:2; PED-2:n101:n102 = 1:1

The hologram recording material compositions 101 to 106 and the comparative sample compositions 11 to 16 were each spread (optionally in a multi-layer form) over a glass substrate to a thickness of about 80 μm using a blade to form a photosensitive layer which was then dried at room temperature in vacuo for 1 day to remove the solvent. The photosensitive layer was then covered by TAC (triacetly cellulose) layer to prepare hologram recording materials 101 to 106 and comparative samples 11 to 16.

The hologram recording materials were each then exposed to YAG laser second harmonic (532 nm; output: 2W) as a light source in a two-flux optical system for transmission hologram recording shown in FIG. 1 to perform recording. The angle of the object light with respect to the reference light was 30 degrees. The light had a diameter of 0.6 cm and an intensity of 8 mW/cm². During exposure, the holographic exposure time was varied from 0.1 to 400 seconds (radiation energy ranging from 0.8 to 3,200 mJ/cm²). He—Ne laser bean having a wavelength of 632 nm was passed through the center of exposed area at the Bragg angle. The ratio of diffracted light to transmitted light (relative diffraction efficiency) was then measured at real time. Since the sensitizing dye shows no absorption at 632 nm, the hologram recording material is not sensitive to He—Ne laser beam.

The results of evaluation of absolute diffraction efficiency and percent shrinkage of the hologram recording materials 101 to 106 and the comparative samples 11 to 16are set forth in Table 2. For the calculation of the percent shrinkage of the hologram recording materials, the change of the thickness of the layer from before to after recording was determined. For Comparison Example 1, a radical polymerization photopolymer process hologram recording material disclosed in Example 1 of JP-A-6-43634 was prepared.

TABLE 2

| | Maximum diffraction | |
|---|---|---|
| Sample | efficiency η | % Shrinkage |
| 101 | 92 | <0.01 |
| Comparative Sample 11 | 89 | ″ |
| 102 | 87 | ″ |
| Comparative Sample 12 | 84 | ″ |
| 103 | 91 | ″ |
| Comparative Sample 13 | 86 | ″ |
| 104 | 89 | ″ |
| Comparative Sample 14 | 85 | ″ |
| 105 | 87 | ″ |
| Comparative Sample 15 | 84 | ″ |
| 106 | 88 | ″ |
| Comparative Sample 16 | 85 | ″ |
| Comparative Example 1 | 81 | 5.1% |

As can be seen in Table 2, the comparative example, which is known in JP-A-6-43634, exhibits a high diffraction efficiency but shows a shrinkage as great as more than 5% because it employs a photopolymer process involving radical polymerization. The comparative example shows an extremely deteriorated S/N ratio when used as holographic memory. Thus, the comparative example is not suitable for this purpose. On the other hand, the novel hologram recording 101 to 106, which comprise a polymer component of the invention and the comparative samples 11 to 16 corresponding thereto, which are of novel recording type but are free of polymer component, employ a recording process which is quite different from the known hologram recording process, i.e., hologram recording process involving refractive index modulation by color development reaction rather than by the movement and polymerization of material. Thus, the novel hologram recording 101 to 106 and the comparative samples 11 to 16 can attain both a high diffraction efficiency and a percent shrinkage as extremely small as 0.01% or less and thus are suitable particularly for holographic memory.

In particular, the hologram recording materials 101 to 106, which comprise a polymer component of the invention, show no extinction of recorded data and no deterioration of resolution due to the movement of material after recording because they comprise a polymer as a refractive index modifier for interference fringes-recording component etc. As a result, these inventive hologram recording materials show a higher diffraction efficiency than the comparative samples 11 to 16. Even after 1 month of storage at room temperature in the dark, these inventive hologram recording materials showed no deterioration of diffraction efficiency and thus are favorable from the standpoint of storage properties as well.

Further, the inventive hologram recording materials show a substantially linear rise of Δn (calculated from modulation of refractive index in interference fringes, diffraction efficiency and layer thickness on the basis of Kugelnick's equation) with exposure (mJ/cm²) and thus are advantageous in multiplexed recording.

Multiplexed hologram recording was actually made on the same area of a hologram recording material of the invention 10 times at a dose corresponding to one tenth of the exposure giving the maximum diffraction efficiency and a reference light angle varying by 2 degrees every recording job. Thereafter, the hologram recording material was fixed in the same manner as mentioned above so that the sensitizing dye was optically self-discolored and decomposed, and then irradiated with a reproducing light at an angle varying by 2-degrees. As a result, it was confirmed that these object lights can be reproduced. It can be thus made obvious that the hologram recording material of the invention can be subjected to multiplexed recording at the same exposure and thus is adapted for multiplexed recording. Thus, the hologram recording material of the invention allows many multiplexed recording jobs and hence high density (capacity) recording.

On the contrary, the known photopolymer process hologram recording material as disclosed in JP-A-6-43634 was found to require more radiation dose in the later stage of multiplexed recording than in the initial stage of multiplexed recording to perform the same recording because the polymerization of photopolymer has proceeded such that the rate of movement of monomer required for recording is reduced. Thus, the known photopolymer process hologram recording material leaves something to be desired in the enhancement of multiplexity, i.e., recording density.

Even when the sensitizing dye to be used in Samples 101 to 106 were changed to S-1, S-4, S-8, S-10, S-11, S-19, S-23, S-31, S-33, S-34, S-43, S45, S46, S-50, S-58, S-67, S-71, S-73, S-74, S-77, S-80, S-88, S-91 or S-94 to S-96, similar effects were obtained.

Further, oven when the acid generator to be used as interference fringes recording component in Samples 101 to 104 were changed to I-3, I-4, I-6 to I-10, 4-(octylphenyl)phenyl iodonium hexoafluorotimonate, tris(4-methylphenyl)sulfonium tetra (pentafluoro phenyl)borate, triphenylsulfonium perfluoropentanoate, bis(1-(4-diphenylsulfonium)phenylsulfide ditrifurate, dimethylphenasyl sulfonium perfluorobutane sulfonate, benzoyl tosylate, I-22 or I-23 or when the acid-colorable dye precursor polymer to be used as interference fringes recording component in Samples 101 to 104 were changed to PL-2, PL-4, PL-7 or PL-9, similar effects were obtained.

Further, eve when the base generator to be used as interference fringes recording component in Sample 105 was changed to PB-3 to PB-9 or when the base-colorable dye precursor polymer (non-dissociative product of dissociative dye) to be used in Sample 105 was changed to PDD-3 to PDD-8, PDD-11 or PD-12, similar effects were obtained.

Further, even when the interference fringes-recording component to be used in Sample 106 was changed to PE-9, PE-10 or PE-12 to PE14, similar effects were obtained.

Further, even when the electron-donating compound to be used in Samples 103 to 106 were changed to A-2 to A-6 or A-9 to A-11 or polymer electron-donating compound PED-3 to PED-7, similar effects were obtained.

Further, even when the binder to be used in Samples 101 to 106 were changed to polymethyl methacrylates (Mw: 996,000, 350,000, 120,000), poly (methyl methacrylate-butyl methacrylate) copolymer (Mw: 75,00), polyvinyl acetate (Mw: 83,000), polycarbonate, cellulose acetate butyrate, etc., similar effects were obtained.

### EXAMPLE 2

### Discoloration Process (Sensitizing Dye+Discolorable Dye) Hologram recording Method

Under a red lamp, the sensitizing dye, electron-donating compound, discoloring agent precursor, discolorable dye and binder PMMA-EA (poly(methyl methacrylate-5% ethyl acrylate) copolymer, Mw: 101,000) set forth in Table 3 were dissolved in methylene chloride (optionally with acetone or acetonitrile) in an amount of twice to four tines the weight of these components to prepare novel hologram recording material compositions 201 to 204 comprising the polymer component of the invention. Further, as opposed to these inventive compositions, comparative sample compositions 21 to 24 which are of novel recording type but free of polymer component were prepared. The term “%” as used herein is meant to indicate % by weight based on binder PMMA-EA.

TABLE 3

| | | | Electron- | | Discoloring | | | |
|---|---|---|---|---|---|---|---|---|
| | Sensitizing | | donating | | agent | | Discolorable | |
| Sample | dye | | compound | | precursor | | dye | |
| 201 | S-93 | 0.8% | A-1 | 42% | I-5 | 50% | PG-3 | 12% |
| Comparative | S-93 | 0.8% | A-1 | 42% | I-5 | 50% | G-16 | 8% |
| 21 | | | | | | | | |
| 202 | S-93 | 0.8% | A-1 | 42% | I-5 | 50% | PG-1 | 12% |
| Comparative | S-93 | 0.8% | A-1 | 42% | I-5 | 50% | G-28 | 8% |
| 22 | | | | | | | | |
| 203 | S-75 | 4.0% | A-1 | 42% | I-5 | 50% | PG-1 | 12% |
| Comparative | S-75 | 4.0% | | — | I-5 | 50% | G-28 | 8% |
| 23 | | | | | | | | |
| 204 | S-92 | 0.7% | A-1 | 42% | B-2 | 20% | PG-18 | 12% |
| Comparative | S-92 | 0.7% | A-1 | 42% | PB-2 | 20% | G-40 | 8% |

| | |
|---|---|
| 24 | X₅₁:PF₆⁻ |

* PG-3: n86:n87 = 1:2; PG-1: n86:n87 = 1:2; PG-18: n93:n94 = 1:2

The hologram recording material compositions 201 to 204 and the comparative sample compositions 21 to 24 were each spread (optionally in a multi-layer form) over a glass substrate to a thickness of about 80 μm using a blade to form a photosensitive layer which was then dried at room temperature in vacuo for 1 day to remove the solvent. The photosensitive layer was then covered by TAC layer to prepare hologram recording materials 201 to 204 and comparative samples 21 to 24.

The hologram recording materials were each then exposed to YAG laser second harmonic (532 nm, output: 2W) as a light source in a two-flux optical system for transmission hologram recording shown in FIG. 1 to perform recording. The angle of the object light with respect to the reference light was 30 degrees. The light had a diameter of 0.6 cm and an intensity of 8 mW/cm². During exposure, the holographic exposure time was varied from 0.1 to 400 seconds (radiation energy ranging from 0.8 to 3,200 mJ/cm²). He—Ne laser beam having a wavelength of 632 nm was passed through the center of exposed area at the Bragg angle. The ratio of diffracted light to transmitted light (relative diffraction efficiency) was then measured at real time. Since the sensitizing dye shows no absorption at 632 nm, the hologram recording material is not sensitive to He—Ne laser beam.

The results of evaluation of absolute diffraction efficiency and percent shrinkage of the hologram recording materials 201 to 204 and the comparative samples 21 to 24 are set forth in Table 4. For the calculation of the percent shrinkage of the hologram recording materials, the change of the thickness of the layer from before to after recording was determined. For Comparison Example 1, a radical polymerization photopolymer process hologram recording material disclosed in Example 1 of JP-A-6-43634 was prepared.

TABLE 4

| | Maximum diffraction | |
|---|---|---|
| Sample | efficiency η | % Shrinkage |
| 201 | 93 | <0.01 |
| Comparative Sample 21 | 89 | ″ |
| 202 | 91 | ″ |
| Comparative Sample 22 | 88 | ″ |
| 203 | 89 | ″ |
| Comparative Sample 23 | 86 | ″ |
| 204 | 88 | ″ |
| Comparative Sample 24 | 85 | ″ |
| Comparative Example 1 | 81 | 5.1% |

As can be seen in Table 4, the comparative example, which is known in JP-A6-43634, exhibits a high diffraction efficiency but shows a shrinkage as great as more than 5% because it employs a photopolymer process involving radical polymerization. The comparative example shows an extremely deteriorated S/N ratio when used as holographic memory. Thus, the comparative example is not suitable for this purpose. On the other hand, the novel hologram recording 201 to 204, which comprise a polymer component of the invention and the comparative samples 21 to 24 corresponding thereto, which are of novel recording type but are free of polymer component, employ a recording process which is quite different from the known hologram recording process, i.e., hologram recording process involving refractive index modulation by color development reaction rather than by the movement and polymerization of material, Thus, the novel hologram recording 201 to 204 and the comparative samples 21 to 24 can attain both a high diffraction efficiency and a percent shrinkage as extremely small as 0.01% or less and thus are suitable particularly for holographic memory.

In particular, the hologram recording materials 201 to 204, which comprise a polymer component of the invention, show no extinction of recorded data and no deterioration of resolution due to the movement of material after recording because they comprise a polymer as a refractive index modifier for interference fringes-recording component, etc. As a result, these inventive hologram recording materials show a higher diffraction efficiency than the comparative samples 21 to 24. Even after 1 month of storage at room temperature in the dark, these inventive hologram recording materials showed no deterioration of diffraction efficiency and thus are favorable from the standpoint of storage properties as well.

Further, the inventive hologram recording materials show a substantially linear rise of Δn (calculated from modulation of refractive index in interference fringes, diffraction efficiency and layer thickness on the basis of Kugelnick's equation) with exposure (mJ/cm²) and thus are advantageous in multiplexed recording.

Multiplexed hologram recording was actually made on the same area of a hologram recording material of the invention 10 times at a dose corresponding to one tenth of the exposure giving the maximum diffraction efficiency and a reference light angle varying by 2 degrees every recording job. Thereafter, the hologram recording material was fixed in the same manner as mentioned above so that the sensitizing dye was optically self-discolored and decomposed, and then irradiated with a reproducing light at an angle varying by 2 degrees. As a result, it was confirmed that these object lights can be reproduced. It can be thus made obvious that the hologram recording material of the invention can be subjected to multiplexed recording at the same exposure and thus is adapted for multiplexed recording. Thus, the hologram recording material of the invention allows many multiplexed recording jobs and hence high density (capacity) recording.

On the contrary, the known photopolymer process hologram recording material as disclosed in JP-A-6-43634 was found to require more radiation dose in the latter stage of multiplexed recording than in the initial stage of multiplexed recording to perform the same recording because the polymerization of photopolymer has proceeded such that the rate of movement of monomer required for recording is reduced. Thus, the known photopolymer process hologram recording material leaves something to be desired in the enhancement of multiplexity, i.e., recording density.

Even when the sensitizing dye to be used in Samples 201 to 204 were changed to S-1, S-4, S-8, S-10, S-11, S-19, S-23, S-31, S-33, S-34, S43, S-45, S46, S-50, S-58, S-67, S-71, S-73, S-74, S-77, S-80, S88, S-91 or S-94 to S-96, similar effects were obtained.

Further, even when the acid generator to be used as interference fringes recording component in Samples 201 to 203 were changed to I-3, I-4, I-6 to I-10, 4-(octylphenyl)phenyl iodonium hexoafluorotimonate, tris(4-methylphenyl)sulfonium tetra (pentafluoro phenyl)borate, triphenylsulfonium perfluoropentanoate, bis(1-(4-diphenylsulfonium)phenylsulfide ditrifurate, dimethylphenasyl sulfonium perfluorobutane sulfonate, benzoyl tosylate, I-22 or I-23 or when the acid-discolorable dye precursor polymer to be used as interference fringes recording component in Samples 201 to 203 were changed to PG-2, PG-4 to PG-6. or PG-9 to PG-14, similar effects were obtained.

Further, eve when the base generator to be used as interference fringes recording component in Sample 204 was changed to PB-3 to PB-9 or when the base-discolorable dye precursor polymer (non-dissociative product of dissociative dye) to be used in Sample 204 was changed to PG-16, PG-17 or PG-21, similar effects were obtained. Further, even when the electron-donating compound to be used in Samples 201, 202 and 204 were changed to A-2 to A-6 or A-9 to A-11 or polymer electron-donating compound PED-1 to PED-7, similar effects were obtained.

Further, even when the binder to be in Samples 201 to 204 were changed to polymethyl methacrylates (Mw: 996,000, 350,000, 120,000), poly (methyl methacrylate-butyl methacrylate) copolymer (Mw: 75,000), polyvinyl acetate (Mw: 83,000), polycarbonate, cellulose acetate butyrate, etc., similar effects were obtained.

While the invention has been described in detail and with reference to specific embodiments thereof, it will be apparent to one skilled in the art that various changes and modifications can be made therein without departing from the spirit and scope thereof.

The entire disclosure of each and every foreign patent application from which the benefit of foreign priority has been claimed in the present application is incorporated herein by reference, as if fully set forth herein.

What is claimed is:

1. A hologram recording material comprising:
a sensitizing dye absorbing light upon hologram exposure to generate an excited state thereof; and
an interference fringes-recording component capable of causing color development reaction or discoloration reaction by an electron or energy transfer from the excited state to record interference fringes providing a refractive index modulation,
wherein at least one of the sensitizing dye one the interference fringes-recording component is one of a polymer and an oligomer.

2. The hologram recording material according to claim 1, wherein the interference fringes-recording component comprises: an acid generator; and one of an acid-colorable dye precursor and an acid-discolorable dye, at least one of the acid generator, the acid-colorable dye precursor and the acid-discolorable dye being one of a polymer and an oligomer.

3. The hologram recording material according to claim 2, wherein the one of the acid-colorable dye precursor and the acid-discolorable dye is one of a polymer and an oligomer.

4. The hologram recording material according to claim 1, wherein the interference fringes-recording component comprises: a base generator; and one of a base-colorable dye precursor and a base-discolorable dye, at least one of the base generator, the base-colorable dye precursor and the base-discolorable dye being one of a polymer is an oligomer.

5. The hologram recording material according to claim 4, wherein the one of the base-colorable dye precursor and the base-discolorable dye is one of a polymer and an oligomer.

6. The hologram recording material as defined according to claim 1, wherein the interference fringes-recording component comprises a colorable dye precursor being one of a polymer and an oligomer, the colorable dye be represented by formula (1):
(A1−PD)m1 (1)
wherein A1 and PD are covalently bonded to each other; A1 represents a site capable of disconnecting the covalent bond to PD by an electron or energy transfer with the excited state of the sensitizing dye; PD represents a site capable of causing color development reaction when PD is released upon the disconnection of the covalent bond to A1, with the proviso that the molecules of the formula (1) are connected to each other with covalent bond of at least one of A1 and PD to form a polymer or an oligomer, and m1 represents an integer of 3 to 1,000,000.

7. The hologram recording material according to claim 1, wherein the interference fringes-recording component comprises a discolorable dye being one of a polymer and an oligomer, the discolorable dye being represented by formula (2):
(A2−DD)m2 (2)
wherein A2 and DD are covalently bonded to each other; A2 represents a site capable of disconnecting the covalent bond to DD by an electron or transfer with he excited state of the sensitizing dye; DD represents a site which stays in the form of dye when DD is covalently bonded to A2; DD is discolored when DD is released upon the disconnection of the covalent bond to A2, with the proviso that the molecules of the formula (2) are connected to each other with covalent bond of any of A2 and DD to form a polymer or an oligomer, and m2 represents an integer of 3 to 1,000,000.

8. The hologram recording material according to claim 1, further comprising an electron-donating compound capable of donating an electron to a radical cation of the sensitizing dye, from which electron has been transferred to the interference fringes-recording component.

9. The hologram recording material according to claim 8, wherein the electron-donating compound is one of a polymer and an oligomer.

10. The hologram recording material as defined according to claim 8, comprising one of a polymer and an oligomer, the one of the polymer and the oligomer being are copolymer of at least two of the sensitizing dye the interference fringes-recording component and the electron-donating compound.

11. A hologram recording method, which comprises recording interference fringes providing a refractive index modulation in a hologram recording material according to claim 1 by at least one of 1) a color development reaction, 2) a color development reaction amplified by a self-sensitization with a coloring material of a latent image, 3) a polymerization reaction sensitized with a coloring material of a latent image, 4) a dye discoloration reaction, and 5) a latent image-sensitized polymerization reaction sensitized by a latent image of a residual of a discolorable dye.

12. The hologram recording method according to claim 11, wherein
the recording of the interference fringes is performed by 2) the color development reaction amplified by a self-sensitization with a coloring material of a latent image, and
the recording of the interference fringes comprises:
a first step of generating a coloring material as a latent image by holographic exposure, the coloring material having no absorption in a wavelength of a hologram reproducing light; and
a second step of irradiating the latent image of the coloring material with a light having a wavelength, which is different from that of the holographic exposure and in which the sensitizing dye has a molar absorption coefficient of 5,000 or less, to self-sensitize and self-amplify the coloring material,
wherein each of the first and second stops is dry process.

13. The hologram recording method according to claim 11, wherein
the interference fringe-recording component is a component capable of recording the interference fringes by at least one of 1) the color development reaction and 2) the color development reaction amplified by a self-sensitization with a coloring material of a latent image,
the component comprises a dye precursor capable of forming a coloring material, wherein the coloring material has an absorption shifted to a longer wavelength than that of the dye precursor and has no absorption in a wavelength of a hologram reproducing light, and
the interference fringes are recorded by forming the refractive index modulation through a color development of the coloring material as a result of an electron or energy transfer from the excited state of the sensitizing dye or an excited state of the coloring material.

14. The hologram recording method according to claim 1, wherein
the recording of the interference fringes is performed by 3) the polymerization reaction sensitized with the coloring material of the latent image, and
the recording of the interference fringes comprises:
a first step of generating a coloring material as a latent image by holographic exposure, the coloring material having no absorption in a wavelength of a hologram reproducing light; and
a second step of irradiating the latent image of the coloring material with a light having a wavelength, which is different from that of the holographic exposure, to cause a polymerization reaction.
wherein each of the first and second steps is dry process.

15. The hologram recording method according to claim 14, wherein
the sensitizing dye absorbs light upon the holographic in the first step to generate the excited state thereof, and
the interference fringe-recording component comprises:
a dye precursor capable of forming a coloring material by an electron or energy transfer from the excited state of the sensitizing dye in the first step or from an excited state of the coloring material in the second step, wherein the coloring material has an absorption shifted to a longer wavelength than that in the dye precursor, the coloring material has an absorption in a wavelength in which the sensitizing has a molar absorption coefficient of 5,000 or less, and the coloring material has no absorption in a wavelength of a hologram reproducing light;
a polymerizable compound;
a polymerization initiator capable of initiating a polymerization of the polymerizable compound by an energy or electron transfer from the excited state of the sensitizing dye in the first stop or from an excited state of the coloring material in the second stop; and
a binder.

16. The hologram recording method according to claim 11, wherein
the recording of the interference fringes is performed by 4) the dye discoloration reaction,
the interference fringe-recording component comprises at least one of a discolorable dye and a discoloring agent precursor, the discoloring agent precursor comprising at least one of a radical generator, an acid generator, a base generator, a nucleophilic agent generator, an electrophilic agent generator and an triplet oxygen, and
the interference fringes are recorded by forming the refractive index modulation through at least one of: discoloring the discolorable dye as a result of an energy or electron transfer from the excited state of the sensitizing dye directly to the discolorable dye; and discoloring the discolorable dye by a discoloring agent formed by an energy or electron transfer from the excited state of the sensitizing dye to the discoloring agent precursor.

17. The hologram recording method according to claim 11 wherein
the recording of the interference fringes is performed by 7) the latent image-sensitized polymerization reaction sensitized by a latent image of a residual of a discolorable dye, and
the interference fringe-component records the interference fringes by a method comprising:
a first step in which:
the sensitizing dye represented absorbs light upon holographic exposure to generate the excited state thereof,
a color of a discolorable dye is discolored by at least one of; an energy or electron transfer from the excited state of the sensitizing dye directly to the discolorable dye; and a discoloring agent formed by an energy or electron transfer from the excited state of the sensitizing dye to a discoloring agent precursor, the discoloring agent precursor comprising at least one of a radical generator, an acid generators a base generator, a nucleophilic agent generator, an electrophilic agent generator and an triplet oxygen, and
a residual of the discolorable dye forms a latent image; and
a second step of irradiating the latent image of the residual of the discolorable dye with light having a wavelength, which is different from that the holographic exposure, to cause a polymerization reaction by activating a polymerization initiator as a result of an energy or electron transfer from the residual of the discolorable dye.

18. The hologram recording method according to claim 17 wherein the interference fringe-recording component comprises:
a discolorable dye capable of discoloring itself in the first step as a result of at least one of: an energy or electron transfer directly from the excited state of the sensitizing dye; and an generation of the discoloring agent by an energy or electron transfer from the excited state of the sensitizing dye to the discoloring agent precursor, the discolorable dye having a molar absorption coefficient of 1,000 or less at a wavelength of a hologram reproducing light;
a polymerizable compound;
a polymerization initiator capable of initiating a polymerization of the polymerizable compound by an electron or energy transfer from the excited state of the residual of the discolorable dye in the second step; and
a binder.

19. The hologram recording material according to claim 1, wherein the interference fringes are non-rewritable.

20. The hologram recording method according to claim 11, comprising performing a multiplexed recording by subjecting the hologram recording material to holographic exposure ten times or more.

21. The hologram recording method according to claim 20, wherein the multiplexed recording is performed under a common exposure amount in each holographic exposure.

22. An optical recording medium comprising a hologram recording material according to claim 1.

23. The optical recording medium according to claim 22, wherein the hologram recording material is stored in a light-shielding cartridge during a storage period.
